(19) United States
(12) Patent Application Publication
(10) Pub. No.: US 2020/0180962 A1
(43) Pub. Date: Jun. 11, 2020

(54) FLUORESCENT QUANTUM DEFECTS ON CARBON NANOTUBES

(71) Applicant: MASSACHUSETTS INSTITUTE OF TECHNOLOGY, Cambridge, MA (US)

(72) Inventors: Angela Belcher, Lexington, MA (US); Ching-Wei Lin, Cambridge (US)

(73) Assignee: MASSACHUSETTS INSTITUTE OF TECHNOLOGY, Cambridge, MA (US)

(21) Appl. No.: 16/708,339

(22) Filed: Dec. 9, 2019

Related U.S. Application Data
(60) Provisional application No. 62/778,204, filed on Dec. 11, 2018.

(51) Int. Cl. C01B 32/16; C01B 32/159; G01N 21/64

(52) U.S. Cl. CPC C01B 32/16; B82Y 40/00; G01N 21/64; C01B 32/159

(57) ABSTRACT

Fluorescent quantum defects in a single walled carbon nanotubes can provide single photon emissions which can enable applications in quantum computing and imaging.

### PRIORITY CLAIM

This application claims priority to U.S. Provisional Patent Application No. 62/778,204, filed Dec. 11, 2018, which is incorporated by reference in its entirety.

### GOVERNMENT SPONSORSHIP

This invention was made with Government support under Grant No. CA014051 awarded by the National Institutes of Health. The Government has certain rights in the invention.

### FIELD OF INVENTION

The invention features emissive carbon nanotubes, methods of making emissive carbon nanotubes and methods of using emissive carbon nanotubes.

### BACKGROUND

Semiconducting single-walled carbon nanotubes (SWCNTs) are known to fluoresce at short-wave infrared (SWIR; NIR-II; 850-1600 nm), thus are promising for applications such as bioimaging and light based noncontact sensing. See, Hong, G. S., Antaris, A. L. & Dai, H. J. Near-infrared fluorophores for biomedical imaging. Nature Biomedical Engineering 1, 22, doi:10.1038/s41551-016-0010 (2017); Lin, C.-W., Bachilo, S. M., Vu, M., Beckingham, K. M. & Weisman, R. B. Spectral triangulation: a 3D method for locating single-walled carbon nanotubes in vivo. Nanoscale 8, 10348-10357, doi:10.1039/C6NR01376G (2016); Lin, C.-W. & Weisman, R. B. In vivo detection of single-walled carbon nanotubes: progress and challenges. Nanomedicine 11, 2885-2888, doi:10.2217/nnm-2016-0338 (2016); Lin, C.-W. et al. In Vivo Optical Detection and Spectral Triangulation of Carbon Nanotubes. ACS Appl. Mater. Interfaces 9, 41680-41690, doi:10.1021/acsami.7b12916 (2017); Bachilo, S. M. et al. Structure-Assigned Optical Spectra of Single-Walled Carbon Nanotubes. Science 298, 2361-2366 (2002); O'Connell, M. J. et al. Band Gap Fluorescence from Individual Single-Walled Carbon Nanotubes. Science 297, 593-596, doi:10.1126/science.1072631 (2002); Withey, P. A., Vemuru, V. S. M., Bachilo, S. M., Nagarajaiah, S. & Weisman, R. B. Strain paint: Noncontact strain measurement using single-walled carbon nanotube composite coatings. Nano Lett. 12, 3497-3500 (2012); and Sun, P., Bachilo, S. M., Lin, C.-W., Nagarajaiah, S. & Weisman, R. B. Dual-layer nanotube-based smart skin for enhanced noncontact strain sensing. Structural Control and Health Monitoring 26, e2279, doi:doi:10.1002/stc.2279 (2019), each of which is incorporated by reference in its entirety.

### SUMMARY OF THE INVENTION

In one aspect, a plurality of single walled carbon nanotubes can have a fluorescent quantum defect. The single walled carbon nanotube with the fluorescent quantum defect can have emission maxima near about 1000 nm and 1275 nm and, optionally, having an E*₁₁ absorption with peak intensity of at least 1.5% compared to the E₁₁ absorption peak of pristine single walled carbon nanotubes. The different chirality of carbon nanotubes (different diameter) can have different emission wavelength and excitation wavelengths.

In another aspect, a composition can include the plurality of single walled carbon nanotubes can have a fluorescent quantum defect.

In another aspect, a method of making emissive single walled carbon nanotubes can include contacting single walled carbon nanotubes with an oxygen-atom source to form a mixture, and irradiating the mixture with UV light to introduce a fluorescent quantum defect in the single walled carbon nanotubes.

In another aspect, a continuous flow reactor for making emissive single walled carbon nanotubes can include a reaction chamber including: an injection port configured to introduce a flow of single walled carbon nanotubes and a flow of an oxygen-atom source; a reaction chamber configured to receive the flow of single walled carbon nanotubes and the flow of an oxygen-atom source as a mixture; and a source of electromagnetic radiation arranged to irradiated the mixture with UV light to introduce a fluorescent quantum defect in the single walled carbon nanotubes.

In certain circumstances, the emission maxima can be at 900-1000 nm and 1100-1275 nm.

In certain circumstances, the fluorescent quantum defect can be O-doping.

In certain circumstances, the single walled carbon nanotubes having the fluorescent quantum defect can have an emission quantum yield that is at least 2 times higher than pristine single walled carbon nanotubes.

In certain circumstances, the single walled carbon nanotubes having the fluorescent quantum defect can have a D/G ratio of about 0.0371.

In certain circumstances, the oxygen-atom source can include a hypochlorite, a peroxide or a permanganate.

In certain circumstances, the UV light can have a wavelength shorter than 350 nm, for example, between 250 nm and 350 nm, or between 275 nm and 325 nm.

In certain circumstances, the method can include dispersing the single walled carbon nanotube with a surfactant prior to the contacting step.

In certain circumstances, the surfactant can be a dedecylbenzene sulfonate, a dodecyl sulfate or a deoxycholate.

In certain circumstances, the method can include flowing the mixture through a reaction zone where the irradiating takes place.

In certain circumstances, the emissive single walled carbon nanotubes can be manufactured in less than 5 minutes, less than 4 minutes, less than 3 minutes, less than 2 minutes or less than 1 minute.

In another aspect, a method can include exposing a single walled carbon nanotube having a fluorescent quantum defect to an excitation wavelength of light, and detecting emission from the single walled carbon nanotube having a fluorescent quantum defect in a wavelength range of 850 nm to 1600 nm, for example between 1100 and 1600 nm.

In certain circumstances, the single walled carbon nanotube having the fluorescent quantum defect can be a single walled carbon nanotube as described above.

In certain circumstances, the method can include introducing the single walled carbon nanotube into a subject and generating an image based on the detected emission. For example, the single walled carbon nanotube can be introduced at a concentration of less than 10 micrograms per kilogram, less than 8 micrograms per kilogram, less than 6 micrograms per kilogram, less than 5 micrograms per kilogram or 4 micrograms per kilogram or less.

In certain circumstances, the detecting can include monitoring a shift in an emission maximum.

In certain circumstances, the detecting can include measuring a single photon emission.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIGS. 1A-1H depict optical properties of (6,5)-enriched pristine and O-doped SWCNTs. FIG. 1A depicts fluorescence spectra. FIG. 1B depicts absorption spectra; expanded inset shows E*₁₁ absorption feature. FIG. 1C depicts excitation-emission maps. FIG. 1D depicts Raman spectra; expanded inset shows the D bands. FIG. 1E depicts emission intensities vs illumination time. Figures IF depicts normalized emission spectra of SWCNT samples with and without 300 nm irradiation in the absence of NaClO. FIG. 1G depicts changes in SWCNTs with NaClO placed in dark for 24 hrs. FIG. 1H depicts, in the first panel: Fluorescence action spectra at E₁₁ and E₁₁ of O-doped SWCNTs, in the second panel: NaClO absorption spectrum, and in the third panel: illumination power density. Fourth panel: absorption spectra of SWCNTs.

FIGS. 2A-2D depict a mechanism of oxygen doping using NaClO. FIG. 2A shows the relative doping extents in samples irradiated at SWCNT resonant absorption peaks and at the 300 nm NaClO absorption peak. Relative doping extent is defined as [(E*₁₁/E₁₁)_{irrad.}−(E*₁₁/E₁₁)_{no light}]/P_{irrad.}. Error bars indicate standard deviation (s.d.) from the spectral measurement noise. FIG. 2B shows an action spectrum of the doping rate constant (open circles), and relative photogeneration rates of O (¹D) (closed triangles). Error bars indicate s.d. estimated from literature uncertainties and spectral measurement noise. FIG. 2C shows a diagram showing computed energies for reactants, products, and proposed transition state for the doping reaction in vacuum (units: kcal mol⁻¹). Note that the ether adduct is more stable than the epoxide. FIG. 2D shows an illustration of the proposed doping reaction

FIGS. 3A-3E depict surfactants and oxidizing agents that affect doping efficiency. FIG. 3A shows E₁₁ and E*₁₁ emission intensities after treatment of samples suspended in various SC concentrations. FIG. 3B shows a maximum ratio of E₁₁ to E*₁₁ emission intensities for treated samples suspended in different surfactants. # represents SWCNT fluorescence quenched after addition of oxidizing agent. Error bars indicate s.d. from the spectral measurement noise. FIG. 3C shows dependence of E₁₁ and E*₁₁ emission intensities after treatment on NaClO concentration. FIG. 3D shows the effect of NaClO concentration on the D/G ratio. FIG. 3D shows D/G Raman ratio vs NaClO concentration. The samples are the same as those in FIG. 3C. FIG. 3E shows emission intensity vs NaClO concentration of a unsorted CoMoCAT sample.

FIGS. 4A-4E depict variance spectroscopy of pristine and O-doped (6,5)-SWCNTs. FIG. 4A shows covariance matrix measured for the (6,5)-SWCNT suspension before treatment. FIG. 4B shows covariance matrix measured for the (6,5)-SWCNT suspension after treatment. The off-diagonal components (white arrows) reveal the presence of correlated E₁₁ and E*₁₁ emissions. FIG. 4C shows variance spectra (diagonal traces) of FIG. 4A and FIG. 4B. The O-doped trace shows evidence of spectrally resolved E*₁₁ peaks from the two (6,5) enantiomers. FIG. 4D shows Pearson correlation coefficient spectra, at 994 and 1126 nm, of the O-doped (6,5)-SWCNT sample. FIG. 4E shows intensity ratio vs intensity sum of single nanotube emission acquired at two channels (Ch. 1:950-1000 nm; Ch. 2: 1100-1300 nm). Solid lines are the linear fittings showing the trends.

FIGS. 5A-5C depict efficient synthesis of O-doped SWCNTs and their application in fluorescence in vivo imaging. FIG. 5A shows schematic diagram of the flow reactor incorporating syringe pumps and a 300 nm LED for irradiation and fluorescence excitation. Emission was collected through the back cell window and analyzed in a SWIR spectrometer. FIG. 5B shows emission spectrum of O-doped SWCNTs synthesized in the flow reactor. The solution was diluted by SDC to OD ˜0.1 for measurement. (inset) Photo of O-doped (6,5)-SWCNTs collected directly from the flow reactor. FIG. 5C shows SWIR fluorescence images of O-doped SWCNTs in vivo. Left panel: A black mouse injected intravenously with ˜100 ng of O-doped SWCNTs, showing clear inguinal lymph node. Upper right panel: Lymphatic drainage after footpad injection (˜10 ng) into a white mouse. Lower right panel: clear vasculature imaging from the leg of a black mouse injected with ˜100 ng of O-doped SWCNTs. Image label abbreviations: LN for lymph node; A&V for artery and vein.

FIGS. 6A-6D depict optical properties of (6,5)-enriched and CoMoCAT SWCNTs. FIG. 6A shows an absorption spectrum of the CoMoCAT SWCNTs in 1% SC. FIG. 6B shows an absorption spectrum of (6,5)-SWCNTs in 1% SC. FIG. 6C shows a Raman spectrum of the CoMoCAT SWCNTs. FIG. 6D shows a Raman spectrum of the (6,5)-SWCNTs.

FIGS. 7A-7B depict emission spectra of pristine and O-doped (6,5)-enriched SWCNTs converted to energy scale. The area ratio is ca. 2.6. The FWHM is broadened from 317.8 to 436.1 cm⁻¹. FIG. 7A shows the area ratio is ca. 2.6. The FWHM is broadened from 317.8 to 436.1 cm⁻¹. FIG. 7B shows the spectral position and shapes of both pristine and O-doped SWCNTs are very similar, including the sideband position and intensity.

FIGS. 8A-8B depict E*₁₁ absorption and energy diagram at defect site. FIG. 8A shows difference of absorption spectra between treated and pristine samples. FIG. 8B shows an energy diagram of an ether-SWCNT.

FIGS. 9A-9B depict emission spectra of pristine and O-doped (6,5)-enriched SWCNTs excited at 565 (E₁₁) and 1125 (E*₁₁) nm. The O-doped SWCNTs shows weaker upconversion intensity compared to the pristine SWCNTs. FIG. 9A shows excitation at 565 nm. FIG. 9B shows excitation at 1125 nm.

FIG. 10 depicts RBM spectra of pristine and O-doped (6,5)-enriched SWCNTs excited at 532 nm.

FIGS. 11A-11D depict optical properties of pristine and O-doped CoMoCAT SWCNTs. (a) The emission spectra excited at 565 nm. (b) The absorption spectra. (c) The excitation-emission profile of the pristine CoMoCAT SWCNTs, showing (6,5), (8,3) and (75). (d) The O-doped sample.

FIGS. 12A-12B depict excitation-emission map of pristine and O-doped sorted HiPco SWCNTs. FIG. 12A shows pristine sorted SWCNTs. FIG. 12B shows O-doped sorted SWCNTs.

FIG. 13 depicts absorption spectra of NaClO before and after illumination at 300 nm. The O-doped SWCNTs shows weaker upconversion intensity compared to the pristine SWCNTs.

FIGS. 14A-14E depicts sample stability in dark for 24 h. FIG. 14A shows Raman spectra, FIG. 14B shows Emission spectra, and FIG. 14C shows absorption spectra of (6,5)-enriched SWCNTs at time zero and time 24 h. FIG. 14D shows absorption spectra normalized to E₁₁ peaks. FIG. 14E shows a percentage change of O-doped to pristine SWCNT quantities in (FIGS. 14A-14D).

FIG. 15A-15E depict characterization of NaClO-free (6,5)-SWCNTs illuminated by 300 nm light. FIG. 15A shows emission spectra of NaClO-free (6,5)-SWCNTs illuminated with 300 nm light. FIG. 15B shows normalized emission intensity of FIG. 15A. FIG. 15C shows absorption spectra of E₁₁. FIG. 15D shows Raman spectra of NaClO-free (6,5)-SWCNTs after 300-nm illumination. FIG. 15E depicts the Raman spectrum of (6,5)-SWCNTs without NaClO illuminated by 300 nm light. The D/G ratio is higher than pristine SWCNTs, showing no fluorescent defects are created

FIGS. 16A-16D depict various types of spectra measured from Variance Spectrometer. FIG. 16A shows mean spectra. FIG. 16B shows emission efficiency spectra. FIG. 16C shows relative abundance spectra. FIG. 16D shows skewness spectra.

FIGS. 17A-17F depict variance spectroscopy of pristine and O-doped CoMoCAT SWCNTs excited at 660 nm. FIG. 17A shows a mean spectrum of pristine SWCNTs. FIG. 17B shows a mean spectrum of O-doped SWCNTs. FIG. 17C shows a variance spectrum of pristine SWCNTs. FIG. 17D shows a variance spectrum of O-doped SWCNTs. FIG. 17E shows a covariance matrix of pristine SWCNTs. FIG. 17F shows a covariance matrix of O-doped SWCNTs.

FIGS. 18A-18F depict the variance spectroscopy of pristine and O-doped CoMoCAT SWCNTs excited at 785 nm. FIG. 18A shows a mean spectrum of pristine SWCNTs. FIG. 18B shows a mean spectrum of O-doped SWCNTs. FIG. 18C shows a variance spectrum of pristine SWCNTs. FIG. 18D shows a variance spectrum of O-doped SWCNTs. FIG. 18E shows a covariance matrix of pristine SWCNTs. FIG. 18F shows a covariance matrix of O-doped SWCNTs.

FIGS. 19A-19F depict normalized covariance, normalized emission efficiency and Pearson correlation coefficient matrix. FIG. 19A shows a Pearson correlation coefficient matrix of pristine (6,5)-SWCNTs. FIG. 19B shows a Pearson correlation coefficient matrix of O-doped (6,5)-SWCNTs. FIG. 19C shows normalized emission efficiency matrix of pristine (6,5)-SWCNTs. FIG. 19D shows normalized emission efficiency matrix of O-doped (6,5)-SWCNTs. FIG. 19E shows a Pearson correlation coefficient matrix of pristine (6,5)-SWCNTs. FIG. 19F shows a Pearson correlation coefficient matrix of O-doped (6,5)-SWCNTs.

FIGS. 20A-20C depict doping extent vs doping heterogeneity. FIG. 20A shows mean spectra normalized to E₁₁. FIG. 20B shows variance spectra normalized to E₁₁. FIG. 20C shows the percentage of each type of SWCNTs.

FIG. 21 depicts pixel size measurement.

FIGS. 22A-22C depict single nanotube measurements. FIG. 22A shows raw SWIR images of nanotubes on coverslip surface. The images are acquired at two different wavelength channels (Ch. 1:950-1000 nm; Ch. 2: 1100-1300 nm). The pixel size is ˜500 nm. FIG. 22B shows intensity ratio vs intensity sum. Light red circles and light blue squares are the SWCNTs that has intensity in one of the channels lower than detection limit. FIG. 22C shows the distribution of the intensity ratio of pristine and O-doped SWCNTs deduced from FIG. 22A.

FIG. 23 depicts the Raman D/G ratio of (6,5)-SWCNTs left in the in dark after 24 hours. The result shows no observable change in D/G ratio, meaning pristine structures were kept intact.

FIG. 24 represents O-doping using other water-soluble oxidizing agents. ϕ represents the quantum yield. The doping power does not correlate to the reduction potential of the oxidizing agents. Hypochlorite, Permanganate, and hydrogen peroxide can dope oxygen and from fluorescent quantum defects.

FIGS. 25A-25D depict oxygen doping of CoMoCAT SWCNTs using KMnO₄. FIG. 25A shows an absorption spectrum of KMnO₄. FIG. 25B shows reaction kinetics excited at 500 nm. FIG. 25C shows action spectra of E₁₁ and E*₁₁ peaks. FIG. 25D shows fluorescence spectrum after oxygen doping.

FIG. 26 depicts a schematic showing modification of a SWCNT.

FIG. 27 depicts the E₁₁ and E*₁₁ peak shifts of the −(6,5) SWCNTs.

FIGS. 28A-28D depict oxygen doping of CoMoCAT SWCNTs using H₂O₂.

FIG. 28A shows an absorption spectrum of H₂O₂. FIG. 28B shows reaction kinetics excited at 260 nm. Three doping periods were performed. FIG. 28C shows action spectra of E₁₁ and E*₁₁ peaks. FIG. 28E shows a fluorescence spectrum after oxygen doping.

FIG. 29 depicts a flow reactor.

FIGS. 30A-30F depict in vivo images. FIG. 30A shows a mouse leg showing femoral artery and vein. FIG. 30B shows a mouse footpad. FIG. 30C shows a mouse leg showing medial marginal artery and vein. FIG. 30D shows lymph nodes after footpad subcutaneous injection. FIG. 30E shows whole body vasculature imaging of a nude mouse. FIG. 30F shows whole body vasculature imaging of a shaved black mouse.

FIGS. 31A-31B depict doping extent with and without NaClO. FIG. 31A shows the doping extent as a function of illumination wavelengths. FIG. 31B shows the ratios of doping extent.

FIGS. 32A-32B depict ¹D oxygen generation and doping rate constant. FIG. 32A shows the absorption spectra of SWCNT solution with and without NaClO. The percentage of the photons absorbed by NaClO at 313 and 514.33 nm are listed. FIG. 32B shows the doping rate constant with and without dissolved oxygen gas. The reaction is much faster when O₂ molecules have been removed. The reaction rate is also higher when the illumination wavelengths are shorter.

FIGS. 33A-33H depict variance spectroscopy of sample 2. FIG. 33A shows mean spectra, FIG. 33B shows variance spectra, and FIG. 33C shows a covariance matrix of pristine (6,5)-SWCNTs. FIG. 33D shows a covariance matrix of O-doped (6,5)-SWCNTs. FIG. 33E shows relative abundance spectra, FIG. 33F shows emission efficiency, and FIG. 33G shows a Pearson correlation coefficient matrix of pristine (6,5)-SWCNTs. FIG. 33H shows a Pearson correlation coefficient matrix of O-doped (6,5)-SWCNTs.

### DETAILED DESCRIPTION

Fluorescent quantum defects give single photon emissions which enable applications in quantum encryption and imaging applications. Single-walled carbon nanotubes (SWCNTs) have been shown to emit telecom-wavelength single photons at room temperature. In addition, the higher quantum yield and longer excitation and emission wavelengths of these defect SWCNTs are promising for bio-imaging applications. A more reliable and efficient method for synthesizing defect-doped SWCNTs is needed for translating from fundamental study to practical applications. Here, a method of fast oxygen-doping of SWCNTs is described that reaches maximum intensity of defect emission within 40 seconds, using a very reachable oxidizing agent, bleach. This reaction is photo-activated so that the doping density can be well controlled. The direct attachment of oxygen atom should be responsible for this highly efficient reaction. Finally, a simple doping apparatus can demonstrate the feasibility of synthesizing fluorescent quantum defects on SWCNTs at scale.

As described herein, covalent doping of single-walled carbon nanotubes (SWCNTs) can modify their optical properties, enabling applications as single-photon emitters and bio-imaging agents. A simple, quick, and controllable method for preparing oxygen-doped SWCNTs with desirable emission spectra is described. Aqueous nanotube dispersions are treated at room temperature with NaClO (bleach) and then UV-irradiated for less than one minute to achieve optimized O-doping. The doping efficiency is controlled by varying surfactant concentration and type, NaClO concentration, and irradiation dose. Photochemical action spectra indicate that doping involves reaction of SWCNT sidewalls with oxygen atoms formed by photolysis of ClO⁻ ions. Variance spectroscopy of products reveals that most individual nanotubes in optimally treated samples show both pristine and doped emission. A continuous flow reactor is described that allows efficient preparation of milligram quantities of O-doped SWCNTs. Finally, a bio-imaging application is demonstrated that gives high contrast short-wavelength infrared fluorescence images of vasculature and lymphatic structures in mice injected with only ˜100 ng of the doped nanotubes.

The single walled carbon nanotubes can have a fluorescent quantum defect. The single walled carbon nanotube can be introduced into a subject and an image based on emission from the single walled carbon nanotube can be generated. For example, the single walled carbon nanotube can be introduced at a concentration of less than 10 micrograms per kilogram, less than 8 micrograms per kilogram, less than 6 micrograms per kilogram, less than 5 micrograms per kilogram or 4 micrograms per kilogram or less.

The defect can be introduced to the single walled carbon nanotube in a controlled and homogenous manner. In the method described herein, the rapid introduction of an oxygen defect can lead to a single walled carbon nanotube that has an emission maximum that is shifted to longer wavelength. For example, an emission maximum can be shifted to 1120 nm or longer.

The oxygen defect can be introduced by creating a reactive oxygen atom in the vicinity of a surface of the single walled carbon nanotube. The reactive oxygen atom can be produced by photolysis of a reaction mixture including the single walled carbon nanotube and an oxygen atom source.

The oxygen-atom source can include a hypochlorite, a peroxide or a permanganate. For example, the hypochlorite can be sodium hypochlorite, or bleach. The photolysis can be irradiation at a wavelength at or near 300 nm, for example, between 250 nm and 350 nm, for example, between 275 nm and 325 nm, which decomposes the hypochlorite and can liberate the oxygen atom near a surface of the single walled carbon nanotube. The method can include flowing the mixture through a reaction zone, such as a reaction chamber, where the irradiating takes place. The emissive single walled carbon nanotubes can be manufactured in less than 5 minutes, less than 4 minutes, less than 3 minutes, less than 2 minutes or less than 1 minute. For example, when irradiating a mixture of the single walled carbon nanotube with sodium hypochlorite, the oxygen defect can be introduced in high yield in about 45 to 55 seconds.

The single walled carbon nanotube can be stabilized in solution by a surfactant. The surfactant can be included in the mixture near the critical micelle concentration of the surfactant. This can improve the efficiency and homogeneity of the introduction of the oxygen defect to the surface of the single walled carbon nanotube. In certain circumstances, the surfactant can be a dedecylbenzene sulfonate, a dodecyl sulfate or a deoxycholate, or other long-chain amphiphilic compound. For example, the surfactant can be sodium dedecylbenzene sulfonate, sodium dodecyl sulfate or sodium deoxycholate.

The single walled carbon nanotube with the fluorescent quantum defect can have emission maxima near about 1000 nm and 1125 nm and having an E*₁₁ absorption at 1114 nm with peak intensity of at least 1.5% compared to the E₁₁ absorption peak of pristine single walled carbon nanotubes. The single walled carbon nanotubes having the fluorescent quantum defect can have an emission quantum yield that is at least 2 times higher than pristine single walled carbon nanotubes. The single walled carbon nanotubes having the fluorescent quantum defect can have a D/G ratio of about 0.0371.

A method can include exposing a single walled carbon nanotube having a fluorescent quantum defect to an excitation wavelength of light, and detecting emission from the single walled carbon nanotube having a fluorescent quantum defect in a wavelength range of 850 nm to 1600 nm. The method can be an imaging method, a data transmission method or a stress detection method. The detecting can include monitoring a shift in an emission maximum. The detecting can include measuring a single photon emission.

In some embodiments, the method may comprise exposing the single walled carbon nanotube to electromagnetic radiation. Sources of electromagnetic radiation that can be used include, but are not limited to, a lamp (e.g., an infrared lamp, ultraviolet lamp, etc.), a laser, LED, or any other suitable source. In addition, the method may further comprise sensing electromagnetic radiation (e.g., the intensity and/or wavelength) or the absorption of electromagnetic radiation, for example, emitted by the nanosensor. Sensing can be performed using, for example, a UV-vis-nIR spectrometer, a florometer, a fluorescence microscope, visual inspection (e.g., via observation by a person) or any other suitable instrument or technique.

In some embodiments, the single walled carbon nanotube may have a diameter of the order of nanometers and a length on the order of microns, tens of microns, hundreds of microns, or millimeters, resulting in an aspect ratio greater than about 100, about 1000, about 10,000, or greater. In some embodiments, a nanotube can have a diameter of less than about 1 micron, less than about 500 nm, less than about 250 nm, less than about 100 nm, less than about 75 nm, less than about 50 nm, less than about 25 nm, less than about 10 nm, or, in some cases, less than about 1 nm.

In some embodiments, the photoluminescent nanostructures described herein may emit radiation within a desired range of wavelengths. For example, in some cases, the photoluminescent nanostructures may emit radiation with a wavelength between about 750 nm and about 1600 nm, or between about 900 nm and about 1400 nm (e.g., in the near-infrared range of wavelengths). In some embodiments, the photoluminescent nanostructures may emit radiation with a wavelength within the visible range of the spectrum (e.g., between about 400 nm and about 700 nm).

In some embodiments, a kit including one or more of the compositions previously discussed (e.g., a kit including a photoluminescent nanostructure, etc.) that can be used to produce and/or employ a photoluminescent nanostructure, is described. A “kit,” as used herein, typically defines a package or an assembly including one or more of the compositions of the invention, and/or other compositions associated with the invention, for example, as previously described. Each of the compositions of the kit may be provided in liquid form (e.g., a suspension of photoluminescent nanostructures, etc.), or in solid form. In certain cases, some of the compositions may be constitutable or otherwise processable, for example, by the addition of a suitable solvent, other species, or source of energy (e.g., electromagnetic radiation), which may or may not be provided with the kit. Examples of other compositions or components associated with the invention include, but are not limited to, solvents, surfactants, diluents, salts, buffers, emulsifiers, chelating agents, fillers, antioxidants, binding agents, bulking agents, preservatives, drying agents, antimicrobials, needles, syringes, packaging materials, tubes, bottles, flasks, beakers, dishes, frits, filters, rings, clamps, wraps, patches, containers, tapes, adhesives, and the like, for example, for using, administering, modifying, assembling, storing, packaging, preparing, mixing, diluting, and/or preserving the compositions components for a particular use, for example, to a sample and/or a subject.

A kit of the invention may, in some cases, include instructions in any form that are provided in connection with the compositions of the invention in such a manner that one of ordinary skill in the art would recognize that the instructions are to be associated with the compositions of the invention. For instance, the instructions may include instructions for the use, modification, mixing, diluting, preserving, administering, assembly, storage, packaging, and/or preparation of the compositions and/or other compositions associated with the kit. In some cases, the instructions may also include instructions for the delivery and/or administration of the compositions, for example, for a particular use, e.g., to a sample and/or a subject. The instructions may be provided in any form recognizable by one of ordinary skill in the art as a suitable vehicle for containing such instructions, for example, written or published, verbal, audible (e.g., telephonic), digital, optical, visual (e.g., videotape, DVD, etc.) or electronic communications (including Internet or web-based communications), provided in any manner.

The following examples are intended to illustrate certain embodiments of the present invention, but do not exemplify the full scope of the invention.

Recent discoveries of fluorescent quantum defects (FQDs) generated on pristine SWCNT structure reveals the first room-temperature single photon source emitted at telecom wavelengths. See, Ma, X. D., Hartmann, N. F., Baldwin, J. K. S., Doom, S. K. & Htoon, H. Room-temperature single-photon generation from solitary dopants of carbon nanotubes. Nat. Nanotechnol. 10, 671-675, doi:10.1038/nnano.2015.136 (2015); and He, X. W. et al. Tunable room-temperature single-photon emission at telecom wavelengths from sp³ defects in carbon nanotubes. Nat. Photonics 11, 577-583, doi:10.1038/nphoton.2017.119 (2017), each of which is incorporated by reference in its entirety. These quantum defects are pristine nanotubes either doped with oxygen or converted to sp³ conformation, thus creating local energy traps that allow only one exciton emitted at a time. See, Ghosh, S., Bachilo, S. M., Simonette, R. A., Beckingham, K. M. & Weisman, R. B. Oxygen Doping Modifies Near-Infrared Band Gaps in Fluorescent Single-Walled Carbon Nanotubes. Science 330, 1656-1659, doi:10.1126/science.1196382 (2010); Chiu, C. F., Saidi, W. A., Kagan, V. E. & Star, A. Defect-Induced Near-Infrared Photoluminescence of Single-Walled Carbon Nanotubes Treated with Polyunsaturated Fatty Acids. J. Am. Chem. Soc. 139, 4859-4865, doi:10.1021/jacs.7b00390 (2017); Piao, Y. et al. Brightening of carbon nanotube photoluminescence through the incorporation of sp³ defects. Nature Chem. 5, 840-845 (2013); and Saha, A. et al. Narrow-band single-photon emission through selective aryl functionalization of zigzag carbon nanotubes. Nature Chem., doi:10.1038/s41557-018-0126-4 (2018), each of which is incorporated by reference in its entirety. The availability of the single photon source is the key towards applications in quantum communications. See, See, Aharonovich, I., Englund, D. & Toth, M. Solid-State Single-Photon Emitters. Nat. Photonics 10, 631-641, doi:10.1038/nphoton.2016.186 (2016); and Chunnilall, C. J., Degiovanni, I. P., Kuck, S., Muller, I. & Sinclair, A. G. Metrology of single-photon sources and detectors: a review. Opt. Eng. 53, doi:10.1117/1.oe.53.8.081910 (2014), each of which is incorporated by reference in its entirety. These low-density energy traps also prevent bright excitons turning into dark excitons as well as being quenched by non-fluorescent defects, thus increasing the fluorescent quantum yields. See, Ghosh, S., Bachilo, S. M., Simonette, R. A., Beckingham, K. M. & Weisman, R. B. Oxygen Doping Modifies Near-Infrared Band Gaps in Fluorescent Single-Walled Carbon Nanotubes. Science 330, 1656-1659, doi:10.1126/science.1196382 (2010); and Piao, Y. et al. Brightening of carbon nanotube photoluminescence through the incorporation of sp³ defects. Nature Chem. 5, 840-845 (2013), each of which is incorporated by reference in its entirety. Also, the new emission at longer wavelength from the FQDs can allow the excitation from visible or near infrared to SWIR, indicating even less excitation scattering and lower autofluorescence when imaging through biological tissues. See, Ghosh, S., Bachilo, S. M., Simonette, R. A., Beckingham, K. M. & Weisman, R. B. Oxygen Doping Modifies Near-Infrared Band Gaps in Fluorescent Single-Walled Carbon Nanotubes. Science 330, 1656-1659, doi:10.1126/science.1196382 (2010); and Iizumi, Y. et al. Oxygen-doped carbon nanotubes for near-infrared fluorescent labels and imaging probes. Sci. Rep. 8, 6272, doi:10.1038/s41598-018-24399-8 (2018), each of which is incorporated by reference in its entirety. The FQDs also brighten ultrashort SWCNTs, which was considered to be non-fluorescent because the nanotube length is shorter than exciton diffusion length. See, Danné, N. et al. Ultrashort Carbon Nanotubes That Fluoresce Brightly in the Near-Infrared. ACS Nano, doi:10.1021/acsnano.8b02307 (2018); and Hertel, T., Himmelein, S., Ackermann, T., Stich, D. & Crochet, J. Diffusion Limited Photoluminescence Quantum Yields in 1-D Semiconductors: Single-Wall Carbon Nanotubes. ACS Nano 4, 7161-7168 (2010), each of which is incorporated by reference in its entirety. The advantage of using ultrashort SWCNTs around 50 nm range might be the prolonged blood circulation lifetime for imaging or delivery, and the lower toxicity. See, Hoshyar, N., Gray, S., Han, H. B. & Bao, G. The effect of nanoparticle size on in vivo pharmacokinetics and cellular interaction. Nanomedicine 11, 673-692, doi:10.2217/nnm.16.5 (2016); Toy, R., Peiris, P. M., Ghaghada, K. B. & Karathanasis, E. Shaping cancer nanomedicine: the effect of particle shape on the in vivo journey of nanoparticles. Nanomedicine 9, 121-134, doi:10.2217/nnm.13.191 (2014); and Kolosnjaj-Tabi, J. et al. In Vivo Behavior of Large Doses of Ultrashort and Full-Length Single-Walled Carbon Nanotubes after Oral and Intraperitoneal Administration to Swiss Mice. ACS Nano 4, 1481-1492, doi:10.1021/nn901573w (2010), each of which is incorporated by reference in its entirety.

Despite the amazing fluorescence properties from the FQDs, the efficient synthesis of high quality FQD-SWCNTs at scale is still an unmet goal. The current methods of creating FQDs on SWCNTs suffer from long reaction time, high density of non-fluorescent defects and the need of special reagents. For example, the reaction time for non-photon-activated defect creations takes several days. See, Piao, Y. et al. Brightening of carbon nanotube photoluminescence through the incorporation of sp³ defects. Nature Chem. 5, 840-845 (2013), which is incorporated by reference in its entirety. Fast reaction can be accomplished but leads to lower SWCNT quality. The photo-activated reaction from literature can react faster, which is ˜30 mins, but is still too slow for synthesis at scale. Other minor problems from reported methods are the reproducibility and controllability. See, lizumi, Y. et al. Oxygen-doped carbon nanotubes for near-infrared fluorescent labels and imaging probes. Sci. Rep. 8, 6272, doi:10.1038/s41598-018-24399-8 (2018), which is incorporated by reference in its entirety. Solving these problems should reduce the barrier for translating the FQD-SWCNTs into practical applications.

In this work, an efficient way to create FQDs on SWCNTs is presented. The method is unexpectedly reproducible, controllable, and rapid. This reaction dopes oxygen atoms obtained from bleach via photo-dissociation at 300 nm. The result shows that a maximum defect emission is reached within only 40 seconds while the density of non-fluorescent defects remains low. The density of the defect doping could be controlled by illumination time. The fluorescent quantum defects are oxygen doped (O-doped) sites in ether form and a simple reaction mechanism that explains this efficient reaction is proposed. The doping heterogeneity is explored and demonstrates a high-throughput synthesizer is ideal for in vivo imaging. Finally, the performance of the doping methods is compared with published literature.

One of the most intriguing properties of semiconducting single-wall carbon nanotubes (SWCNTs) is their structure-specific fluorescence at short-wave infrared (SWIR) wavelengths. See, O'Connell, M. J., et al. Band-gap fluorescence from individual single-walled carbon nanotubes. Science 297, 593-596 (2002); and Bachilo, S. M., et al. Structure-assigned optical spectra of single-walled carbon nanotubes. Science 298, 2361-2366 (2002) each of which is incorporated by reference in its entirety. This has inspired emerging applications in areas that include bioimaging and optical non-contact sensing. Williams, R. M., et al. Noninvasive ovarian cancer biomarker detection via an optical nanosensor implant. Science Advances 4, eaaq1090 (2018); Hong, G. S., Antaris, A. L. & Dai, H. J. Near-infrared fluorophores for biomedical imaging. Nat. Biomed. Eng. 1, 0010 (2017); Lin, C.-W., Bachilo, S. M., Vu, M., Beckingham, K. M. & Weisman, R. B. Spectral triangulation: a 3D method for locating single-walled carbon nanotubes in vivo. Nanoscale 8, 10348-10357 (2016); Lin, C.-W. & Weisman, R. B. In vivo detection of single-walled carbon nanotubes: progress and challenges. Nanomedicine 11, 2885-2888 (2016); Lin, C.-W., et al. In vivo optical detection and spectral triangulation of carbon nanotubes. ACS Appl. Mater. Interfaces 9, 41680-41690 (2017); Godin, A. G., et al. Single-nanotube tracking reveals the nanoscale organization of the extracellular space in the live brain. Nat. Nanotechnol. 12, 238-243 (2017); Galassi, T. V., et al. An optical nanoreporter of endolysosomal lipid accumulation reveals enduring effects of diet on hepatic macrophages in vivo. Sci. Transl. Med. 10, eaar2680 (2018); Withey, P. A., Vemuru, V. S. M., Bachilo, S. M., Nagarajaiah, S. & Weisman, R. B. Strain paint: noncontact strain measurement using single-walled carbon nanotube composite coatings. Nano Lett. 12, 3497-3500 (2012); Sun, P., Bachilo, S. M., Lin, C.-W., Weisman, R. B. & Nagarajaiah, S. Noncontact strain mapping using laser-induced fluorescence from nanotube-based smart skin. J. Struct. Eng. 145, 04018238 (2019); and Sun, P., Bachilo, S. M., Lin, C.-W., Nagarajaiah, S. & Weisman, R. B. Dual-layer nanotube-based smart skin for enhanced noncontact strain sensing. Struct. Control Health Monit. 26, e2279 (2019), each of which is incorporated by reference in its entirety. In addition, it has been shown that SWCNTs with some types of sparse covalent doping give spectrally shifted emission arising from the trapping of mobile excitons at the defect sites. Such intentionally doped nanotubes have been used to construct the first room-temperature single photon source emitting at telecom wavelengths, a key step for the development of quantum communications and cryptography. See, Ma, X. D., Hartmann, N. F., Baldwin, J. K. S., Doom, S. K. & Htoon, H. Room-temperature single-photon generation from solitary dopants of carbon nanotubes. Nat. Nanotechnol. 10, 671-675 (2015); He, X. W., et al. Tunable room-temperature single-photon emission at telecom wavelengths from sp³ defects in carbon nanotubes. Nat. Photonics 11, 577-583 (2017); He, X., et al. Carbon nanotubes as emerging quantum-light sources. Nat. Mater. 17, 663-670 (2018); Aharonovich, I., Englund, D. & Toth, M. Solid-state single-photon emitters. Nat. Photonics 10, 631-641 (2016); and Chunnilall, C. J Degiovanni, I. P., Kuck, S., Muller, I. & Sinclair, A. G. Metrology of single-photon sources and detectors: a review. Opt. Eng. 53, 081910 (2014), each of which is incorporated by reference in its entirety. The nanotube quantum defects are either ether-bridged oxygen atoms, which leave all carbon atoms sp²-hybridized, or organic addends, which convert nanotube atoms from sp² to sp³ hybridization at the functionalization site. Besides the ether conformation, oxygen doping is also known to generate epoxide adducts, which are less stable than the ether-bridged structures. See, Ghosh, S., Bachilo, S. M., Simonette, R. A., Beckingham, K. M. & Weisman, R. B. Oxygen doping modifies near-infrared band gaps in fluorescent single-walled carbon nanotubes. Science 330, 1656-1659 (2010); Chiu, C. F., Saidi, W. A., Kagan, V. E. & Star, A. Defect-induced near-infrared photoluminescence of single-walled carbon nanotubes treated with polyunsaturated fatty acids. J. Am. Chem. Soc. 139, 4859-4865 (2017); Iizumi, Y., et al. Oxygen-doped carbon nanotubes for near-infrared fluorescent labels and imaging probes. Sci. Rep. 8, 6272 (2018); Piao, Y., et al. Brightening of carbon nanotube photoluminescence through the incorporation of sp³ defects. Nature Chem. 5, 840-845 (2013); Saha, A., et al. Narrow-band single-photon emission through selective aryl functionalization of zigzag carbon nanotubes. Nature Chem. 10, 1089-1095 (2018); He, X., et al. Low-temperature single carbon nanotube spectroscopy of sp³ quantum defects. ACS Nano 11, 10785-10796 (2017); and Ma, X., et al. Electronic structure and chemical nature of oxygen dopant states in carbon nanotubes. ACS Nano 8, 10782-10789 (2014), each of which is incorporated by reference in its entirety. The sparse energy traps resulting from doping apparently suppress fluorescence quenching by dark excitons or structural defects, thereby increasing the nanotube emissive quantum yields. Unlike pristine SWCNTs, those with sparse doping show significant Stokes shifts between their SWIR absorption and emission bands. This property allows bio-imaging with SWIR excitation, reducing excitation scattering and suppressing autofluorescence from biological tissues. The fluorescent quantum defects also brighten ultrashort SWCNTs, which have potential biomedical advantages because of their size but are otherwise nonemissive because of end quenching. See, Danné, N., et al. Ultrashort carbon nanotubes that fluoresce brightly in the near-infrared. ACS Nano 12, 6059-6065 (2018); Toy, R., Peiris, P. M., Ghaghada, K. B. & Karathanasis, E. Shaping cancer nanomedicine: the effect of particle shape on the in vivo journey of nanoparticles. Nanomedicine 9, 121-134 (2014); Kolosnjaj-Tabi, J., et al. In vivo behavior of large doses of ultrashort and full-length single-walled carbon nanotubes after oral and intraperitoneal administration to Swiss mice. ACS Nano 4, 1481-1492 (2010); Hoshyar, N., Gray, S., Han, H. B. & Bao, G. The effect of nanoparticle size on in vivo pharmacokinetics and cellular interaction. Nanomedicine 11, 673-692 (2016); and Hertel, T., Himmelein, S., Ackermann, T., Stich, D. & Crochet, J. Diffusion limited photoluminescence quantum yields in 1-D semiconductors: single-wall carbon nanotubes. ACS Nano 4, 7161-7168 (2010), each of which is incorporated by reference in its entirety.

Broader use of SWCNTs containing fluorescent defects has been hampered by preparation methods that require special reactants, can be difficult to control, can proceed slowly, can generate non-emissive defects, or can be difficult to scale. A simple, quick, and controllable way to efficiently generate oxygen-doped SWCNTs can be attained using the methods described herein. Surfactant-suspended nanotubes in the presence of NaClO (bleach) are irradiated in the near-UV to induce photodissociation of ClO⁻ and form the desired doped SWCNTs. The doping density is readily controlled by illumination time, with maximal defect emission intensity reached in less than one minute. The reaction product is characterized by absorption, fluorescence, Raman, variance, and single particle spectroscopies and propose a simple reaction mechanism. We also describe a simple continuous flow reactor for efficiently preparing O-doped SWCNTs and demonstrate sensitive in vivo imaging in mice using SWIR fluorescence from our doped samples.

Optical Properties.

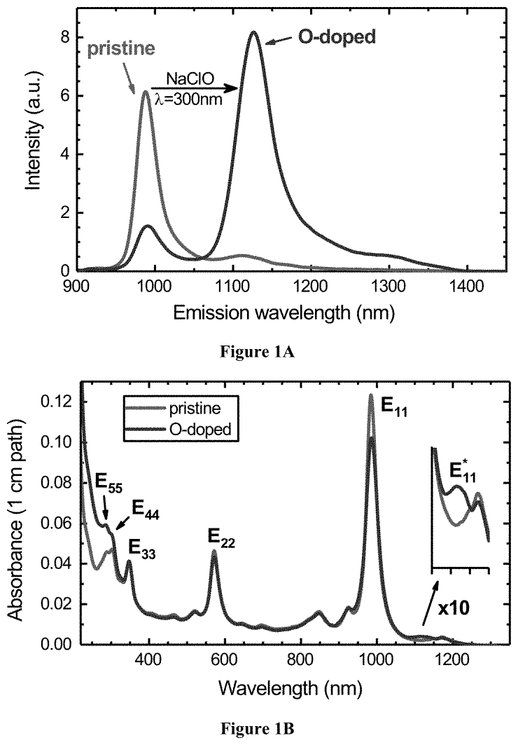

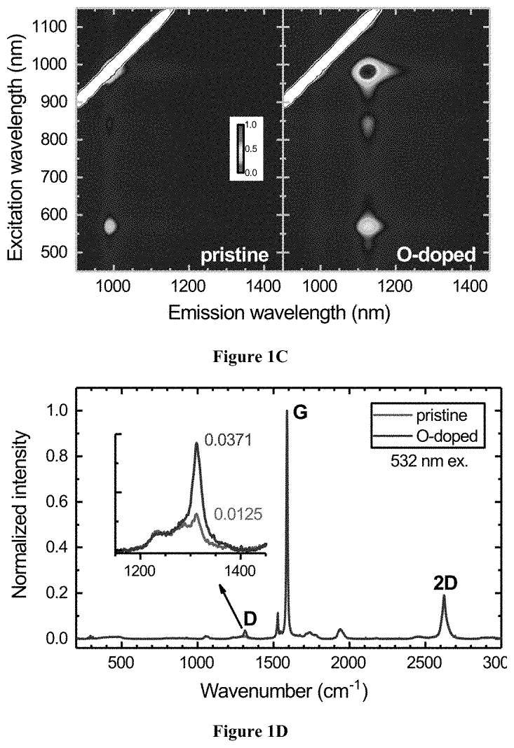

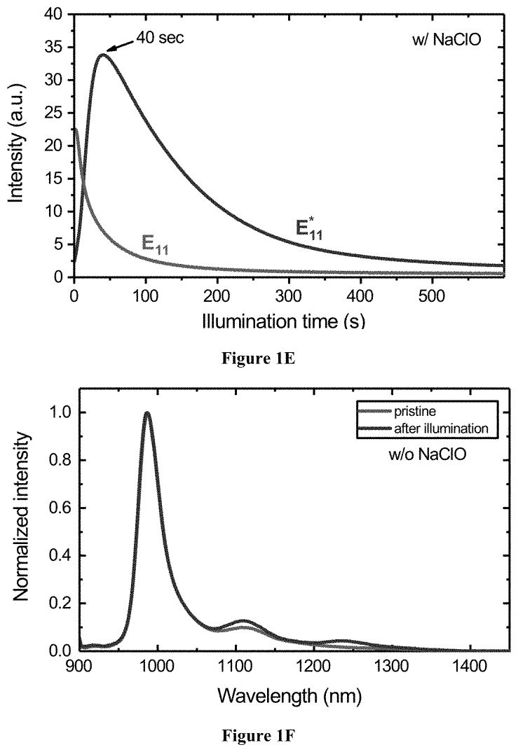

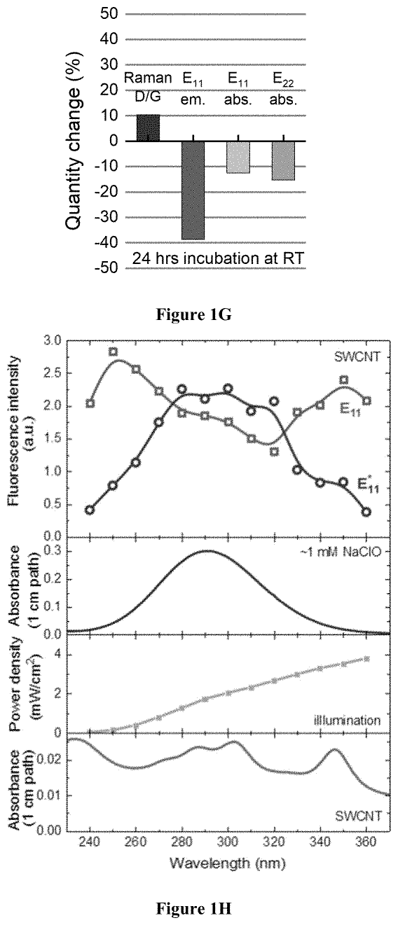

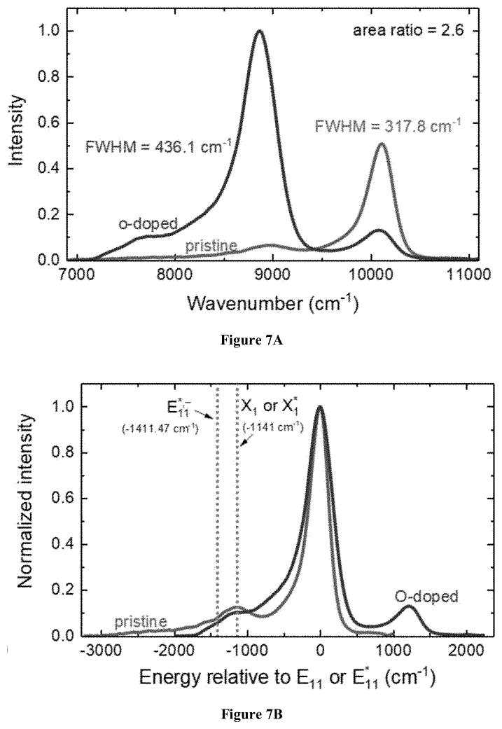

FIG. 1A shows the fluorescence spectra of bulk samples of (6,5)-sorted SWCNTs before and after treatment with bleach and UV light. Clear evidence of successful O-doping is the appearance of an intense red-shifted emission peak (E*₁₁) at 1126 nm and the decreased intensity of the pristine E₁₁ emission peak at 988 nm. The observed E*₁₁ wavelength matches values reported for (6,5) O-SWCNTs by Ghosh et al. and Chiu et al. Treatment shifts most of the sample emission from the pristine band to E*₁₁, indicating that a large fraction of nanotube excitons emit while trapped at O-doped sites. See, Ghosh, S., Bachilo, S. M., Simonette, R. A., Beckingham, K. M. & Weisman, R. B. Oxygen Doping Modifies Near-Infrared Band Gaps in Fluorescent Single-Walled Carbon Nanotubes. Science 330, 1656-1659, doi:10.1126/science.1196382 (2010).; and Chiu, C. F., Saidi, W. A., Kagan, V. E. & Star, A. Defect-Induced Near-Infrared Photoluminescence of Single-Walled Carbon Nanotubes Treated with Polyunsaturated Fatty Acids. J. Am. Chem. Soc. 139, 4859-4865, doi:10.1021/jacs.7b00390 (2017), each of which is incorporated by reference in its entirety. The long-wavelength side bands in the treated sample are assigned as X transitions (see FIG. 7A) and/or emission from parallel epoxide defects. The treatment increases the spectrally integrated emission by a factor of 2.6 (see FIG. 7A). FIG. 1B plots the sample's absorption spectra before and after doping treatment. Peak absorbance drops by 17.2% at E₁₁ and by 6.9% at E₂₂ after treatment. These changes to perturbations in the π-electron system from covalent doping. The inset in FIG. 1B, showing absorbance on a magnified scale, reveals for the first time a new induced feature peaking at 1114 nm, with a peak value ˜1.6% of the pristine E₁₁ peak. This is assigned to E*₁₁ absorption, parallel to the observed weak absorption band reported in sp³-doped SWCNTs. See, Piao, Y., et al. Brightening of carbon nanotube photoluminescence through the incorporation of sp³ defects. Nature Chem. 5, 840-845 (2013), which is incorporated by reference in its entirety.

FIG. 1C shows the excitation-emission profiles of pristine and O-doped SWCNT samples. Treatment shifts the coordinates of the dominant feature from (565 nm, 988 nm) to (988 nm, 1126 nm). Raman D/G band intensity ratios are commonly used to monitor covalent sidewall functionalization in SWCNTs. As shown in FIG. 1D, the D/G ratio of our sample increased from 0.013 to 0.037 on doping treatment. This final D/G ratio is notably smaller than values reported using other methods for generating fluorescent quantum defects in SWCNTs, suggesting minimal non-emissive defects from side reactions.

Reaction Investigations.

Fluorescence spectroscopy is the preferred method for observing the conversion of pristine to O-doped SWCNTs. Fortunately, in the reaction it is possible to use a single ultraviolet light source both to induce the reaction with ClO⁻ and also to excite sample fluorescence to monitor the extent of product formation. FIG. 1E shows time dependent intensities of the E₁₁ and E*₁₁ emission peaks from a dispersed (6,5)-sorted sample in aqueous sodium cholate (SC) and NaClO as it is irradiated with a few milliwatts of 300 nm light. This in situ monitoring reveals a clear maximum in intensity near 40 s while the pristine emission decays monotonically. Separate spectral measurements of the ClO⁻ concentration show that it decreases to less than 5% of its initial value by ca. 40 s (see FIG. 13), indicating that the reactant is almost fully consumed in the first minute of irradiation.

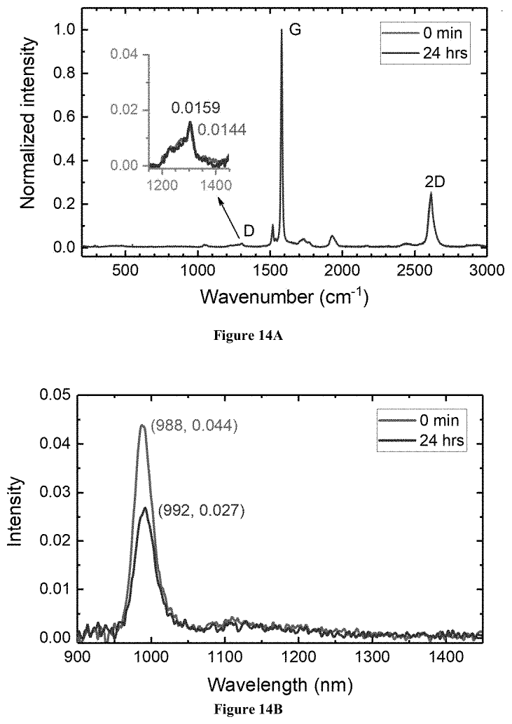

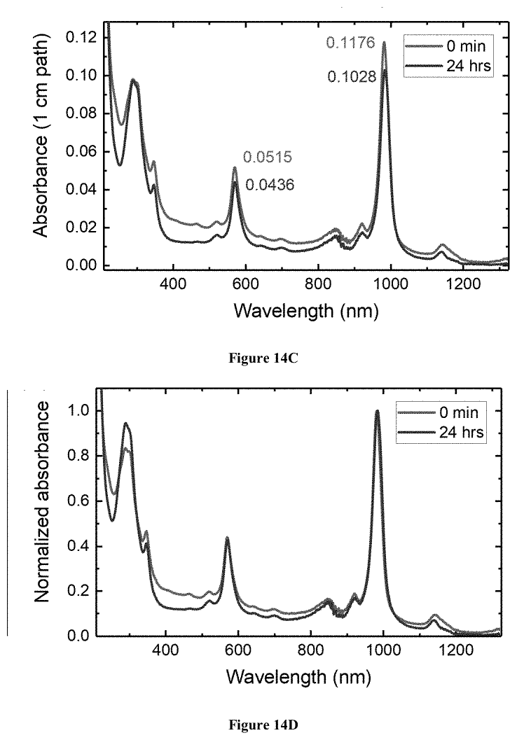

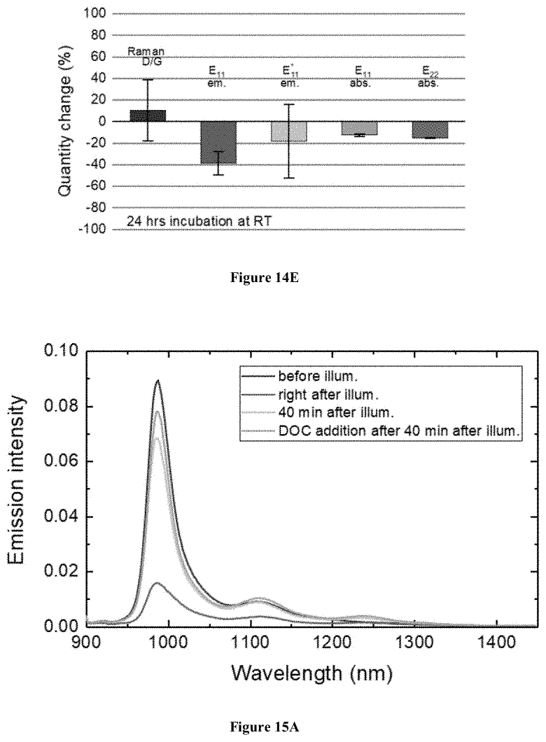

To investigate the intensity decays after 40 s in FIG. 1E, two control experiments were performed. In the first, SWCNT fluorescence was measured after irradiation at 300 nm for 50 s in the absence of NaClO (FIG. 1F). Very little change in the sample's emission intensity or spectral shape was observed, indicating that NaClO is essential for the reaction. In the second control experiment, samples contained NaClO but were not exposed to UV light. Here a suspension of (6,5)-enriched SWCNTs in 0.035% SC/0.75 mM NaClO was split into two aliquots. Aqueous 0.1% sodium deoxycholate (SDC) was immediately added to the first aliquot to protect the nanotubes from reaction and provide a reference. The other aliquot was kept in dark for 24 h before SDC was added. Spectral changes between the two portions were then measured and quantified. Exposure to NaClO for 24 h in the dark led to no significant E*₁₁ feature or increase in Raman D/G ratio. This agrees with the result reported by Chiu et al., who used an enzyme to produce low concentrations of ClO⁻ ions. See, Chiu, C. F., et al. Enzyme-catalyzed oxidation facilitates the return of fluorescence for single-walled carbon nanotubes. J. Am. Chem. Soc. 135, 13356-13364 (2013), which is incorporated by reference in its entirety. A 39% decrease in E₁₁ emission and a broad reduction in absorption was observed, probably reflecting some oxidative destruction of SWCNTs by ClO⁻ (see FIG. 14). However, that process is negligibly slow on the scale of our sub-minute reaction time. Both ClO⁻ and photoexcitation appear to be required for the O-doping reaction to proceed.

Illuminations at various wavelengths were performed to obtain the action spectra at E₁₁ and E*₁₁ peaks (FIG. 1H). The E*₁₁ intensity reaches maximum and the E₁₁ intensity reaches minimum among 280-320 nm.

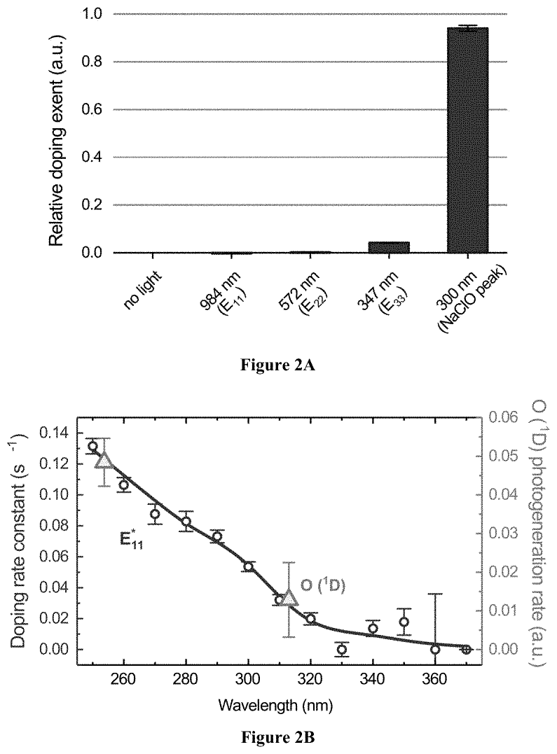

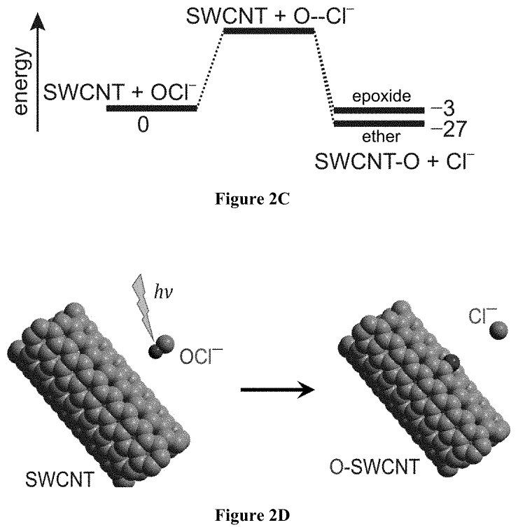

A key clue to a photochemical reaction's mechanism is its action spectrum, which was investigated by measuring spectral changes in replicate samples irradiated at various wavelengths. FIG. 2A shows the relative increase in E*₁₁ emission after treatment with irradiation at the first, second, and third SWCNT resonant absorption bands, as well as at 300 nm. The results have been normalized to irradiation power. They indicate that the doping reaction is not induced by direct SWCNT excitation. In FIG. 2B, circles show doping rates (corrected for irradiation power) at a number of UV wavelengths. The increase in rates at shorter irradiation wavelengths indicates that the doping reaction is aided by excess energy in the photogenerated reactant, which we deduce to be oxygen atoms formed through photodissociation of aqueous ClO⁻ ions. A plausible channel for oxygen excitation would be its release in the excited ¹D state rather than the ³P ground state, which can occur for ClO⁻ irradiation wavelengths below 320 nm. The ¹D oxygen could then react with SWCNTs in a spin-allowed process. In FIG. 2B, the two solid green symbols show the relative formation rates of ¹D oxygen atoms, based on the experimental parameters and the photodissociative quantum yields reported by Buxton et al. See, Buxton, G. V. & Subhani, M. S. Radiation-chemistry and Photochemistry of Oxychlorine Ions. 2. Photodecomposition of Aqueous-solutions of Hypochlorite Ions. J. Chem. Soc. Faraday Trans. I 68, 958-&, doi:10.1039/f19726800958 (1972); and Rao, B. et al. Perchlorate Production by Photodecomposition of Aqueous Chlorine Solutions. Environ. Sci. Technol. 46, 11635-11643, doi:10.1021/es3015277 (2012), each of which is incorporated by reference in its entirety. The following general mechanism is proposed for photoinduced oxygen doping of SWCNT in the presence of aqueous NaClO:

ClO⁻ [symbol] O+Cl⁻

SWCNT+O→SWCNT−O,

Therefore, the overall reaction can be written as

SWCNT+ClO⁻ [symbol] SWCNT−O+Cl⁻

The quantum yield of oxygen atom generation should be higher than 7.5%, but some of them will be quenched by surfactants and water. Only those are very close to the SWCNT wall can diffuse and arrive at the SWCNT surface. See, Buxton, G. V. & Subhani, M. S. Radiation-chemistry and Photochemistry of Oxychlorine Ions. 2. Photodecomposition of Aqueous-solutions of Hypochlorite Ions. J. Chem. Soc. Faraday Trans. 168, 958-&, doi:10.1039/f19726800958 (1972), which is incorporated by reference in its entirety. This reaction only generates residual sodium chloride salts with a concentration of ˜1 mM. Previous studies suggest that SWCNTs aggregates in the time scale of hours after ˜30 mM of NaCl addition. See, Sanchez, S. R., Bachilo, S. M. & Weisman, R. B. Variance Spectroscopy Studies of Single-Wall Carbon Nanotube Aggregation. The Journal of Physical Chemistry C, doi:10.1021/acs.jpcc.8b07173 (2018), which is incorporated by reference in its entirety. However, about 1 mM of residual NaCl seems not tocause severe aggregation, especially within the reaction time scale. See, Sanchez, S. R., Bachilo, S. M., Kadria-Vili, Y. & Weisman, R. B. Skewness Analysis in Variance Spectroscopy Measures Nanoparticle Individualization. J. Phys. Chem. Lett. 8, 2924-2929, doi:10.1021/acs.jpclett.7b01184 (2017); and Niyogi, S. et al. Selective Aggregation of Single-Walled Carbon Nanotubes via Salt Addition. J. Am. Chem. Soc. 129, 1898-1899, doi:10.1021/ja068321j (2007), each of which is incorporated by reference in its entirety. The solution was added extra DOC or SC right after reaction to cease any possible aggregation and side reaction due to exposure of SWCNT surface.

FIG. 2C shows semiempirical quantum chemical energies for the reactant and product species in the proposed mechanism, which is illustrated in FIG. 2D. The major O-SWCNT product is the ether form rather than the epoxide. Doping using photolyzed ClO⁻ may give higher selectivity towards the ether product as compared to the original ozone method (See Table 5).

Effects of Surfactant and Hypochlorite Concentrations.

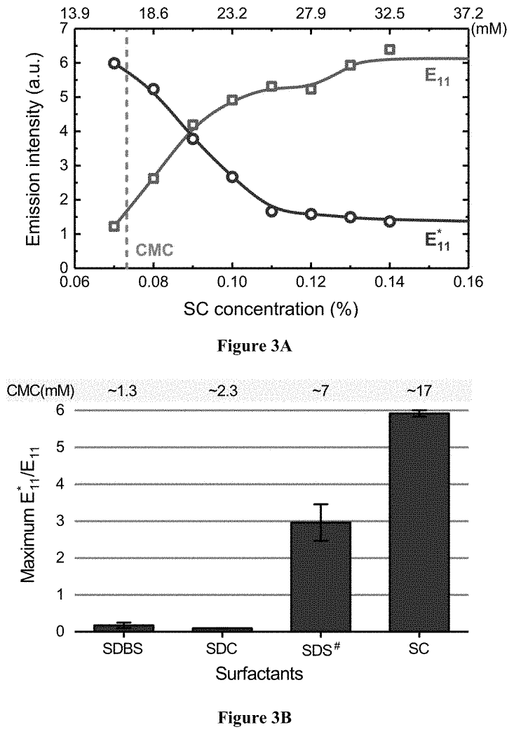

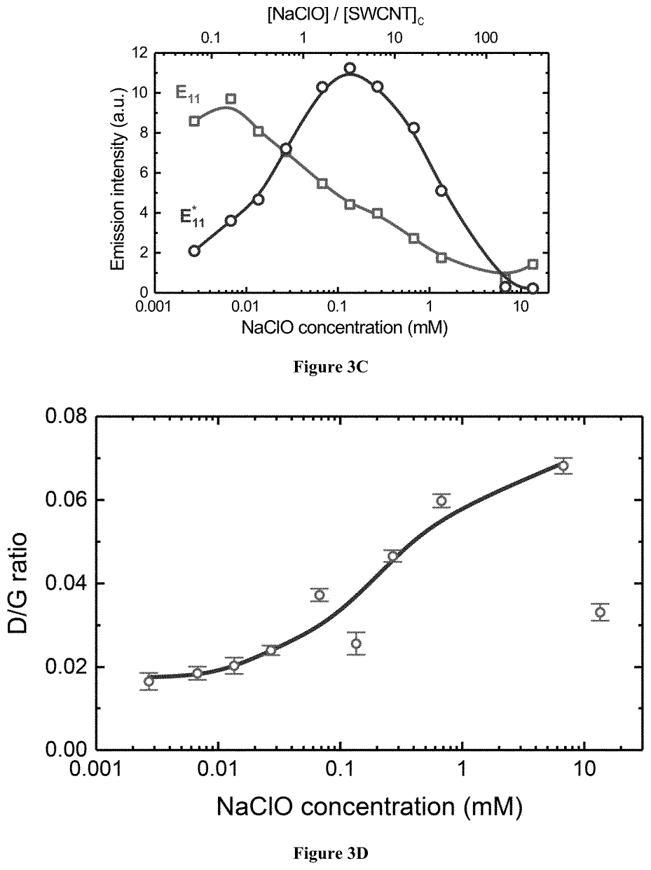

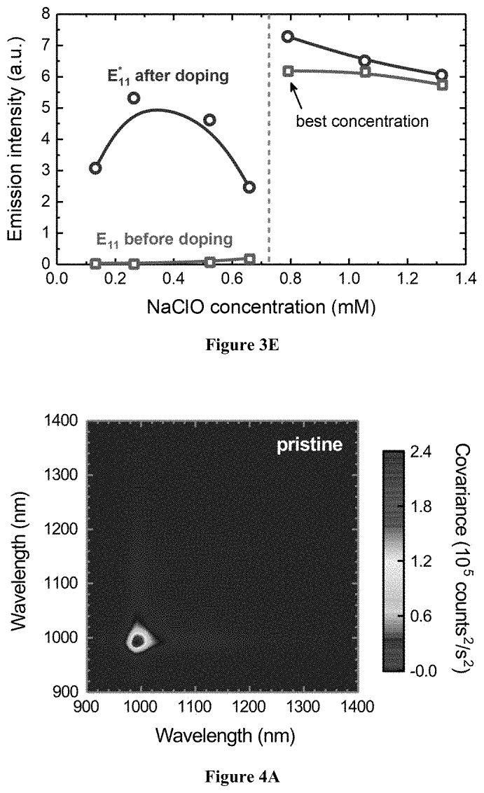

Surfactant concentration is an important parameter in the O-doping reaction, as can be seen from the pristine and shifted emission intensities plotted in FIG. 3A. Nanotube doping is minimal at high concentrations of SC and greatest below the critical micelle concentration (CMC) of 17 mM. High surfactant concentrations can be expected to enable effective micellar shielding of nanotube surfaces from dissolved species, preventing reactions with photochemically generated oxygen atoms. This shielding effect is similar to the strong coating dependence in the recently reported reversible quenching of SWCNT fluorescence by dissolved O₂. See, Zheng, Y., Bachilo, S. M. & Weisman, R. B. Quenching of single-walled carbon nanotube fluorescence by dissolved oxygen reveals selective single-stranded DNA affinities. J. Phys. Chem. Lett. 8, 1952-1955 (2017), which is incorporated by reference in its entirety. Here, the optimal SC concentration for doping was found to be 0.035-0.07%, corresponding to 8-16 mM, or below the CMC of SC. Fortunately, potential nanotube aggregation at these low surfactant concentrations is not a concern on the short time scale of the doping reaction.

FIG. 3B compares the maximum E*₁₁ to E₁₁ ratios obtained with four common nanotube surfactants: sodium dodecylbenzene sulfonate (SDBS), SDC, sodium dodecyl sulfate (SDS) and SC. They are shown in the order of their CMC values. Both SC and SDS give high doping reaction yields, consistent with their behavior as weaker agents for SWCNT dispersion. It was found that unexcited NaClO quenches the fluorescence of SWCNTs in 2% w/v SDS. It is possible that even at this high surfactant concentration, HClO in the slightly acidic solution can penetrate to the nanotube surface and strongly perturb the π-electron system. Subsequent addition of a competing surfactant such as SC or SDC restores the fluorescence. Both SDBS and SDC permit very little oxygen doping during our photoexcited bleach treatment, even when the SDC concentration is tuned to below 3×10⁻³% and E₁₁ emission is too weak to be observed. Surfactant identity and concentration can be important parameters that control access of oxygen doping reactants to the nanotube surface.

FIG. 3C plots the emission intensities of treated SWCNTs as a function of NaClO concentration. The strongest doping is found near 0.1 mM, corresponding to a ratio of NaClO molecules to carbon atoms of ˜3. Based on this finding, it is suggested that lower NaClO concentrations generate sub-optimal densities of oxygen doping sites, whereas higher concentrations lead to excessive nonemissive defects, lowering both the pristine and doped emission intensities (see FIG. 3D for D/G Raman ratios).

In certain examples, the optimal SC concentration for oxygen doping was found to be 0.035-0.07%, corresponding to 8-16 mM, which is right below the critical micelle concentration (CMC) of SC. The lower the surfactant concentration, the easier the SWCNTs aggregate over time. Fortunately, the aggregation rate is not a big concern within the time scale of one minute. Mild aggregation could be redispersed using mild bath sonication. FIG. 3D shows the emission intensity at different NaClO concentrations. The optimal concentration is around ˜1 mM. The basic SC surfactant gives the solution pH ˜9.3, which is much higher than the pKₐ of HClO/ClO⁻ at 7.5. Therefore, most of the hypochlorite molecules exist in the form of ClO⁻ instead of HClO. It was observed that the E₁₁ emission is quenched before illumination when the NaClO concentration is lower than 0.7 mM. This suggest that the ClO⁻ might have quenched SWCNT fluorescence by changing the band structure of the SWCNTs. Surprisingly, when the NaClO concentration is higher than 0.7 mM, the E₁₁ fluorescence was not quenched. One reason for this can be due to the slightly higher pH provided by the NaClO solution makes the SWCNT coating better to prevent the negatively charged ClO⁻ ions to reach the SWCNT surface but still allow the neutral oxygen atom to reach the SWCNT surface. Therefore, it can be preferred to control the NaClO right above the critical concentration not only because it yields higher intensity but also because the ability to monitor the reaction process. Controlling the pH higher than pKa of NaClO is important because the existence of HClO at low pH degrades the SWCNT structure. See, Vlasova, I I et al. PEGylated single-walled carbon nanotubes activate neutrophils to increase production of hypochlorous acid, the oxidant capable of degrading nanotubes. Toxicol. Appl. Pharmacol. 264, 131-142, doi:10.1016/j.taap.2012.07.027 (2012), which is incorporated by reference in its entirety.

Doping Analysis.

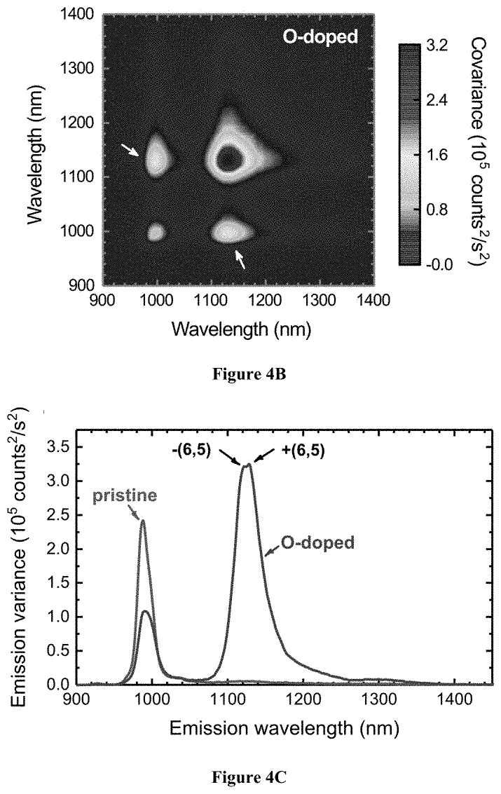

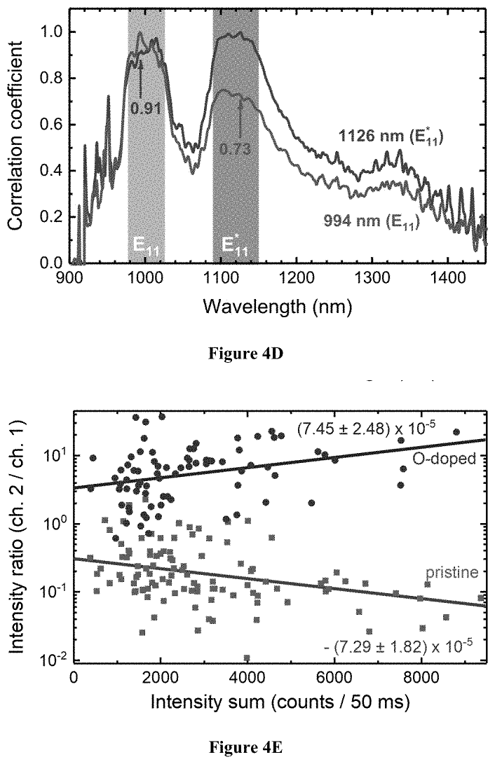

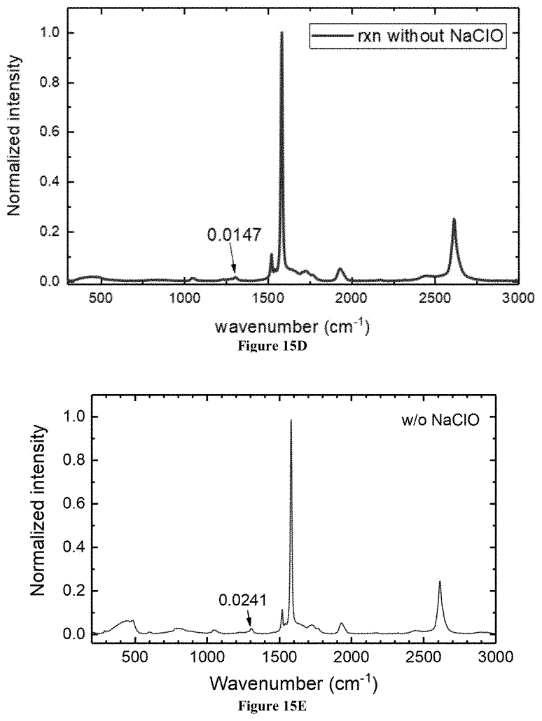

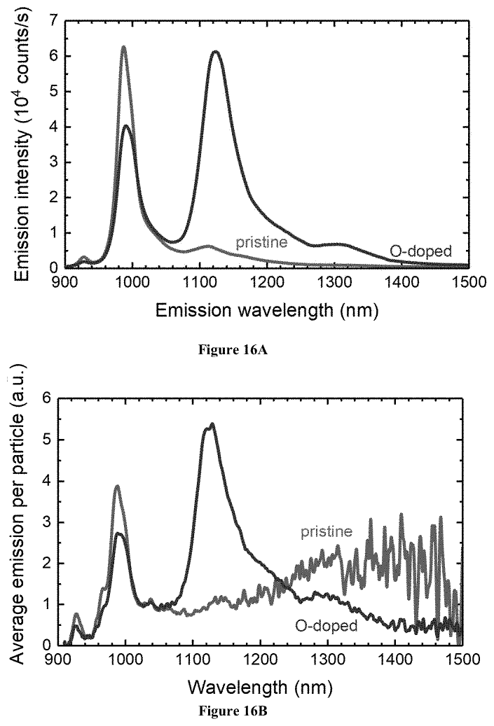

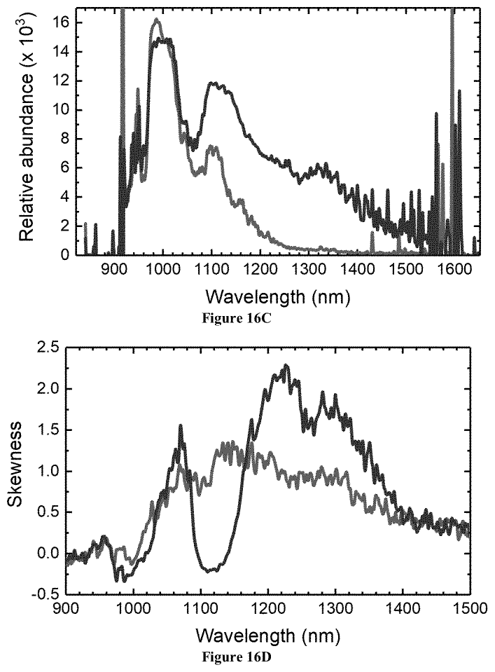

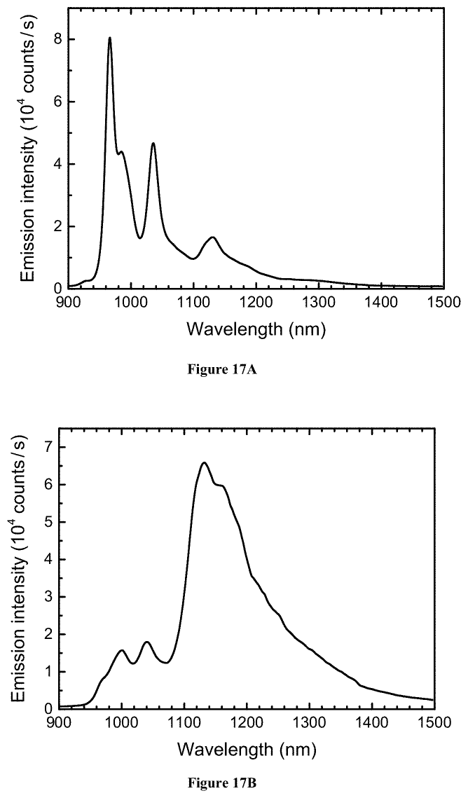

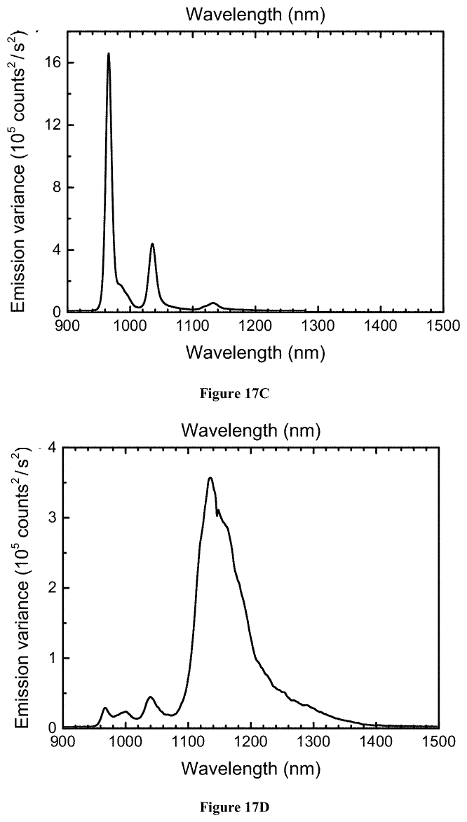

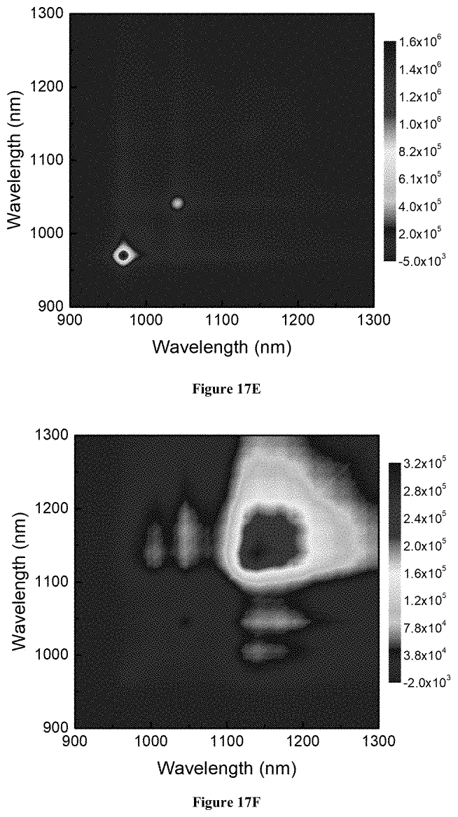

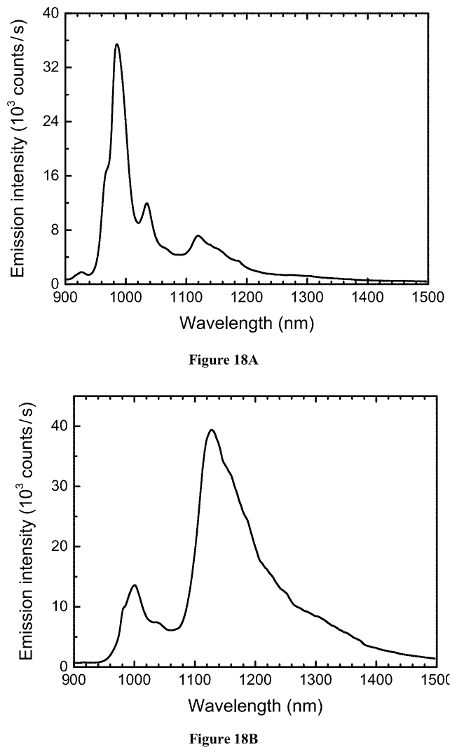

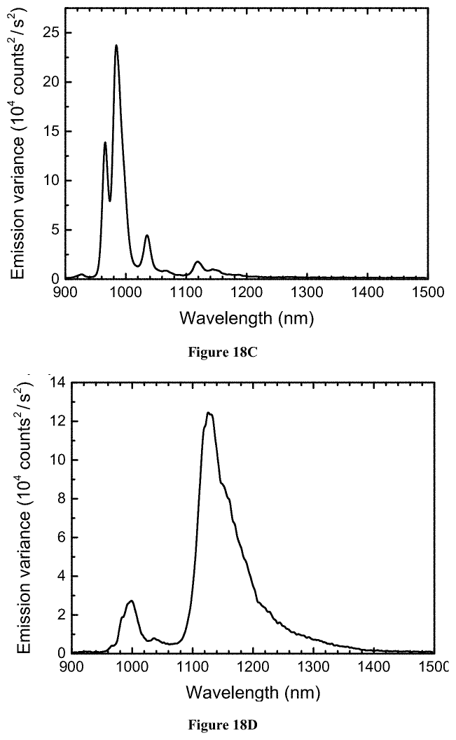

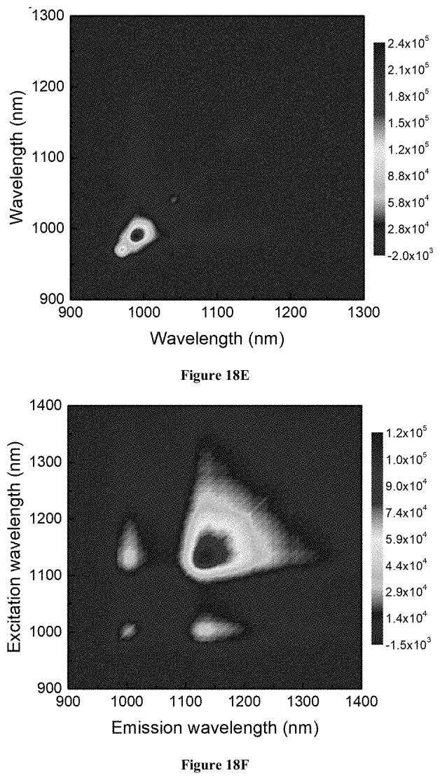

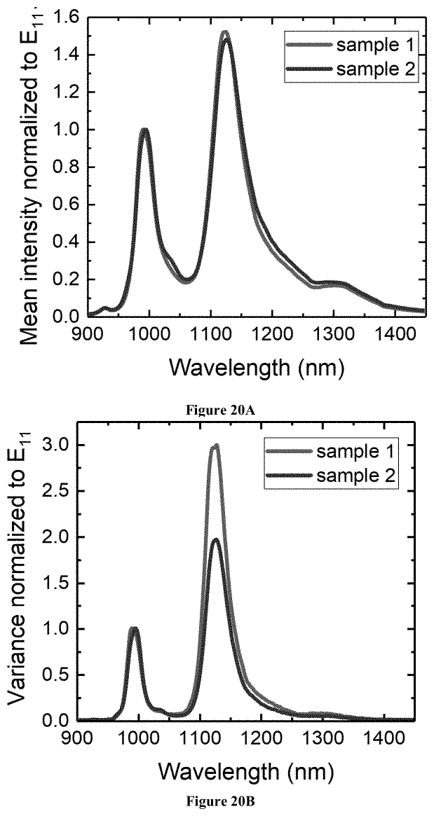

The extent and homogeneity of O-doping in treated nanotubes is important for applications such as fluorescent probes and single photon sources. To characterize these parameters, we supplemented ensemble spectral measurements with variance and single-particle emission spectroscopies. Variance spectroscopy is a recently developed method that evaluates the statistical differences among many replicate emission spectra from small volumes of a dilute sample to find the concentrations and associations of various emitting species. See, Streit, J. K., Bachilo, S. M., Sanchez, S. R., Lin, C.-W. & Weisman, R. B. Variance spectroscopy. J. Phys. Chem. Lett. 6, 3976-3981 (2015); Sanchez, S. R., Bachilo, S. M., Kadria-Vili, Y., Lin, C. W. & Weisman, R. B. (n,m)-specific absorption cross sections of single-walled carbon nanotubes measured by variance spectroscopy. Nano Lett. 16, 6903-6909 (2016); and Kadria-Vili, Y., Sanchez, S. R., Bachilo, S. M. & Weisman, R. B. Assessing inhomogeneity in sorted samples of single-walled carbon nanotubes through fluorescence and variance spectroscopy. ECS J. Solid State Sci. Technol. 6, M3097-M3102 (2017), each of which is incorporated by reference in its entirety. Variance data from a sample can be plotted to a show a covariance contour map in which diagonal features represent emission peaks of distinct particles and off-diagonal features arise from particles that emit at two different wavelengths. FIGS. 4A and 4B show such covariance maps for samples of pristine and O-doped (6,5)-SWCNTs (see FIG. 16A for the corresponding mean spectra). The map for the pristine sample has a single diagonal feature at the 994 nm E₁₁ peak. After doping treatment, that feature becomes less intense and a dominant diagonal E*₁₁ peak appears at 1126 nm. FIG. 4C compares the two variance spectra (diagonal traces in the covariance maps) before and after doping. An interesting feature of the O-doped variance spectrum is barely resolved E*₁₁ peaks ˜6 nm apart. These are assigned to emission from doped (6,5) SWCNTs of opposite helicity. It has been reported that such enantiomeric spectral shifts can be induced by differing coating structures of chiral cholate surfactants on SWCNTs. See, Sanchez, S. R., Bachilo, S. M., Kadria-Vili, Y., Lin, C. W. & Weisman, R. B. (n,m)-specific absorption cross sections of single-walled carbon nanotubes measured by variance spectroscopy. Nano Lett. 16, 6903-6909 (2016), Ghosh, S., Bachilo, S. M. & Weisman, R. B. Advanced sorting of single-walled carbon nanotubes by nonlinear density-gradient ultracentrifugation. Nat. Nanotechnol. 5, 443-450 (2010); and Ao, G. Y., Streit, J. K., Fagan, J. A. & Zheng, M. Differentiating left- and right-handed carbon nanotubes by DNA. J. Am. Chem. Soc. 138, 16677-16685 (2016), each of which is incorporated by reference in its entirety. The most significant qualitative finding from our variance data is the presence of clear off-diagonal features in FIG. 4B (marked by white arrows) that reveal strong spatial correlations between 994 nm and 1126 nm fluorescence. These demonstrate that both pristine and O-doped emissive sites coexist on individual nanotubes, in agreement with previous findings from a single-particle imaging study. See, Hartmann, N. F., et al. Photoluminescence imaging of solitary dopant sites in covalently doped single-wall carbon nanotubes. Nanoscale 7, 20521-20530 (2015), which is incorporated by reference in its entirety. Quantitative analysis of covariance spectral data provides a way to estimate the relative populations of treated SWCNTs showing pristine and doped emission. This requires the Pearson correlation coefficient (p) for signals at the two peak positions, which can be expressed as

$${ρ}_{{λ}_{j}} ( {λ}_{k} ) = \frac{{COV}_{{λ}_{j}} ( {λ}_{k} )}{{E}_{{λ}_{j}} ( {λ}_{k} )}$$

where COV_{λ}_{ⱼ}(λₖ) is the covariance of λⱼ and λₖ normalized to the variance of λⱼ, cov(λⱼ,λₖ)/σ²(λⱼ), and E_{λ}_{ⱼ}(λₖ) is the relative emission efficiencies of λₖ to λⱼ, ε(λₖ)/ε(λⱼ). FIG. 4D plots the full correlation spectra ρ_{994 nm}(λ) and ρ_{1126 nm}(λ), which are horizontal traces through the covariance map at the 994 and 1126 peaks. The two plateaus near those E₁₁ and E*₁₁ emission wavelengths represent strongly correlated components. Their magnitudes indicate that ˜91% of the E*₁₁ emitting SWCNTs also show E₁₁ emission while ˜73% of the E₁₁ emitting SWCNTs also emit at the E*₁₁ wavelength. The abundances of the following three categories of SWCNTs can be deduced in the treated sample: ˜26% remain undoped, showing E₁₁ emission only; ˜7% show E*₁₁ emission only; and ˜67% show both E*₁₁ and E₁₁ emission. Note that one cannot deduce these abundances just from the E*₁₁/E₁₁ ratio, and the fraction of undoped SWCNTs may be less than 5% even when the E*₁₁/E₁₁ peak ratio is only ˜1.5 (see FIG. 20A). The fractions of the following three types of SWCNTs can be further extracted: E₁₁ emission only (F_{E}_{₁₁}_{^{only}}˜0.26), E*₁₁ emission only (F_{E*}_{₁₁}_{^{only}}˜0.07), and both E*₁₁ and E₁₁ emissions (F_{E}_{₁₁}_{+E*}_{₁₁}˜0.67).

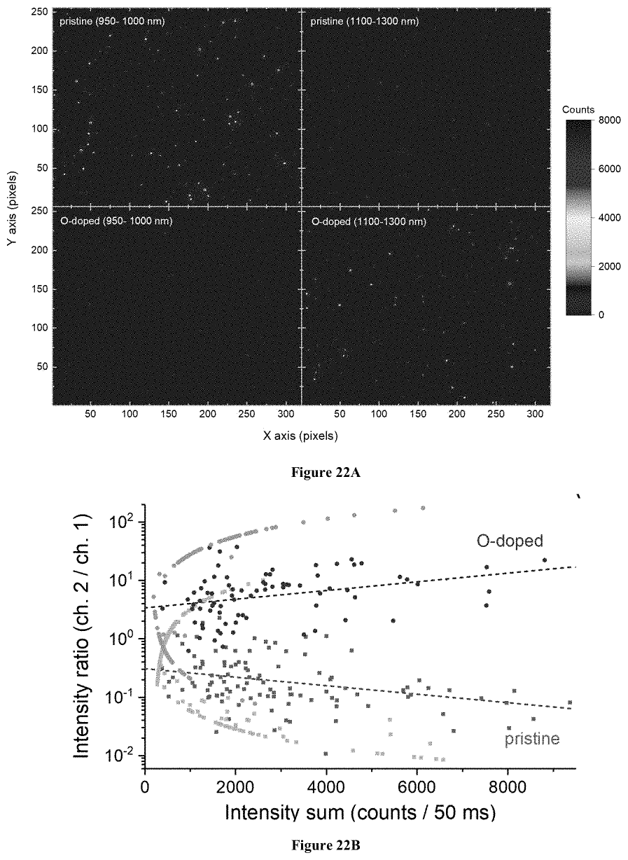

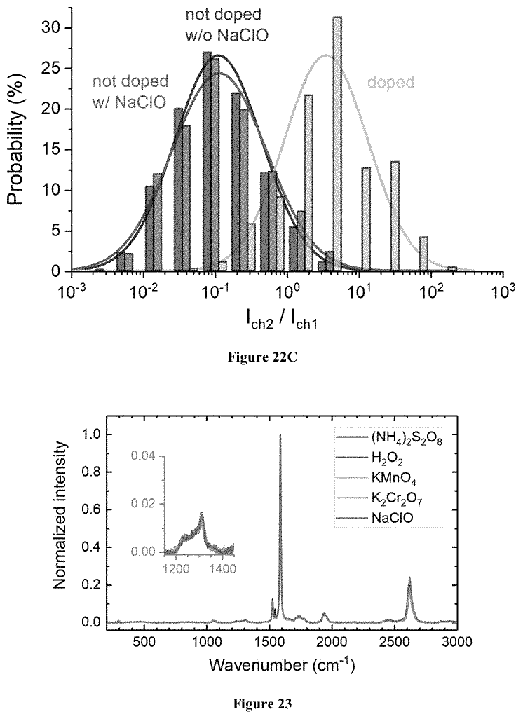

Single particle measurements reveal additional information about dopant homogeneity. As shown in FIG. 22, spectrally filtered SWIR fluorescence microscopy was used to separately measure E*₁₁ and E₁₁ emission from many individual SWCNTs in treated and control nanotube samples. The correlation of the E*₁₁/E₁₁ ratio with the total particle emission was examined, which is an approximate gauge of nanotube length. O-doped SWCNTs show a positive correlation between intensity ratio and nanotube length. This implies that doping is not restricted to sites at the nanotube ends, because that would lead to relatively more pristine emission in longer nanotubes and a negative correlation. This conclusion is consistent with previous findings based on fluorescence imaging of individual doped nanotubes. See, Hartmann, N. F., et al. Photoluminescence imaging of solitary dopant sites in covalently doped single-wall carbon nanotubes. Nanoscale 7, 20521-20530 (2015), which is incorporated by reference in its entirety. It was also found that longer SWCNTs in treated samples show less variation in E*₁₁/E₁₁ ratio than shorter SWCNTs. This can be because the smaller average number of doping sites in short nanotubes leads to larger statistical fluctuations in their spectral signatures. Based on the recent study by Danne et al., ultrashort O-doped SWCNTs are more likely to show only E*₁₁ emission. Length heterogeneity in samples of O-doped SWCNTs therefore contributes to the observed spectral heterogeneity. See, Danne, N., et al. Ultrashort carbon nanotubes that fluoresce brightly in the near-infrared. ACS Nano 12, 6059-6065 (2018), which is incorporated by reference in its entirety.

Therefore, about a quarter of the SWCNTs are not doped for this specific sample. Note that the E*₁₁/E₁₁ ratio (doping extent) does not necessarily correlate to the doping heterogeneity (FIGS. 20A-20C). It is demonstrated that F_{E}_{₁₁}_{^{only}} can be less than 5% with E*₁₁/E₁₁ ratio ˜2 (FIGS. 20A-20C). The correlation between the doping extent and SWCNT lengths can be further addressed using single particle measurements. FIG. 4E show the intensity ratio vs intensity sum for two-channel (ch1: 950-1000 nm; ch2: 1100-1300 nm) measurements of SWCNTs spread on a coverslip. Here, the SWCNT brightness increases monotonically with SWCNT length. For pristine SWCNTs, longer SWCNTs have lower non-fluorescent defects, leading to lower intensity ratio. For O-doped SWCNTs, the intensity ratio is higher for longer SWCNTs, indicating homogeneous doping throughout the SWCNT wall. Also, shorter SWCNTs show larger variation of the intensity ratio for both pristine and O-doped SWCNTs, probably because the exciton meets non-fluorescent defect sites easily. For the O-doped SWCNT sample, it is reasonable to consider the long SWCNTs have both E₁₁ and E*₁₁ emission and have relative constant quantum defect density. Short SWCNT have larger variation depending on whether there is a fluorescent quantum defect in the SWCNTs. The heterogeneous length distribution of SWCNT ensemble is the main reason that makes the O-doped sample more diverse.

High Throughput Reactor for In Vivo Imaging.

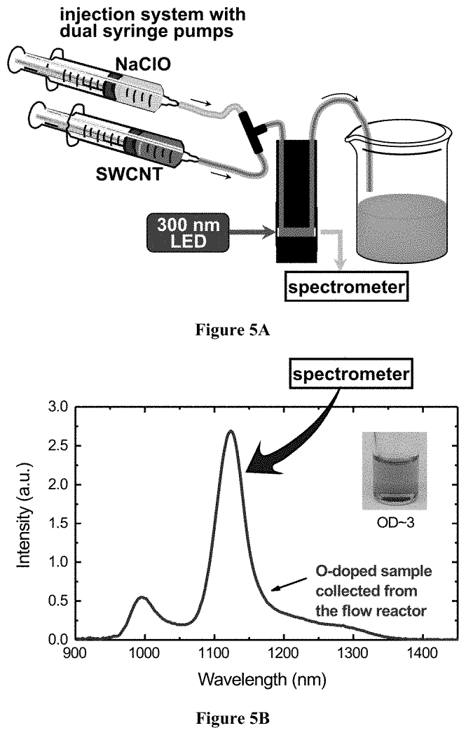

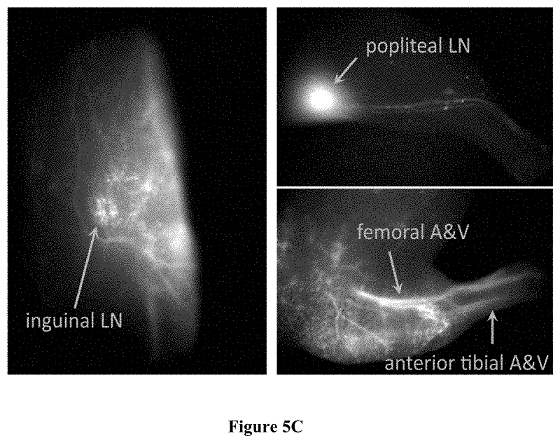

A custom-designed flow reactor for the efficient production of O-doped SWCNTs was constructed. FIG. 5A schematically illustrates our device. NaClO solution and a concentrated SWCNT suspension (OD=34 cm⁻¹ at E₁₁) are loaded into separate syringes and then mixed just before injection into a spectrophotometric flow cell used as the reaction chamber. The mixture is illuminated by light from a 300 nm LED, which induces the reaction and also excites fluorescence in the sample. The resulting nanotube emission is transmitted to a near-IR spectrometer for monitoring. Immediately following the doping reaction, we added extra SC surfactant to protect the SWCNT sidewalls and prevent possible aggregation or side reactions. FIG. 5B plots the emission spectrum of a treated sample containing 6 mg mL⁻¹ of (6,5)-SWCNTs, as determined from its E₁₁ peak absorbance of ˜3 cm⁻¹ and the known (6,5) absorptivity. See, Streit, J. K., Bachilo, S. M., Ghosh, S., Lin, C.-W. & Weisman, R. B. Directly measured optical absorption cross sections for structure-selected single-walled carbon nanotubes. Nano Len. 14, 1530-1536 (2014), which is incorporated by reference in its entirety. This device can produce up to ca. 0.3 mg h⁻¹ of O-doped SWCNTs per mL of reaction chamber under 29 mW cm⁻² of UV illumination.

The maximum reaction rate calculated from FIG. 1E is around 0.3 mg/hr/mL reaction chamber under 29 mW/cm² of illumination. In vivo imaging using O-doped SWCNTs. As was discussed in a prior report, O-doped SWCNTs are preferable to pristine SWCNTs for bio-imaging because their fluorescence can be excited at the E₁₁ transition and detected at E*₁₁. The use of longer wavelength excitation allows better tissue penetration and greatly suppressed autofluorescence backgrounds. To demonstrate this application, we prepared a batch of O-doped SWCNTs in our high throughput reactor, suspended them in DSPE-PEG₅ₖ (a biocompatible surfactant coating (1,2-distearoyl-sn-glycero-3-phosphoethanolamine-N-[amino(polyethylene glycol)-5000] (DSPE-PEG5k)), and injected small samples into mice. The in vivo specimens were excited at 980 nm and imaged through optical filters to isolate the E*₁₁ emission. High contrast images displaying clear vascular and lymphatic structure with low autofluorescence backgrounds are shown in FIG. 5C. Note that some organic dyes such as indocyanine green require the blockage of emission wavelengths shorter than 1300 nm to achieve the same level of image contrast because their shorter wavelength excitation leads to much higher autofluorescence backgrounds. See, Carr, J. A. et al. Shortwave infrared fluorescence imaging with the clinically approved near-infrared dye indocyanine green. Proc. Natl. Acad. Sci. U.S.A 115, 4465-4470, doi:10.1073/pnas.1718917115 (2018), which is incorporated by reference in its entirety. Moreover, the dosage used here, only ˜100 ng of SWCNTs per mouse (˜4 μg kg⁻¹), is among the lowest reported for nanoparticle-based fluorescent probes. See, Antaris, A. L., et al. Ultra-low doses of chirality sorted (6,5) carbon nanotubes for simultaneous tumor imaging and photothermal therapy. ACS Nano 7, 3644-3652 (2013), which is incorporated by reference in its entirety. The ability to locate sentinel nodes is crucial for diagnosing tumor metastasis, studying immune system related disease, and developing immunotherapeutic methods. See, Torabi, M., Aquino, S. L. & Harisinghani, M. G. Current concepts in lymph node imaging. J. Nucl. Med. 45, 1509-1518 (2004), which is incorporated by reference in its entirety. The O-doped SWCNTs provide high-resolution imaging of sentinel nodes and therefore can be a new candidate for fluorescence-based lymphoscintography or in vivo lymph node histology. See, Knackstedt, R. W., Couto, R. A. & Gastman, B. Indocyanine green fluorescence imaging with lymphoscintigraphy for sentinel node biopsy in head and neck melanoma. J. Surg. Res. 228, 77-83 (2018), which is incorporated by reference in its entirety. Clear vascular structure with low autofluorescence backgrounds demonstrates the excitation and emission wavelengths of O-doped (6,5)-SWCNTs is ideal for in vivo imaging. Also, the dosage at ˜100 ng per mouse (˜4 μg/kg) for in vivo imaging is the lowest among the nanoparticle based fluorescent probes.

Comparison to Other Methods.

Table 1 compares different sidewall functionalization methods for creating fluorescent quantum defects in SWCNTs.

TABLE 1
Comparison of aqueous reactions generating SWCNT fluorescent quantum defects

| | | | D/G Raman | | | E₁₁/E₁₁ | Reaction |
|---|---|---|---|---|---|---|---|
| | Defect | Photoexcited | ratio | | Relative decrease | emission | time |
| Reference | type | species | (dopedpristine) | | in E₁₁ absorption | ratio | (min) |
| this work | O-doping | ClO⁻ | 0.037 | 0.01 | 17% | 5.3 | 0.67 |
| Ghosh et al. | O-doping | SWCNT (E₂₂) | 0.17 | 0.03 | 30% | 5.2 | 960 |
| Chiu et al. | O-doping | SWCNT (E₂₂) | 0.27 | 0.13 | 9% | 7.7 | 50 |
| Piao et al. | sp³ | — | 0.21 | 0.01 | 24% | 18.1 | 14,400 |
| Kwon et al. | sp³ | — | 0.15 | — | —* | 8.9 | 16 |
| Wu et al. | sp³ | SWCNT (E₂₂) | 0.04 | 0.016 | — | 1.4 | 30 |

*Accurate assessment prevented by background absorption. See, Ghosh, S., Bachilo, S. M., Simonette, R. A., Beckingham, K. M. & Weisman, R. B. Oxygen Doping Modifies Near-Infrared Band Gaps in Fluorescent Single-Walled Carbon Nanotubes. Science 330, 1656-1659, doi: 10.1126/science. 1196382 (2010); Chiu, C. F. et al. Enzyme-Catalyzed Oxidation Facilitates the Return of Fluorescence for Single-Walled Carbon Nanotubes. J. Am. Chem. Soc. 135, 13356-13364, doi: 10.1021/ja400699y (2013); Piao, Y. et al. Brightening of carbon nanotube photoluminescence through the incorporation of sp³ defects. Nature Chem. 5, 840-845 (2013); Kwon, H. et al. Molecularly Tunable Fluorescent Quantum Defects. J. Am. Chem. Soc. 138, 6878-6885, doi: 10.1021/jacs.6b03618 (2016); and Wu, X. J., Kim, M., Kwon, H. & Wang, Y. H. Photochemical Creation of Fluorescent Quantum Defects in Semiconducting Carbon Nanotube Hosts. Angew. Chem. Int. Ed. 57, 648-653, doi: 10.1002/anie.201709626 (2018), each of which is incorporated by reference in its entirety.

To date, two main types have been reported: O-doping with retained sp² hybridization, and organic functionalization giving local sp³ hybridization in the SWCNT. Both product types show similar spectral features and single photon emission capabilities, although the single-photon emission of O-doped SWCNTs seems more sensitive to the environment. See, Hartmann, N. F., et al. Photoluminescence imaging of solitary dopant sites in covalently doped single-wall carbon nanotubes. Nanoscale 7, 20521-20530 (2015), which is incorporated by reference in its entirety. Prior reports of light-assisted reactions to generate SWCNT fluorescent defects have all involved excitation of the nanotubes. By contrast, the method of photoexciting the reactant precursor described herein gives functionalization rates higher by factors of ˜20 to 20,000 than other methods. This photochemical reaction also seems to suppress the introduction of non-fluorescent defects, judging by the lower Raman D/G ratio and absorption perturbation in samples with similarly altered emission spectra.

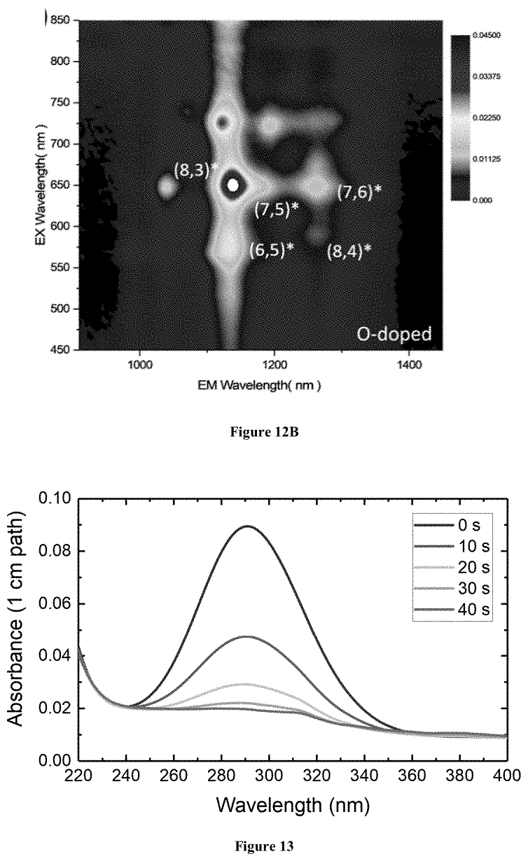

Researchers also have shown that in some cases photons can assist the defect creation, but all the reported methods are based on the generation of SWCNT excitons. The method of photoactivating the defect reagent, described herein, gives much faster reaction rate, which is 24-21,600 times faster than the reported values. Fast reaction also suppresses creation of non-fluorescent defects, showing lowest D/G ratio. It is believed this D/G ratio correlates more accurately to the concentration of fluorescent defect sites compared to the reported values. The amount of E₁₁ absorbance decrease also suggests reasonable doping density. Our E*₁₁/E₁₁ matches reported value. Higher E*₁₁/E₁₁ value means more fluorescent defect density, but the optimal density that leads to maximum E*₁₁ still needs to be answered. In general, the most efficient method of creating fluorescent quantum defects on SWCNTs based on O-doping is described herein. This method is ideal for the applications that needs this special excitation/emission wavelength or the single-photon emission property. Using different chirality of SWCNTs enables different wavelengths of photons emitted from the defect sites (FIGS. 12A-12B). The O-doped defects have drawbacks of not being able to fine tune the emission wavelength by changing the functional group, as well as no additional covalent attachment being possible on the defect site. However, previous research suggests the possibility to tune the defect emission if they are too close together. The covalent linkage could be overcome by attaching the functional group at the tube ends. See, Liu, J. et al. Fullerene pipes. Science 280, 1253-1256, doi:10.1126/science.280.5367.1253 (1998), which is incorporated by reference in its entirety.

An efficient oxygen doping method to create fluorescent quantum defects on SWCNTs using and oxygen atom source, such as bleach, has been developed. The oxygen doping reaction takes only about 40 seconds to reach maximum defect emission with the help of 300-nm illumination. The low D/G ratio of O-doped SWCNTs suggests the high-quality structure of the nanotubes remained after reaction. Calculations suggest the direct oxygen doping after photo-dissociation of ClO⁻ ions. The results also show the structure and the concentration of surfactant, as well as the structure of the oxidizing agent greatly affect the doping efficiency. Variance spectroscopy was used to estimate the doping extent and the microscope images to demonstrate the homogeneous side-wall doping. A protocol for controlled synthesis of O-doped SWCNTs at scale can be provided and in vivo imaging using our O-doped SWCNTs was shown.

A simple and efficient oxygen doping method has been developed to create fluorescent quantum defects in SWCNTs using photoexcited NaClO (e.g., bleach). This room temperature aqueous reaction takes less than one minute under 300 nm illumination to reach maximum shift of sample emission to the dopant band. Doping efficiency can depend strongly on the identity and concentration of the surfactant used to suspend the nanotubes. The mechanism is proposed to be direct attack on SWCNT side walls by excited 0 atoms formed through photodissociation of ClO⁻ ions. Variance spectroscopy shows that most nanotubes in treated samples emit at both the pristine and doped wavelengths, and that only a minority retain pristine emission spectra. Finally, a device has been developed allowing larger-scale controlled synthesis of O-doped SWCNTs and demonstrated the effectiveness of the product for high contrast in vivo imaging at SWIR wavelengths.

### Methods

Sample preparation. SWCNTs were prepared from CoMoCAT and HiPco batches in this study. To prepare a CoMoCAT SWCNT sample, the solid crystals (Aldrich, lot # MKBW7869) were added into 1% SC (Sigma C1254, Lot # SLBX2315) solution, followed by 1.5 hours of active tip-sonication (5 s on/55 s off; Cole-Parmer Ultrasonic Processor) under water bath controlled at 22 C. Right after that, the dispersed SWCNT sample was then ultracentrifuged for 3 hrs followed by immediate extraction of the supernatant. The (6,5)-enriched sample was performed using a gel separation method modified from Wei et al. See, Wei, X. J. et al. High-yield and high-throughput single-chirality enantiomer separation of single-wall carbon nanotubes. Carbon 132, 1-7, doi:10.1016/j.carbon.2018.02.039 (2018), which is incorporated by reference in its entirety. Two-step instead of multiple-step elution with various DOC concentration was performed to select racemic (6,5)-SWCNTs. The surfactants were replaced to 1% SC and the SWCNTs were reconcentrated to an OD of ˜4 to 15 cm⁻¹ using tangential flow filtration (mPES/100 kDa, C02-E100-05-N). The HiPco SWCNTs were purchased from NanoIntegris (Batch # HR27-075). The preparation procedure was the same as CoMoCAT preparation.

Doping Procedure.

The SWCNT samples were diluted with water and NaClO to obtain a solution that has 0.035-0.07% SC and ˜1 mM NaClO. For reaction mechanism studies and characterization, we added 300 uL of the prepared solution in a 4 mm wide 4 sides polished cuvette (Starna Cells 9-Q-10-GL14-S). The cuvette was illuminated at 300 nm with power density of ˜29 mW/cm² for desired amount of time, usually 40-50 sec. SC or DOC surfactants were added to give final concentration around 0.2%. An optional re-concentration step was performed if the SWCNT concentration is too low. For action spectrum measurements, 13 aliquots of (6,5)-enriched SWCNTs in SC and NaClO were prepared for the reaction. For each aliquot, SWCNTs were doped using different illumination wavelengths ranging between 250 and 370 nm with bandwidth of 10 nm. The illumination duration was fixed at 50 secs for all samples.

Optical Characterization.

The fluorescence spectra were obtained by NanoLog spectrofluorometer (Horiba). A Xenon short arc lamp was used as the excitation source with the wavelengths selected by double-grating monochromator. The emission was filtered by a 900-nm longpass filter (Thorlabs FELH0900) followed by a grating system and then detected by a liquid nitrogen cooled single-element InGaAs detector (Electro-Optical Systems). Sample illumination for oxygen doping is also from the same light source with the band width set to 25 nm if not mentioned. The absorption spectra were measured by spectrophotometers (Perkin Elmer Lambda 1050 UV/VIS/NIR or Beckman Coulter DU 800). Raman spectra of SWCNTs were measured under liquid solution with E₁₁ OD around 1. A 532 nm excitation laser was used. An 5× objective was used to focus the beam inside the liquid sample. Spectra were scanned 10 times from 3100 cm′ to 150 cm′ to obtain better resolution. Baselines were removed using the WiRE software (ver. 4.4).

Variance Spectroscopy.

The Variance spectra were measured on a step-scan apparatus described in previous publications. See, Streit, J. K., Bachilo, S. M., Sanchez, S. R., Lin, C.-W. & Weisman, R. B. Variance Spectroscopy. J. Phys. Chem. Lett., 3976-3981, doi:10.1021/acs.jpclett.5b01835 (2015); Sanchez, S. R., Bachilo, S. M., Kadria-Vili, Y., Lin, C.-W. & Weisman, R. B. (n,m)-Specific Absorption Cross Sections of Single-Walled Carbon Nanotubes Measured by Variance Spectroscopy. Nano Lett., doi:10.1021/acs.nanolett.6b02819 (2016); Zheng, Y., Sanchez, S. R., Bachilo, S. M. & Weisman, R. B. Indexing the Quality of Single-Wall Carbon Nanotube Dispersions Using Absorption Spectra. The Journal of Physical Chemistry C 122, 4681-4690, doi:10.1021/acs.jpcc.7b12441 (2018), Sanchez, S. R., Bachilo, S. M. & Weisman, R. B. Variance spectroscopy studies of single-wall carbon nanotube aggregation. J. Phys. Chem. C 122, 26251-26259 (2018); and Sanchez, S. R., Bachilo, S. M., Kadria-Vili, Y. & Weisman, R. B. Skewness Analysis in Variance Spectroscopy Measures Nanoparticle Individualization. J. Phys. Chem. Lett. 8, 2924-2929 (2017), each of which is incorporated by reference in its entirety. The samples were tip sonicated at 5 watts for 3 min before measurements. A 660 nm diode laser as an excitation source (Power Technologies, Inc.) was used. 2000 spectra were acquired at different spatial locations and then postprocessed the data using Matlab.

Single Particle Measurements.

SWCNT samples were diluted with 1% SDC solution to desired SWCNT concentration. ˜1 μL diluted sample was spread on the coverslip. A 40× objective (Zeiss LD C-Apochromat 40×/1.1) in conjunction with a tube lens (Thorlabs TTL200-S8) was used to transmit single particle images to an InGaAs camera (Princeton instrument). The pixel size was ˜500 nm measured by a resolution test target (Thorlabs R1DS1N). Images were recorded at two wavelength channels, which are 950-1000 nm and 1100-1300 nm, to compare the ratio of the defect or side band emission to the pristine E₁₁ emission.

Theoretical Calculation.

Semi-empirical methods, mostly PM3, were used in quantum chemical calculations. Hyperchem software was used as a graphic interface. Energy was determined for an optimized structures, if available. For a case of non-equilibrium structure such as “stretched” O—Cl, a single-point energy was calculated. No configuration interaction was used in the energy calculations. See FIG. 2D[ ].

Fluorescence Imaging.

The O-doped SWCNTs in 1% SC was displaced by DSPE-PEG5k using the method modified from the previously published protocols. See, Welsher, K. et al. A route to brightly fluorescent carbon nanotubes for near-infrared imaging in mice. Nat. Nanotechnol. 4, 773-780, doi:10.1038/nnano.2009.294 (2009), which is incorporated by reference in its entirety. In brief, the stock SWCNTs in 1% SC was mixed with equal volume of ˜2 mg/mL DSPE-PEG5k and dialyzed using a 2k MWCO dialysis membrane for 3 days. After that, the solution was centrifuged at 14,000 rpm for 30 min to remove aggregates (Microfuge® 22R Centrifuge). The DSPE-PEG₅ₖ-coated O-doped SWCNTs was then injected into a nude mouse intravenously. Immediately right after injection, the SWIR fluorescence images were acquired using a 980 nm diode laser (CNI Laser) for excitation and InGaAs camera (2D-OMA V: 320, Princeton Instruments) for collecting the emission. The excitation power is controlled at ca. 100 mW/cm². An 1150 nm longpass filter (FELH1150, Thorlabs) was used to select the wavelengths longer than 1150 nm and a camera lens (MVL25M1, Navitar) was used to focus the image. All in vivo experiments were performed in compliance with the Institutional Animal Care and Use Committee protocols. Animal experiment procedures were pre-approved (Protocol #1215-112-18) by the Division of Comparative Medicine (DCM) and the Committee on Animal Care (CAC), Massachusetts Institute of Technology, and in compliance with the Principles of Laboratory Animal Care of the National Institutes of Health (NIH), United States of America.

### Preparation of (6,5)-Enriched SWCNTs

CoMoCAT SWCNTs were purified using gel chromatography modified from previous publications. See, Wei, X. J. et al. High-yield and high-throughput single-chirality enantiomer separation of single-wall carbon nanotubes. Carbon 132, 1-7, doi:10.1016/j.carbon.2018.02.039 (2018); and Wei, X. J., Tanaka, T., Hirakawa, T., Wang, G. W. & Kataura, H. High-Efficiency Separation of (6,5) Carbon Nanotubes by Stepwise Elution Gel Chromatography. Physica Status Solidi B-Basic Solid State Physics 254, 4, doi:10.1002/pssb.201700279 (2017), each of which is incorporated by reference in its entirety. CoMoCAT SWCNTs were dispersed in 50 mL of 1% SC solution. 50 mL of 1% SDS was then mixed with SWCNT solution to give a stock solution that contains 0.5% SC and 0.5% SDS. DOC surfactant was further added to give a final surfactant concentration of 0.5% SC+0.5% SDS+0.035% DOC. This solution is then added onto a packed S-200 gel column. The eluted solution is collected and then diluted with a mixture solution of 0.5% SC and 0.5% SDS to give final surfactant concentration of 0.5% SC+0.5% SDS+0.023% DOC. The adsorbed SWCNTs on the gel are larger diameter species. This solution was added to a bigger gel column for (6,5) adsorption. The column was washed with 0.5% SC+0.5% SDS+0.023% DOC and then the SWCNTs was eluted by 0.5% SC+0.5% SDS+0.023% DOC solution. This SWCNT solution was then washed with 1% SC and then concentrated using tangential flow filtration.

### Oxygen Doping Protocol for Small Volume

1. Dilute the stock solution (SWCNTs dispersed in 1% SC) with DI water and add the NaClO stock (˜150 mM) to prepare the SWCNT solution for reaction at desired SC and NaClO concentration
2. Fully illuminate the sample with 300 nm light and monitor the E emission intensity simultaneously. Stop the illumination until E reached maximum. (Make sure the whole sample is illuminated to give the best result). The reaction is around 40-60 secs for the sample under ˜29 mW/cm² illumination.
3. Add extra DOC or SC (10%) to the reacted solution to reach 0.1% of added surfactant concentration.
4. (Optional) Place the reacted solution in dialysis tube and concentrate the solution using water absorbent (Spectra/Gel). 10× concentration is ideal because the concentration of surfactant reaches 1%.
5. (Optional) If higher concentration is needed, use tangential flow filtration to concentrate the SWCNTs and keep surfactant concentration around 1%.
   Note: Higher stock SWCNT concentration makes the doping procedure easier because of the following reasons: (1) The higher SWCNT concentration under the same SC concentration leads to more exposed SWCNT surface. The reaction undergoes faster when the coating is incomplete. (2) Higher SWCNT concentration means more SWCNT products. (3) The resulting SWCNT concentration can reach OD-3 without further concentration steps. (4) Similar amount of NaClO is required for reactions under low and high SWCNT concentrations.

### Protocol for Finding the Optimum Doping Condition

1. Dilute the SWCNT solution so that the concentration of SC is less then CMC, usually around 0.035-0.07%. Larger-diameter SWCNTs needs lower concentration of SC because SC coats better on larger diameter SWCNTs.
2. Add ˜1 mM NaClO into solution. Several conditions need to be tested in order to find the optimum NaClO concentration. For (6,5)-SWCNTs, FIG. 3C is a good reference. For unsorted CoMoCAT samples, the SWCNT fluorescence tends to be quenched when the NaClO concentration is around 0.7 mM or slightly lower. A concentration slightly higher than the maximum NaClO concentration that will not quench the SWCNTs is the best.
3. Find the condition for the highest defect emission intensity again by checking several SC concentrations around the value used in step 1 with NaClO concentration used in step 2.
4. Repeat step 2 to optimize the condition.

### Optical Properties of the SWCNT Stock Solutions

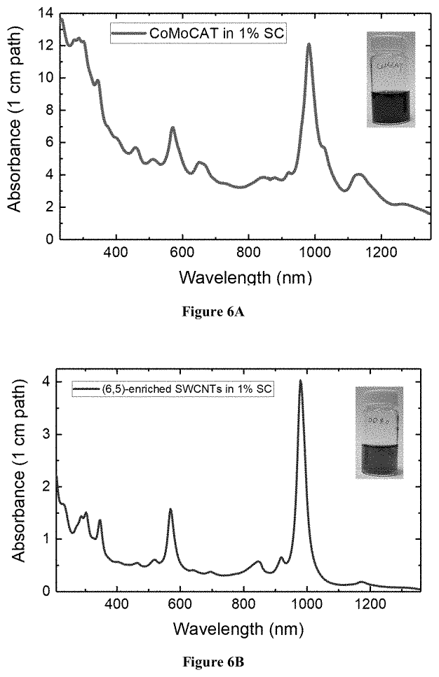

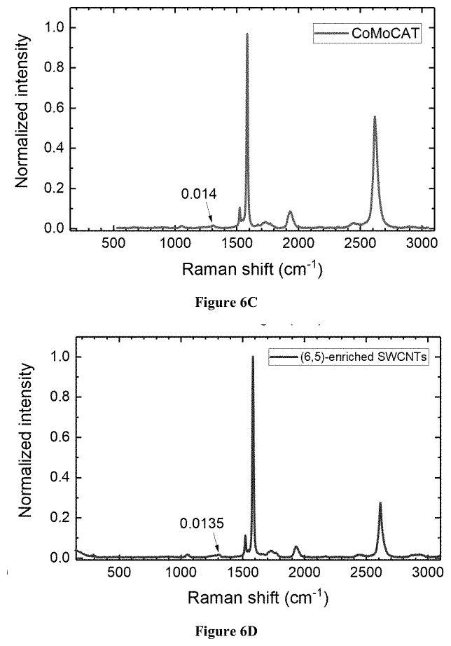

CoMoCAT and (6,5)-enriched SWCNTs were mostly used for this study. The absorption spectra in FIG. 6A and FIG. 6B were measured in diluted stock solution and multiplied by the dilution factor. The (6,5)-enriched SWCNTs contains trace amounts of (9,1) species but the purity should be more than 90% based on the literature. Gel purification removed most of the impurities in the CoMoCAT sample. The comparable D/G ratios suggest that the nonfluorescent defect densities of both samples are very similar. We also observed higher 2D peaks in CoMoCAT samples, possibly because of graphene impurities (FIGS. 6C and 6D).

### Emission Spectra at Energy Scale

The emission spectra in FIG. 1A are converted to wavenumber in x-scale and quanta in y-scale (FIGS. 7A-7B). The area ratio of O-doped to pristine SWCNTs shows the quantum yield ratio, which is 2.6 in this case. The actual increase of the quantum yield should be slightly higher than measured value because water absorbs light at longer wavelengths. The amount of increase is also strongly related to the initial condition of the pristine nanotubes, such as defect density and lengths. Lower density of non-fluorescent defects on pristine SWCNTs and longer SWCNT lengths could raise the quantum yield of the pristine nanotubes, and thus, decrease the quantum yield ratio, ϕ_{O-doped}/ϕₚᵣᵢₛₜᵢₙₑ. Supplementary FIG. 7B shows normalized and aligned spectra with the frequency zero set to the E₁₁ peak for pristine SWCNTs and to the E*₁₁ peak for O-doped SWCNTs. The low frequency side bands for E₁₁ and E*₁₁ can be seen to lie at similar positions (−1141 cm⁻¹ lower than the main peaks) with similar intensities. This sideband in pristine nanotubes has been assigned to X₁ band, which is the emission from the dark K-momentum exciton. The low frequency sideband in the treated sample might arise from the same source and therefore could be assigned to X₁*. Also, this peak appears different from the assigned parallel epoxide emission E*₁₁−E*₁₁, which should be near 7500 cm⁻¹ (at 1333 nm or 1411 cm⁻¹ lower than E*₁₁). However, a minor contribution from E*₁₁ ⁻ emission cannot be excluded (see also page 22), and the accurate assignments of the sidebands need further study.

### Absorption of E*₁₁ Band

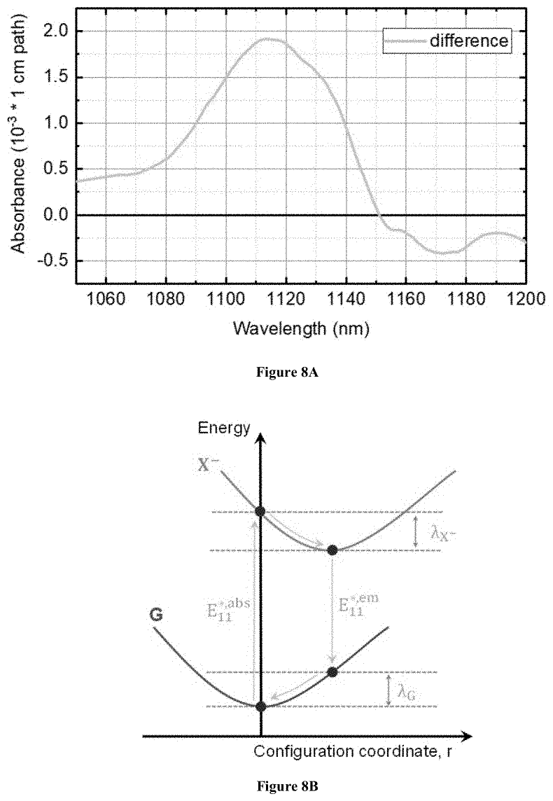

FIG. 8A plots the difference absorbance spectrum between O-doped and pristine samples. The peak shows the weak absorption arising from the O-doped sites. This feature has a peak wavelength of ˜1114 nm and a FWHM of ˜54 nm. The defect density is so low that this absorption peak is very hard to measure. The absorption coefficient might be extracted if the defect density can be quantified. A future determination of this absorption coefficient would allow accurate measurements of doping density.

It is of fundamental interest to understand the vibrational reorganization energy for E*₁₁ transitions. As shown in FIG. 8B, the relative energies can be written as follows assuming vertical (Franck-Condon) transitions:

E₁₁^{*,abs}=λ_{X}−+E₁₁^{*,em}+λ_{G}

or

E₁₁^{*,abs}−E₁₁^{*,em}=λ_{X}−+λ_{G}.

Therefore, the energy difference between absorption and emission equals the total reorganization energy, which is λₜₒₜₐₗ=λ_{X}−+λ_{G}. The λₜₒₜₐₗ obtained from this work is ˜11.9 meV, which is much smaller than the reported calculated λ_{G} of 70 meV. See, Kim, M., et al. Fluorescent carbon nanotube defects manifest substantial vibrational reorganization. J. Phys. Chem. C 120, 11268-11276 (2016), which is incorporated by reference in its entirety. Dense oxygen doping in our treated sample might result in a reduced reorganization energy, which is also observed in the sp^{a} doped samples.

### Up-Conversion of Pristine and O-Doped SWCNTs

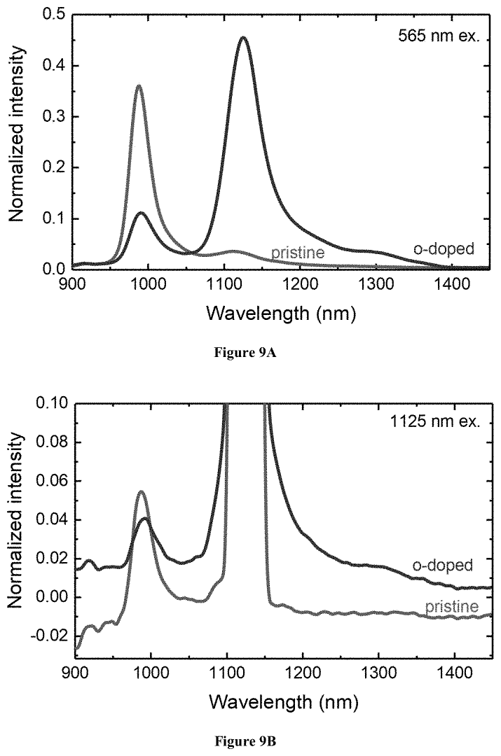

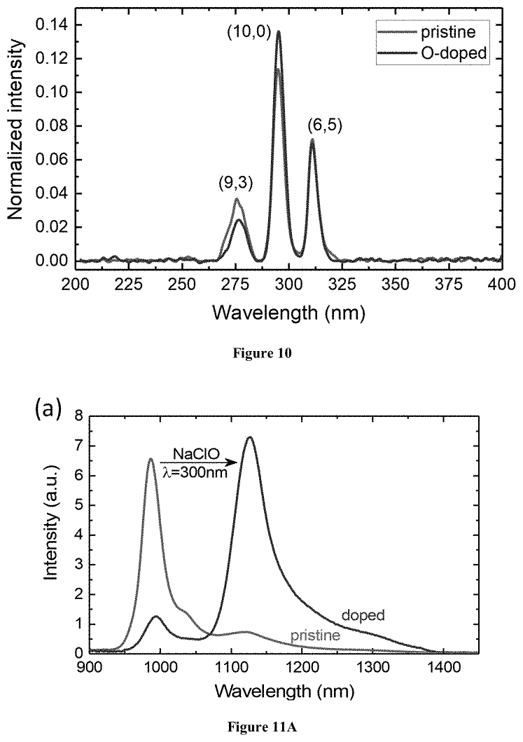

SWCNT up-conversion was first reported by Akizuki et al. in 2015. See, Akizuki, N., Aota, S., Mouri, S., Matsuda, K. & Miyauchi, Y. Efficient near-infrared up-conversion photoluminescence in carbon nanotubes. Nat. Commun. 6, 8920-8920, doi:10.1038/ncomms9920 (2015), which is incorporated by reference in its entirety. The E₁₁ emission intensity of pristine SWCNTs excited at 1125 nm is ca. 9.35% compared to excitation at 565 nm, which matches previous observations. The E₁₁ intensity from the up-conversion excitation for O-doped SWCNTs is ˜2.67 times lower than that for the pristine SWCNTs (0.0235/0.0627=2.67 from FIG. 9B). This ratio is not too far away from the E₁₁ intensity ratio of pristine to O-doped SWCNTs excited at 565 nm, which is around 3.29 (from FIG. 9A). The lowered E₁₁ ratio from the up-conversion transition might indicate a larger absorption cross-section at the O-doped site compared to the thermal assisted absorption of the pristine structure. However, our distance between O-doped sites should be much smaller than the exciton diffusion length, which is around 200 nm. The escaped excitons from the traps are likely to re-enter a trapping site, lowering up-conversion efficiency. Lighter O-doping might help to produce higher up-conversion through defect-assisted exciton generation.

### Radial Breathing Mode

The RBM peaks did not show significant difference between pristine and O-doped SWCNTs. These three peaks have been assigned in the literature. See, Magg, M., Kadria-Vili, Y., Oulevey, P., Weisman, R. B. & Buergi, T. Resonance Raman Optical Activity Spectra of Single-Walled Carbon Nanotube Enantiomers. J. Phys. Chem. Lett. 7, 221-225, doi:10.1021/acs.jpclett.5b02612 (2016); and Liu, H., Nishide, D., Tanaka, T. & Kataura, H. Large-scale single-chirality separation of single-wall carbon nanotubes by simple gel chromatography. Nat. Commun. 2 (2011), each of which is incorporated by reference in its entirety.

### Optical Properties of Pristine and O-Doped CoMoCAT SWCNTs

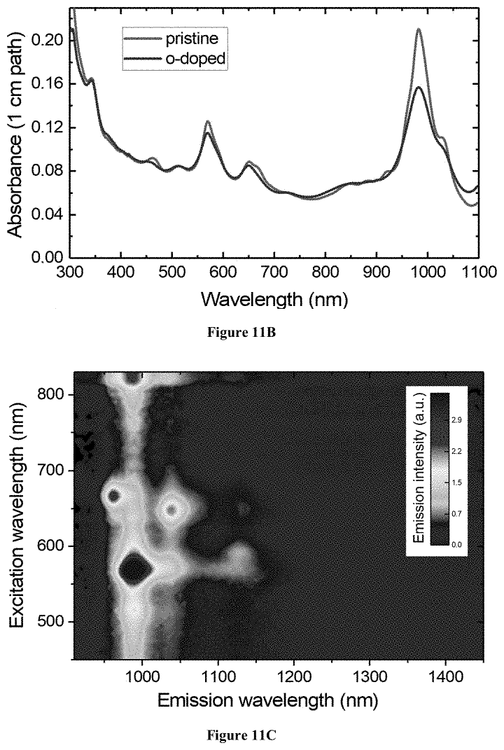

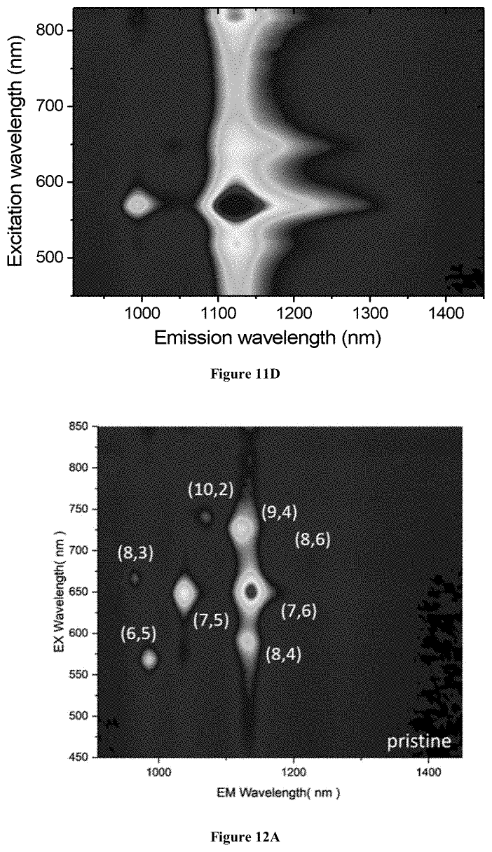

The results from CoMoCAT SWCNTs are very similar to that from the (6,5)-SWCNTs. The near armchair species seem to be less reactive than other species. In FIG. 11C, the E₁₁^{(8,3)} and E₁₁^{(7,5)} emissions are obvious but in FIG. 11D the E*₁₁^{(8,3)} and E*₁₁^{(7,5)} peaks are hidden in the E*₁₁^{(6,5)} emission.

Oxygen Doping to Species Other than (6,5)

The oxygen doping also works for several species other than (6,5). Here, we doped oxygens on partially sorted HiPco SWCNTs. FIG. 12A shows the excitation-emission profile of the pristine SWCNTs. (8,3), (6,5), (7,5), (10,2), (9,4), (7,6), and (8,4) were the dominant species. FIG. 12B shows the excitation-emission profile of the O-doped SWCNTs. The E₁₁^{(8,3)} emission disappeared, indicating successful oxygen doping. The E*₁₁^{(8,3)} emission of might be hidden by the dominant emission from E₁₁^{(7,6)} and E*₁₁^{(7,5)}. The E*₁₁^{(6,5)} is obvious at 1126 nm and slightly overlap with E₁₁^{(8,4)}. (10,2) seems harder to react with oxygen. The E*₁₁^{(8,4)} is observed at 1258 nm. And the E*₁₁^{(7,6)} is at 1266 nm. Strangely, the emission of E₁₁^{(9,4)} and E₁₁^{(8,6)} becomes stronger after NaClO treatment. The E*₁₁^{(9,4)} and E*₁₁^{(8,6)} emission were not found in the literature as well. Instead, the fluorescence recovery of the oxidized (9,4) and (8,6) was observed probably because the oxidizing agents removes the nonfluorescent defects. See, Chiu, C. F. et al. Enzyme-Catalyzed Oxidation Facilitates the Return of Fluorescence for Single-Walled Carbon Nanotubes. J. Am. Chem. Soc. 135, 13356-13364, doi:10.1021/ja400699y (2013), which is incorporated by reference in its entirety. However, the detailed can help clarify this special chirality-specific mechanism. The concentration of SC for reaction is chirality sensitive. Larger diameter SWCNTs requires lower SC concentration for the reaction to happen. The oxygen doping was reacted under 0.03% SC in this case.

### Photo-Dissociation of OCl⁻ Ions

The ClO⁻ ions undergo photo-dissociation when illuminated with ˜300 nm light. The absorbance of ClO⁻ decreases as the sample is illuminated at 300-nm. Here, most of the ClO⁻ ions had decomposed within 40 sec, which matches the optimal illumination time for reaction. The O-doping reactions were performed with several ClO⁻ concentrations in order to make sure the E*₁₁ emission reached maximum.

### Sample Stability

Here, the sample stability of the SWCNTs was examined under NaClO for 24 hours. FIG. 14A shows that the Raman D/G ratio increases only 10%, within the uncertainty of the measurement. This finding means that the NaClO did not destroy the pristine structure. But the possibility of shortening SWCNTs by NaClO cannot be excluded. Chiu et al. have shown that low concentration of ClO⁻ ions does not affect the D/G ratio, but the absorbance decreases. See, Chiu, C. F. et al. Enzyme-Catalyzed Oxidation Facilitates the Return of Fluorescence for Single-Walled Carbon Nanotubes. J. Am. Chem. Soc. 135, 13356-13364, doi:10.1021/ja400699y (2013), which is incorporated by reference in its entirety. High concentrations of ClO⁻ ions can oxidize the SWCNT completely. This suggests ClO⁻ can destroy the SWCNTs. Also, previous research has discovered that oxidized graphene sheets degrades easier than oxidized SWCNTs. FIGS. 14B and 14C both show decreased intensity after 24 hours. The lowered emission intensities might be originated from aggregated or shortened SWCNTs. FIG. 14B shows the emission slightly red-shifted from 988 nm to 992 nm, indicating possible environmental change around the SWCNT wall. The slightly broader emission also suggests possible aggregation happening during 24 h incubation. The lower absorption background in FIG. 14C might indicate that the carbon related structure including amorphous carbon and small graphene sheets might be decomposed by ClO⁻ ions slowly. Also, the attack of the ClO⁻ ions might happen at the non-fluorescent defect sites and therefore cause the decrease of pristine structure and shorted nanotube lengths. The overall density of non-fluorescent defects on nanotube walls structure might be reduced.

300 nm Illumination without NaClO

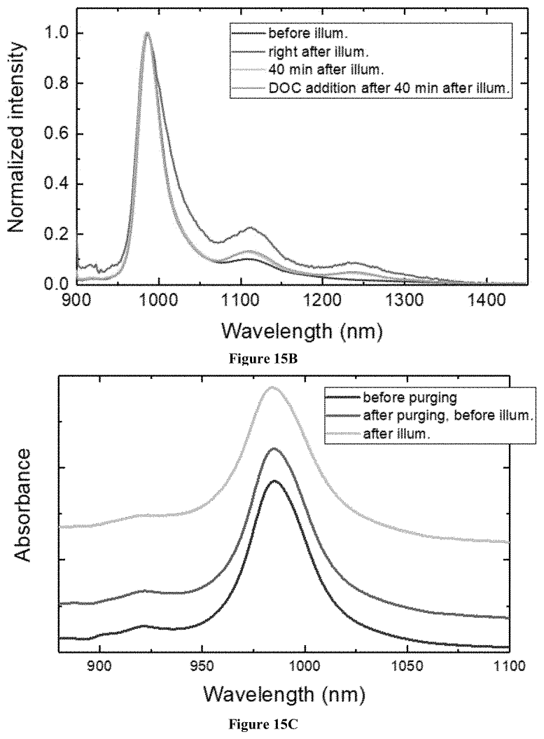

A sample of (6,5)-SWCNTs in 0.07% SC was illuminated by 200 nm light for 50 seconds while the solution was saturated with argon to prevent oxygen doping side effects. FIG. 15A shows that the EE11 fluorescence dropped by 83% after illumination and then recovered to 76% of initial value after 40 mins. This suggests that there is some largely reversible charge transfer reaction happening under 300-nm illumination. This charge transfer reaction creates some defects that induce small new sidebands that are not directly related to the fluorescent quantum defects. FIG. 15C shows slightly lower and broader absorption at E₁₁. But in FIG. 15D, the Raman spectrum shows little change in the low D/G ratio, suggesting no severe modification of the pristine structure. FIG. 15E also shows higher D/G ratio, suggesting the illumination destroys the pristine structure. The creation of non-fluorescent defects is not obvious in O-doping process using ClO− ions because the E11 emission is stronger in O-doped sample. This suggests two reactions are competing.

### NaClO Control.

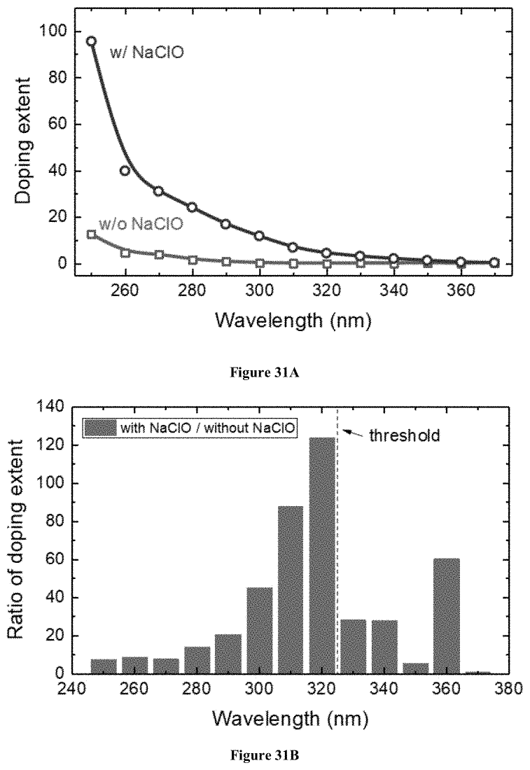

Here, the sample was illuminated in the absence of ClO− ions to check if dissolved oxygen molecules play any role in the doping mechanism. FIG. 31A shows that the doping reaction did proceed very mildly under these conditions with short wavelength irradiation. The ratios of doping extent shown in FIG. 31B reveal a clear threshold near 325 nm. This is consistent with a reaction channel involving ¹D oxygen doping, because ¹D oxygen atoms are generated only at wavelengths shorter than 320 nm.

Generation of 1D Oxygen Atoms.

Prior studies have shown that ¹D oxygen atoms are generated upon photodissociation of hypochlorite ions at wavelengths shorter than ˜320 nm. The rate of ¹D oxygen atom generation given a certain excitation wavelength can be estimated by the following equation:

$$O ( {}^{1} D ) photogeneration rate = \frac{\# of O ( {}^{1} D ) generated}{time} = \frac{QY \times photons absorbed}{time}$$

Here, we used the same excitation power for all wavelengths. The kinetic ratio at two different wavelengths is then

$$\frac{{rate}_{253.7 nm}}{{rate}_{313 nm}} = \frac{{QY}_{253.7 nm}}{{QY}_{313 nm}} \times \frac{{Abs}_{253.7 nm}}{{Abs}_{313 nm}}$$

The quantum yields of ¹D oxygen generation are reported to be 0.133 at 253.7 nm and 0.020 at 313 nm10. See, Buxton, G. V. & Subhani, M. S. Radiation-chemistry and photochemistry of oxychlorine ions. 2. Photodecomposition of aqueous-solutions of hypochlorite ions. J. Chem. Soc. Faraday Trans. 68, 958-969 (1972), which is incorporated by reference in its entirety. The ratio of photon absorption equals the ratio of NaClO absorbance. Therefore,

$$\frac{{rate}_{253.7 nm}}{{rate}_{313 nm}} = \frac{0.133}{0.02} \times \frac{0.36}{0.64} = \frac{0.0484}{0.0129}$$

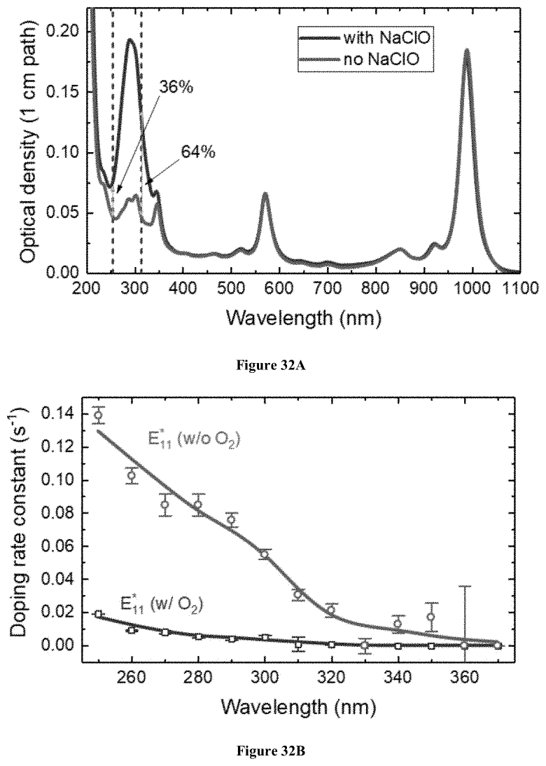

The results are summarized in Table 2. The O(¹D) photogeneration rates are plotted in FIG. 32B as a comparison to the doping rate constant. Taking zero as the reference point, the action spectrum of doping rate constant matches the ratio of O (1D) photogeneration rates at the two known wavelengths.

TABLE 2
The calculation of the 1D oxygen photogeneration
rates at two wavelengths

| wavelength | quantum yield | absorbance | QY × Abs |
|---|---|---|---|
| 313 nm | 0.020 ± 0.015 | 0.64286 ± 0.00171 | 0.0129 ± 0.0096 |
| 253.7 nm | 0.133 ± 0.017 | 0.36414 ± 0.00219 | 0.0484 ± 0.0060 |

Dissolved O₂ Control.

Here we purged the SWCNT solution with argon gas to remove dissolved oxygen molecules. Interestingly, the reaction rates increased significantly, proving that dissolved O₂ is not the reactant in the doping reaction. The singlet oxygen atoms (¹D) may be partially quenched by ground state oxygen molecules, slowing the doping reaction in the unpurged samples. FIG. 32B uses the sample without O₂ to obtain accurate reaction kinetics, although in ambient conditions the reactions are efficient enough to run without purging. In summary, oxygen molecules in our doping reaction seem to have two side effects: first, they quench the singlet oxygen atoms that are essential for oxygen doping. Second, they slowly create fluorescent defects upon short wavelengths UV radiation, but with 10-120 times lower efficiency. The resulting product might also be different (E*₁₁ is ˜1120 nm).

Energy Diagram.

The energies of several species were calculated using the PM3 semiempirical method and listed in Tables 3 and 4. The energy of a (6,5)-SWCNT segment nine hexagons in length was calculated to be ˜37392 kcal mol⁻¹. The ends were capped with H atoms in this simulation. A ±3 kcal mol⁻¹ variation appears as the length varies from 7 to 18 hexagons. The binding energy of the ClO⁻ ions relative to an O atom and Cl⁻ ion is around 84.5 kcal mole⁻¹, which corresponds to a photon wavelength of 337 nm. The calculated binding energy is consistent with our illumination wavelengths. The original reactants, SWNT_6-5_L09 plus O—Cl⁻, have a calculated energy of −37513.85 kcal mol⁻¹. The products, SWNT_6-5_L09_O_per plus Cl⁻, have a total energy of −37541.22 kcal mol⁻¹, which is approximately 28 kcal mol⁻¹ lower than the reactants. The epoxide adduct has energy similar to the reactants (−2.86 kcal mol⁻¹), thus that reaction channel is not energetically preferred. As expected, the Cl⁻ ion can be further stabilized in H₂O (1420 energy is −217.22 kcal mol⁻¹). The solvation energy for Cl⁻ in a 7H₂O system is −57 kcal mol⁻¹. In conclusion, it was found that the most stable structure is formed when an oxygen atom dissociates from the ClO⁻ and bonds to the SWCNT to form the perpendicular ether adduct. The probability for this reaction occurring thermally is low because of the reaction barrier to O—Cl⁻ dissociation. Photoexcitation of the ClO⁻ ion overcomes this barrier. Also, stabilization of Cl⁻ by H₂O may stabilize the intermediate and accelerate the reaction.

TABLE 3
Examples of calculated energies of species calculated with PM3.

| Structure | Energy (kcal) | Details | Comment |
|---|---|---|---|
| SWNT_6-5_L09 | −37392.31 | (6,5) SWCNT H-capped | Calculated energy difference |
| | | with length 9 hexagons | shown below was plus-minus |
| | | | 3 kcal for different SWCNT |
| | | | lengths from 7 to 18 hexagons |
| SWNT_6-5_L09_O_par | −37436.50 | “Parallel” epoxide with | |
| | | O atom in the middle of | |
| | | the SWCNT | |
| SWNT_6-5_L09_O_per | −37461.01 | “Perpendicular” ether, | About 25 kcal lower than |
| | | open ester structure, on | epoxide |
| | | the same SWCNT | |
| Cl— | −80.21 | Cl (−) ion in vacuum | |
| O | 43.16 | Atom O in vacuum | Cl— + O is −37 kcal |
| O—Cl— | −121.54 | O—Cl (−) ion in vacuum | 84.5 kcal binding energy |

TABLE 4
The energy of ClO— with different bond length in vacuum.

| | | | | | | | |
|---|---|---|---|---|---|---|---|
| Length | 1.702 | 1.8 | 1.9 | 2.0 | 2.1 | 2.2 | 2.3 |
| Energy, kcal | −121.54 | −118.73 | −111.14 | −100.80 | −89.75 | −79.48 | −70.69 |
| Length | 2.4 | 2.5 | 2.6 | 2.7 | 2.8 | 2.9 | 3.0 |
| Energy, kcal | −63.49 | −57.71 | −53.12 | −49.48 | −46.64 | −44.45 | −42.78 |
| Length | 3.1 | 3.2 | 3.3 | 3.4 | 3.5 | 3.6 | 3.7 |
| Energy, kcal | −41.54 | −40.63 | −39.98 | −39.52 | −39.19 | −38.96 | −38.78 |
| Length | 3.8 | 3.9 | 4.0 | 4.5 | 5.0 | 6.0 | 7.0 |
| Energy, kcal | −38.65 | −38.54 | −38.45 | −38.09 | −37.83 | −37.51 | −37.34 |

Comparison to Ozone Method.

The yields of ether-SWCNTs and epoxide-SWCNTs are related to their relative energies between reactants and products. Here, the stabilization energy was used, which is defined as the difference of total energies between products and reactants, to describe the thermodynamic preference. For example, the reactants of the oxygen doping in this work are SWCNT and ClO⁻ and the products of the reaction are either ether-SWCNT plus Cl⁻ or epoxide-SWCNT plus Cl⁻. The stabilization energies then should be

$$\{ \begin{matrix}{E}_{stab}^{ether} ( {ClO}^{-} ) = {E}_{SWCNT + {ClO}^{-}} - {E}_{ether - SWCNT + {Cl}^{-}} \\ {E}_{stab}^{epoxide} ( {ClO}^{-} ) = {E}_{SWCNT + {ClO}^{-}} - {E}_{epoxide - SWCNT + {Cl}^{-}}\end{matrix}$$

The E_{stab}^{ether} (ClO⁻) and E_{stab}^{epoxide} (ClO⁻) are 27.37 and 2.86 kcal mol⁻¹, respectively (shown in Table 5). The total energy of the epoxide product is estimated to be only ca. 3 kcal mol⁻¹ below that of the reactants (see table below). To further examine the product selectivity, the results were checked for the epoxide emission features in the spectra of Ghosh et al. See, Ghosh, S., Bachilo, S. M., Simonette, R. A., Beckingham, K. M. & Weisman, R. B. Oxygen doping modifies near-infrared band gaps in fluorescent single-walled carbon nanotubes. Science 330, 1656-1659 (2010), which is incorporated by reference in its entirety. The extra sidebands in the range of 1,010 to 1,060 nm appeared in the first 5 hours, which might be from the E₁₁− or E*₁₁+ emissions. But these less-stable forms seem to disappear after 16 hours. This can be attributed to irreversible photoisomerization into more stable ether form. Therefore, the bulk of the O-SWCNT product apparently ended up in the ether form after some period of irradiation. By comparison, significant emission sidebands other than were not observed using the hypochlorite method, and the samples were not irradiated for a long time to allow photoisomerization. Therefore, it was concluded that hypochlorite method has higher initial selectivity.

TABLE 5
Comparison of stabilization energies using ozone and hypochlorite

stabilization energy (kcal mol⁻¹)

| species | ether | epoxide |
|---|---|---|
| ozone | 55 | 31 |
| hypochlorite | 27.37 | 2.86 |

Photodissociation of Hypochlorite.

Buxton et al. reported the photolysis of ClO⁻ ions into oxygen atom (³P or ¹D) and chloride ion (Cl⁻) under UV illumination at wavelengths of 253.7 nm, 313 nm, and 365 nm. Illumination at 365 nm produces only ground state oxygen atoms (³P). A low yield of O-doping was observed with illumination at 360 nm, even though our simulation suggests that doping ground state oxygen atom onto SWCNT is also energy preferred. The more efficient reaction below 320 nm suggests that ¹D (excited) oxygen atoms play an important role in the doping process. Lim et al. also showed that the negative charge of ClO⁻ ion redistributed from O to Cl when excited. However, the dissociation might redistribute the negative charge back to the oxygen atom when the structure is optimized. The possibility of direct oxygen atom transfer from the excited ClO⁻ ion to SWCNT without full dissociation of ClO⁻ cannot be excluded, although this mechanism seems inconsistent with the observation that dissolved O₂ suppresses the reaction rate. See, Buxton, G. V. & Subhani, M. S. Radiation-chemistry and photochemistry of oxychlorine ions. 2. Photodecomposition of aqueous-solutions of hypochlorite ions. J. Chem. Soc. Faraday Trans. 68, 958-969 (1972); Rao, B., et al. Perchlorate production by photodecomposition of aqueous chlorine solutions. Environ. Sci. Technol. 46, 11635-11643 (2012); and Lim, M. H., Gnanakaran, S. & Hochstrasser, R. M. Charge shifting in the ultrafast photoreactions of ClO− in water. J. Chem. Phys. 106, 3485-3493 (1997), each of which is incorporated by reference in its entirety.

Participation of Exciton.

One possible doping mechanism to consider is the involvement of hot excitons that have energy higher than E₁₁. However, hot nanotube excitons relax to their E₁₁ state in ˜100 fs, which suggests a very low probability for a hot exciton to encounter an O-doping agent. See, Kafle, T. R., et al. Hot exciton relaxation and exciton trapping in single-walled carbon nanotube thin films. J. Phys. Chem. C 120, 24482-24490 (2016), which is incorporated by reference in its entirety. This would lead to a very inefficient reaction and long reaction times. If the reaction could be activated by ground state excitons, which have relaxation time up to ˜100 ps, irradiation at 988 and 845 nm would give similar results as irradiation at 300 nm. This is not observed. Therefore, the results in FIG. 2A suggest the photo-dissociation of hypochlorite ions is essential to the doping mechanism.

O(¹D) Quenching and Doping Yield.

An isolated singlet oxygen atom O(¹D) has a very long radiative lifetime of ˜114 s. See, Slanger, T. G. & Copeland, R. A. Energetic oxygen in the upper atmosphere and the laboratory. Chem. Rev. 103, 4731-4766 (2003), which is incorporated by reference in its entirety. However, in practice its lifetime is far shorter and depends on chemical reactions with its environment. It appears that measurements of the O(¹D) lifetime in aqueous solution have not been reported. Benedikt et al. used plasma-generation to prove that oxygen atoms are highly stable in aqueous solution, showing no reaction with water, and are only quenched by encounters with reactive species. See, Benedikt, J., et al. The fate of plasma-generated oxygen atoms in aqueous solutions: non-equilibrium atmospheric pressure plasmas as an efficient source of atomic O(aq). Phys. Chem. Chem. Phys. 20, 12037-12042 (2018) For example, the authors show an oxygen atom lifetime of 53 ns in 0.5 mM phenol aqueous solution. The 53 ns lifetime represents the mean diffusion time for oxygen atoms to meet a phenol molecule. The lifetime of oxygen in aqueous solution increased greatly to 32 μs when only dissolved O₂ was present as a quencher. This is consistent with a simulation result, which states that the O(³P) remains stable in aqueous solution throughout the simulated time scale of 10 ps. See, Verlackt, C. C. W., Neyts, E. C. & Bogaerts, A. Atomic scale behavior of oxygen-based radicals in water. J. Phys. D: Appl. Phys. 50, 11LT01 (2017), which is incorporated by reference in its entirety. The authors also show that O(¹D) forms oxywater (H₂O—O) within the first iteration and remains stable throughout the rest of the simulation. The conversion of oxywater into H₂O₂ was not observed in the simulation, probably due to the energy barrier. See, Codorniu-Hernandez, E., Hall, K. W., Ziemianowicz, D., Carpendale, S. & Kusalik, P. G. Aqueous production of oxygen atoms from hydroxyl radicals. Phys. Chem. Chem. Phys. 16, 26094-26102 (2014), which is incorporated by reference in its entirety. Therefore, it is reasonable to suppose that the O(¹D) atoms are stable in water until they reach a reactive species such as SWCNT or O₂. To further consider the reaction yield, an optimal NaClO concentration is ˜3 times higher than the concentration of nanotube carbon atoms. The average axial spacing between doping sites on an O-SWCNT product nanotube can be estimated to be ˜100 nm, which corresponds to 8,800 carbon atoms. This would imply a NaClO-to-doping site ratio of 26,000. In other words, 26,000 hypochlorite ions would be needed to create one ether dopant site. This low efficiency suggests that most of the O(¹D) atoms are quenched by other reactive species, probably O₂ or surfactants. Therefore only the small fraction of O(¹D) atoms that are formed near nanotube sidewalls can successfully react with SWCNTs.

### NaClO Concentration

The basic SC surfactant gives the solution pH ˜9.3, which is much higher than the 7.5 pKₐ of HClO/ClO⁻. Therefore, most of the hypochlorite molecules exist in the form of ClO⁻ instead of HClO. See, Feng, Y. G., Smith, D. W. & Bolton, J. R. Photolysis of aqueous free chlorine species (NOCI and OCI—) with 254 nm ultraviolet light. J. Environ. Eng. Sci. 6, 277-284 (2007), which is incorporated by reference in its entirety. The Raman D/G ratio reveals the defect density of the oxygen treated SWCNTs. NaClO at higher concentration creates more defects on the SWCNT walls. FIG. 3C suggests that most of these defects are not fluorescent. NaClO at lower concentration creates fewer defects and larger portion of the defects is fluorescent quantum defects. The optimal concentration is around 0.1 mM but can vary slightly for each sample. FIG. 3D shows the effect of NaClO concentration on the D/G ratio.

In FIG. 3E, the yields of the doping reactions using illumination wavelengths at (6,5)-SWCNT's E₂₂ and E₁₁ transitions was examined. No reactions were happening using those excitation wavelengths.

### Reaction Mechanism

The actual increase of the quantum yield should be slightly higher than measured value because water absorbs light at longer wavelengths.

### Variance Spectroscopy

Variance spectroscopy measures fluctuations of the SWCNT emission, from which many results can be obtained. The variance spectra give much sharper peaks compared to the mean spectra because the emission variance is related to the number of SWCNTs instead of the number of carbon atoms. See, FIGS. 16A-16D.,

One of these is the relative abundance spectrum, expressed as the ratio of mean spectrum divided by the variance spectrum

$$N ( λ ) = \frac{{〈 I ( λ ) 〉}^{2}}{{σ}^{2} ( λ )}$$

The mean emission intensity per particle spectrum (relative emission efficiencies) then can be written as

$$ɛ ( λ ) = \frac{〈 I ( λ ) 〉}{N ( λ )} = \frac{{σ}^{2} ( λ )}{〈 I ( λ ) 〉} = \frac{σ ( λ )}{\sqrt{N ( λ )}}$$

### Calculation of Pearson Correlation Coefficient

Assume that two emissive components, E₁₁ and E*₁₁, exist on (6,5)-SWCNTs. Some of the SWCNTs preserves the E₁₁ emission profile without being doped. Some of the SWCNTs are heavily doped so that no E₁₁ emission can be observed. The other situation is that both emissions are presents from one SWCNT. The Pearson correlation coefficient can be expressed as the following function (Streit, J. K., Bachilo, S. M., Sanchez, S. R., Lin, C.-W. & Weisman, R. B. Variance Spectroscopy. J. Phys. Chem. Lett., 3976-3981, doi:10.1021/acs.jpclett.5b01835 (2015), which is incorporated by reference in its entirety)

$${ρ}_{{λ}_{j}} ( {λ}_{k} ) = \sqrt{\frac{{n}_{k}^{0}}{{n}_{j}^{0}}} \frac{cov ( {λ}_{j} , {λ}_{k} )}{σ ( {λ}_{j} ) σ ( {λ}_{k} )}$$

where σ(λ) is the covariance at wavelength λ, cov_{λ}_{ⱼ}(λₖ) is the covariance of λₖ relative to λᵢ, and (nₖ⁰/nⱼ⁰)^{1/2} accounts for differing initial abundances of the two components.

$${ρ}_{{λ}_{j}} ( {λ}_{k} ) = \sqrt{\frac{{n}_{k}^{0}}{{n}_{j}^{0}}} \frac{cov ( {λ}_{j} , {λ}_{k} ) σ ( {λ}_{j} )}{{σ}^{2} ( {λ}_{j} ) σ ( {λ}_{k} )}$$

$${ρ}_{{λ}_{j}} ( {λ}_{k} ) = \frac{cov ( {λ}_{j} , {λ}_{k} ) σ ( {λ}_{j} ) \text{/} \sqrt{{n}_{j}^{0}}}{{σ}^{2} ( {λ}_{j} ) σ ( {λ}_{k} ) \text{/} \sqrt{{n}_{k}^{0}}} = \frac{cov ( {λ}_{j} , {λ}_{k} ) ɛ ( {λ}_{j} )}{{σ}^{2} ( {λ}_{j} ) ɛ ( {λ}_{k} )} = \frac{cov ( {λ}_{j} , {λ}_{k} ) \text{/} {σ}^{2} ( {λ}_{j} )}{ɛ ( {λ}_{k} ) \text{/} ɛ ( {λ}_{j} )}$$

Therefore, the Pearson correlation coefficient or Pearson's r can be written as

$${ρ}_{{λ}_{j}} ( {λ}_{k} ) = \frac{covariance of {λ}_{j} and {λ}_{k} normalized to variance of {λ}_{j}}{{λ}_{k} to {λ}_{j} emission efficiency ratio} = \frac{{COV}_{{λ}_{j}} ( {λ}_{k} )}{{E}_{{λ}_{j}} ( {λ}_{k} )}$$

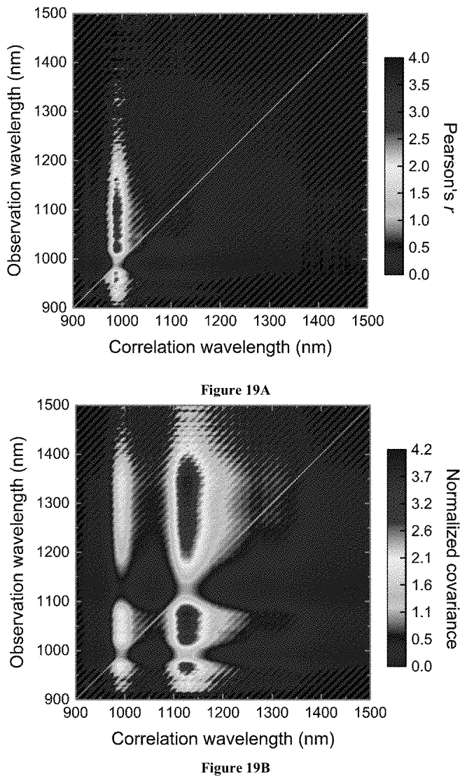

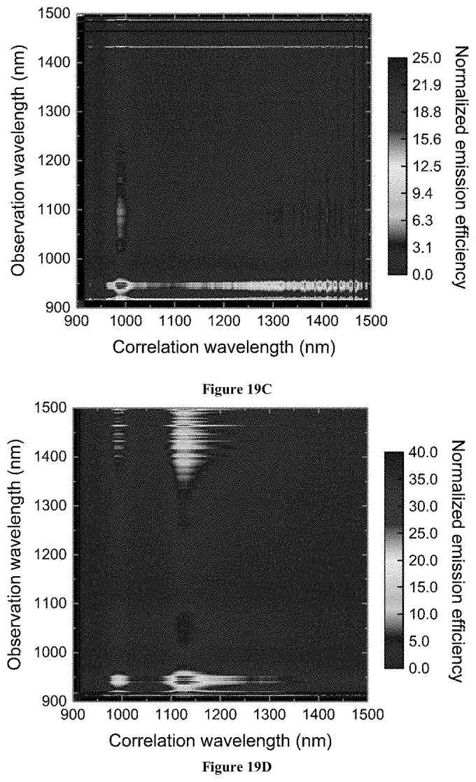

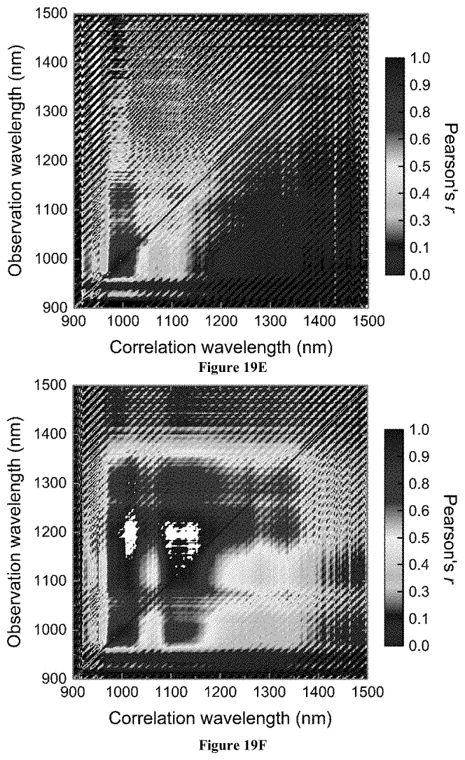

The Pearson correlation coefficient spectrum at E₁₁ and E*₁₁ (ρ_{994 nm}(λ) and ρ_{1126 nm}(λ)) are plotted in FIG. 4D and FIGS. 19A-19C. More complete expressions of the Pearson correlation coefficients relative to each wavelength are shown in FIGS. 19E-19F. In FIG. 19E, for the pristine SWCNT sample, only one major band is shown around 994 nm. A minor band shown in 1100 nm represents the E₁₁ sideband emission. For comparison, the plot in FIG. 19F refers to the O-doped SWCNT sample. Two major bands at 994 nm and 1126 nm reveals the strong correlation between E₁₁ and E*₁₁ emissions. A minor band at ˜1320 nm might be assigned as sideband of E*₁₁ transition, which is also discussed in the previous section. To estimate the correlation between E₁₁ and E₁₁ emissions, the peak positions at 994 nm for E₁₁ and 1260 nm for E*₁₁ were used. Therefore, the Pearson correlation coefficients are:

$$\{ \begin{matrix}{ρ}_{994 nm} ( 1126 nm ) = 0.7251 \\ {ρ}_{1126 nm} ( 994 nm ) = 0.9066\end{matrix}$$

They can be explained as: about 91% of E*₁₁ emissive SWCNTs contains E₁₁ emission and about 73% of E₁₁ emissive SWCNTs contains E*₁₁ emission. Assume that there are three types of SWCNTs after doping: E₁₁ only, E*₁₁ only and E₁₁+E*₁₁. One wants to know the fraction of each type of SWCNTs, which are F_{E}_{₁₁}_{^{only}}, F_{E*}_{₁₁}_{^{only}} and F_{E}_{₁₁}_{+E*}_{₁₁}, respectively. The number of them are N_{E}_{₁₁}_{^{only}}, N_{E*}_{₁₁}_{^{only}} and N_{E}_{₁₁}_{+E*}_{₁₁}. The number of SWCNTs that have E₁₁ emission is N_{E}_{₁₁}, and the number of SWCNTs that have emission is N_{E*}_{₁₁}. And they have the following relationship:

$$\{ \begin{matrix}{N}_{{E}_{11}} = {N}_{{E}_{11} + {E}_{11}^{*}} + {N}_{{E}_{11}^{only}} \\ {N}_{{E}_{11}^{*}} = {N}_{{E}_{11} + {E}_{11}^{*}} + {N}_{{E}_{11}^{* , only}}\end{matrix}$$

The definition of the Pearson correlation coefficient in this case is

$$\{ \begin{matrix}{ρ}_{{E}_{11}^{*}} ( {E}_{11} ) = \frac{{N}_{{E}_{11}^{*}}}{{N}_{{E}_{11} + {E}_{11}^{*}}} \\ {ρ}_{{E}_{11}} ( {E}_{11}^{*} ) = \frac{{N}_{{E}_{11}}}{{N}_{{E}_{11} + {E}_{11}^{*}}}\end{matrix}$$

Therefore, the number of SWCNTs that contain both E₁₁ and E*₁₁ emissions can be calculated

N_{E}_{₁₁}_{+E*}_{₁₁}=ρ_{E*}_{₁₁}(E₁₁)N_{E*}_{₁₁}=ρE₁₁(E*₁₁)N_{E}_{₁₁}

Because there are only three types of SWCNTs, the total number of SWCNTs is

Nₜₒₜₐₗ=N_{E}_{₁₁}_{^{only}}+N_{E*}_{₁₁}_{^{only}}+N_{E}_{₁₁}_{+E*}_{₁₁}

This can be reformulated into fraction

$${F}_{{E}_{11}^{only}} + {F}_{{E}_{11}^{* , only}} + {F}_{{E}_{11} + {E}_{11}^{*}} = \frac{{N}_{{E}_{11}^{only}}}{{N}_{total}} + \frac{{N}_{{E}_{11}^{* , only}}}{{N}_{total}} + \frac{{N}_{{E}_{11} + {E}_{11}^{*}}}{{N}_{total}} = 1$$

The fraction of each type of SWCNTs can be calculated

$$\{ \begin{matrix}{F}_{{E}_{11}^{only}} = \frac{{N}_{{E}_{11}^{only}}}{{N}_{total}} = \frac{1}{1 + \frac{1}{\frac{{N}_{{E}_{11}}}{{N}_{{E}_{11}^{*}}} [ 1 - {ρ}_{{E}_{11}} ( {E}_{11}^{*} ) ]}} \\ {F}_{{E}_{11}^{* , only}} = \frac{{N}_{{E}_{11}^{* , only}}}{{N}_{total}} = \frac{1}{1 + \frac{{N}_{{E}_{11}} \text{/} {N}_{{E}_{11}^{*}}}{1 - {ρ}_{{E}_{11}^{*}} ( {E}_{11} )}} \\ {F}_{{E}_{11} + {E}_{11}^{*}} = \frac{{N}_{{E}_{11} + {E}_{11}^{*}}}{{N}_{total}} = \frac{{ρ}_{{E}_{11}^{*}} ( {E}_{11} )}{[ 1 - {ρ}_{{E}_{11}^{*}} ( {E}_{11} ) ] + \frac{{N}_{{E}_{11}}}{{N}_{{E}_{11}^{*}}}}\end{matrix}$$

The Pearson correlation coefficients of E₁₁ and E*₁₁ (ρ_{E}_{₁₁}(E*₁₁) and ρ_{E*}_{₁₁}(E₁₁)) can be estimated from their peak emissions (ρ_{994 nm}(1126 nm) and ρ_{1126 nm}(994 nm), which are 0.7251 and 0.9066 respectively. The ratio N_{E}_{₁₁}/N_{E*}_{₁₁} which can be obtained from relative abundance spectrum, is 14718/11591=1.2698. Therefore, the fractions are

$$\{ \begin{matrix}{F}_{{E}_{11}^{only}} = \frac{{N}_{{E}_{11}^{only}}}{{N}_{total}} = \frac{1}{1 + \frac{1}{1.2698 \times [ 1 - 0.7251 ]}} = 0.2587 \\ {F}_{{E}_{11}^{* , only}} = \frac{{N}_{{E}_{11}^{* , only}}}{{N}_{total}} = \frac{1}{1 + \frac{1.2698}{[ 1 - 0.9066 ]}} 0.0685 \\ {F}_{{E}_{11} + {E}_{11}^{*}} = \frac{{N}_{{E}_{11} + {E}_{11}^{*}}}{{N}_{total}} = \frac{0.9066}{1 - 0.9066 + 1.2698} = 0.6651\end{matrix}$$

For this specific sample, 26% of the SWCNTs are not doped with oxygen, and 7% of the SWCNTs are heavily doped so that no E₁₁ emission can be detected. The rest of them have both E₁₁ and E*₁₁ emissions. Relative abundance and emission efficiencies used in the calculation can be obtained from FIGS. 16A-16C and Table 6.

### E*₁₁ Assignment of Right and Left Handed (6,5)-SWCNTs

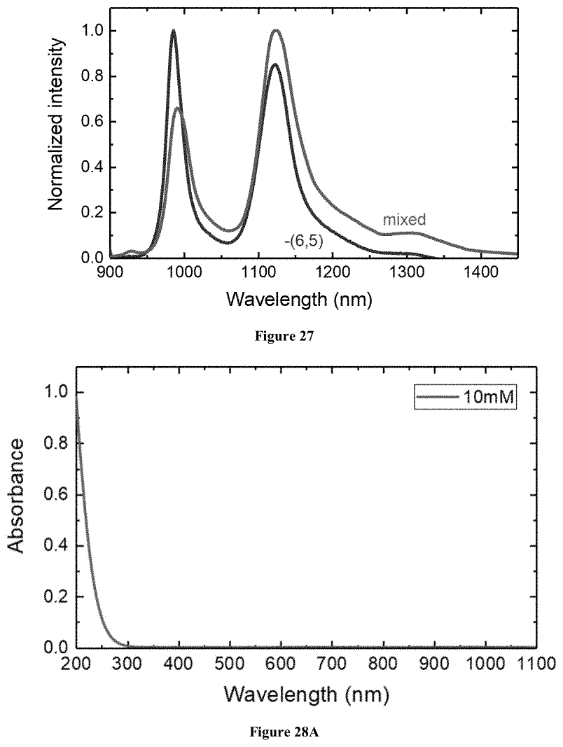

The existence of different emission wavelengths of E*₁₁ emissions for −(6,5) and +(6,5) is a clear evidence to show that the E*₁₁ emission is affected by the environment. It has been reported that the E₁₁ emission of −(6,5) is red shifted relative to +(6,5) in a chiral cholate coating. See, Ghosh, S., Bachilo, S. M., Simonette, R. A., Beckingham, K. M. & Weisman, R. B. Oxygen doping modifies near-infrared band gaps in fluorescent single-walled carbon nanotubes. Science 330, 1656-1659 (2010), which is incorporated by reference in its entirety. Here, a pure −(6,5) sample was prepared based on the published sorting method (Wei, X. J., et al. High-yield and high-throughput single-chirality enantiomer separation of single-wall carbon nanotubes. Carbon 132, 1-7 (2018), which is incorporated by reference in its entirety) and doped the oxygen to clarify the wavelength shift. As shown in FIG. 27, E*₁₁ emission from −(6,5) is also red shifted, which is the same as E₁₁ emission.

TABLE 6
The parameters for the relative abundance calculation.

| | |
|---|---|
| Relative abundance | Emission efficiency |

| | 995 nm | 1125 nm | 995 nm | 1125 nm |
|---|---|---|---|---|
| Pristine sample | 15758 | 5151 | 3.35 | 1.03 |
| Doped sample | 14723 | 11655 | 2.66 | 5.25 |

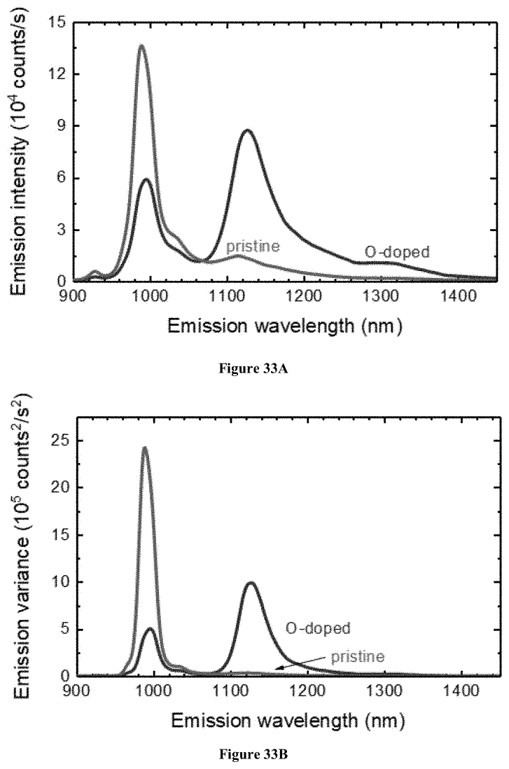

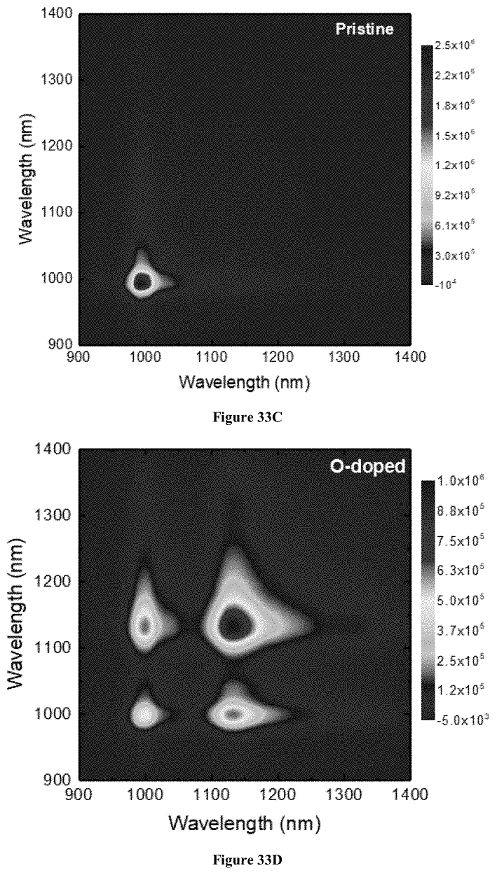

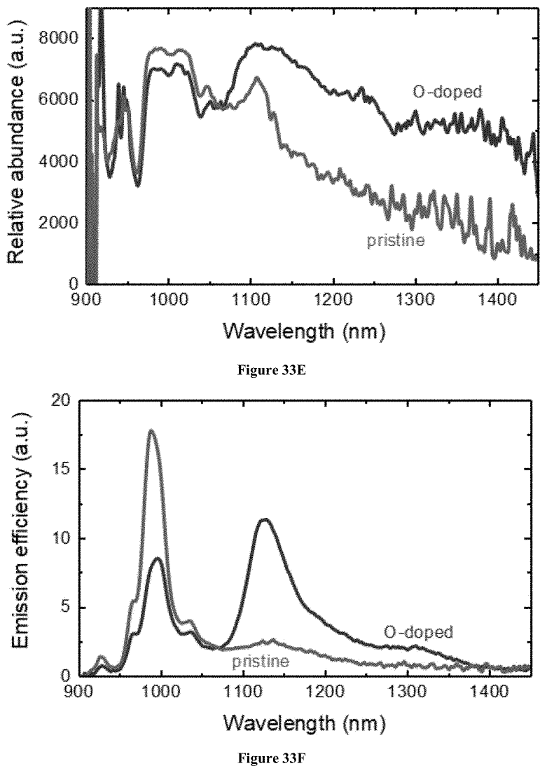

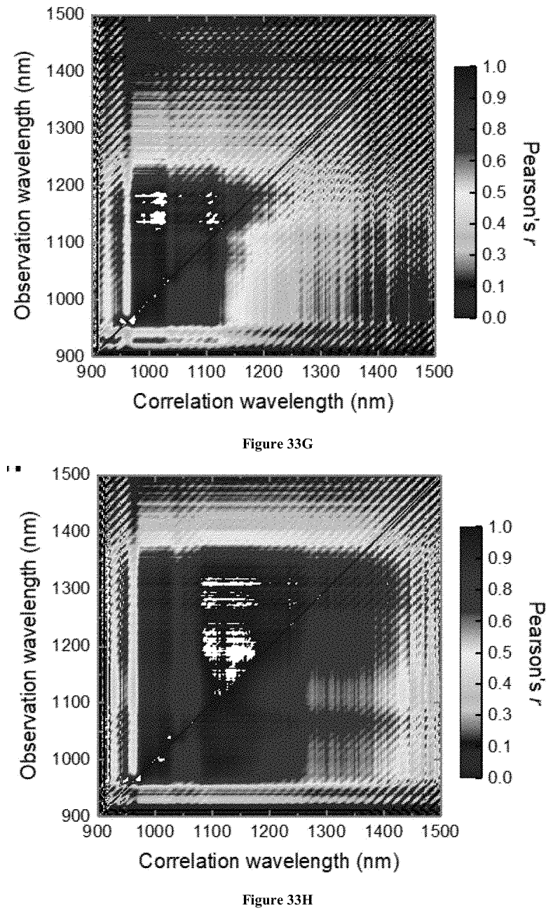

Another doped sample for Variance spectroscopy is shown in FIGS. 33A-33F.

### Doping Extent Vs Doping Heterogeneity

The doping extent does not evaluate the doping heterogeneity of the sample. Here, two samples with very similar doping extents were shown and estimates the doping heterogeneity using relative abundance and Pearson correlation coefficients were compared. As shown in FIG. 20A, the mean spectra of the two samples are nearly identical. However, the variance E*₁₁ peak in FIG. 20B is much higher for sample1 than for sample 2. The percentage of SWCNTs that remain undoped is lower for sample 2, indicating more homogeneous distribution of the O-doping sites (FIG. 20C). For applications in fluorescence imaging, a minimum value of E₁₁^{only} is desired to obtain the maximum E*₁₁. emission per SWCNT dode. However, for applications in single photon emission, one might want minimum E*₁₁ ^{only} emission because only one doping site is required for each SWCNT. Variance spectroscopy helps to characterize sample suitability for such applications.

### Calibration of Pixel Size

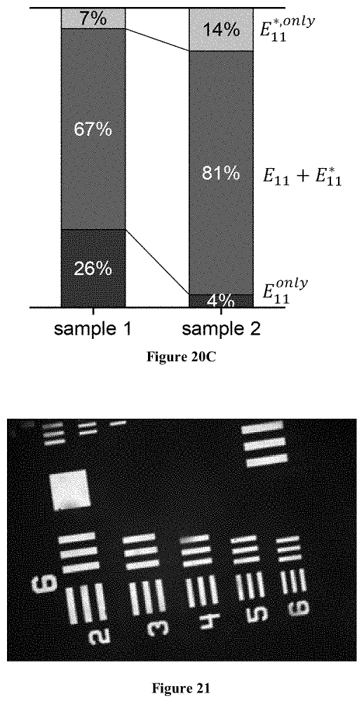

The pixel size was calibrated using a 1951 USAF Target. See, FIG. 21. The size of the line pair is 114 black-white pairs per mm. The measured line pair is 17.691 pixels, which corresponds to 496 nm per pixel.

### Single Particle Measurement

Both pristine and O-doped (6,5)-SWCNTs were dispersed on cover slips and images were taken using two sets of filters. Here, channel 1 represents the optical window ranging from 950 to 1000 nm (Thorlabs FELH950+FESH1000) and channel 2 represents the optical window ranging from 1100 to 1300 nm (Edmunds OD4 1100LP+OD4 1300SP). The SWCNTs were excited at 850 nm from MaiTai laser system. The laser was transmitted to the microscope system using high power optical fiber, indicating depolarized laser light was produced. An 40×NIR objective (Zeiss LD C-Apochromat) was used to focus the excitation and collect the emission. The emission was refocused into the InGaAs camera using a tube lens (Thorlabs TTL200-S8). The camera was operated at high gain and 5 MHz ADC conversion rate. Its frame time was set to 50 ms and a 1000-frame video was recorded to obtain an averaged image. Because the pixel size was ˜500 nm (see FIG. 21) and most of the SWCNTs have lengths shorter than the pixel size, the maximum intensity from each single pixel was used to obtain the SWCNT intensity (FIG. 22A). FIG. 22B shows the intensity ratio vs intensity sum of all the detected SWCNTs. The intensity sum is the summation of the intensities from channel 1 and channel 2, and the intensity ratio is the ratio of the channel 2 to channel 1 intensity. Some SWCNTs show bright emission in one channel but invisible in the other. The noise level was used to overestimate the intensities of the invisible tubes, therefore getting points in light colors (light blue and light red). These points have underestimated or overestimated intensity ratio, depending on which channel is invisible. As discussed above, the intensity ratios difference between O-doped and pristine SWCNTs are larger for SWCNTs having larger intensity sum. This suggests that the longer SWCNTs have better doping efficiency. This can be an indication of homogeneous doping on the SWCNT walls. FIG. 22C shows the probability distribution of intensity ratio of O-doped and pristine SWCNTs. As expected, the pristine SWCNTs with and without the presence of NaClO are very similar, indicating no doping happening without light. The O-doped SWCNTs have significantly higher intensity ratio, but part of the lower intensity ratio overlaps with the higher ratio part of pristine SWCNTs. Those overlapped intensity ratio are shorter SWCNTs, as shown in FIG. 22B.

Other Water-Soluble Oxidizing Agents.

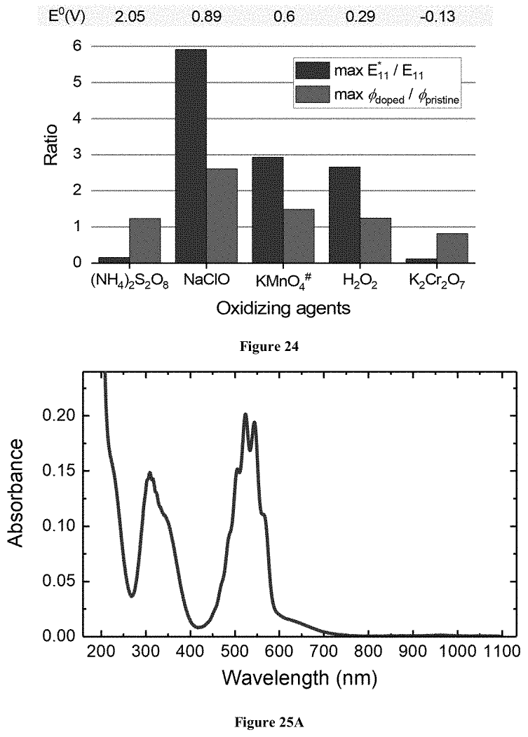

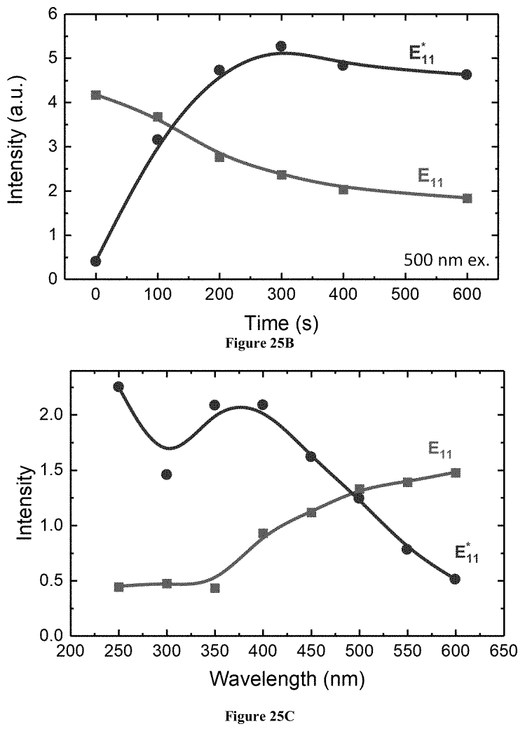

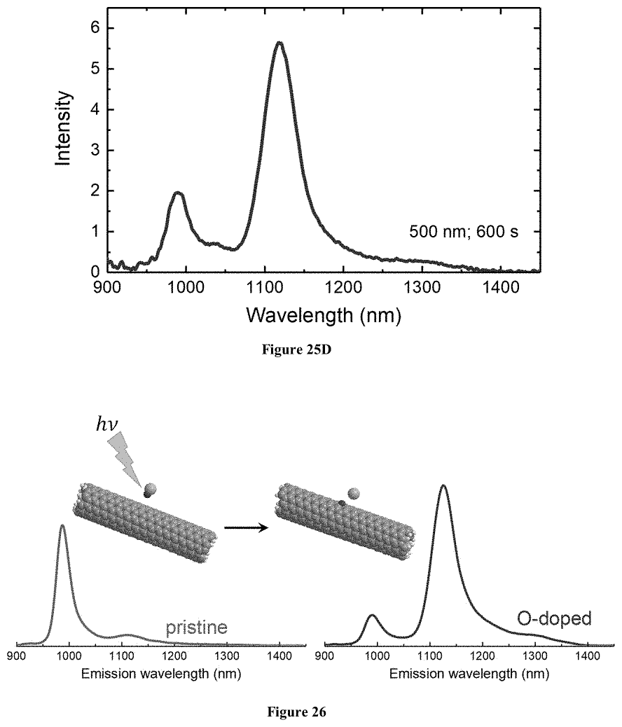

Because the O-doping is an oxidative process, we investigated whether other water soluble oxidizing agents could give similar results. Ghosh et al. demonstrated that reaction with ozone could dope oxygen atoms into SWCNTs, but controlling for accurate and reproducible ozone concentration in liquid is challenging. See, Ghosh, S., Bachilo, S. M., Simonette, R. A., Beckingham, K. M. & Weisman, R. B. Oxygen doping modifies near-infrared band gaps in fluorescent single-walled carbon nanotubes. Science 330, 1656-1659 (2010), which is incorporated by reference in its entirety. Chiu et al. utilized the auto-oxidation of linoleic acid to produce peroxide in solution. See, Chiu, C. F., Saidi, W. A., Kagan, V. E. & Star, A. Defect-induced near-infrared photoluminescence of single-walled carbon nanotubes treated with polyunsaturated fatty acids. J. Am. Chem. Soc. 139, 4859-4865 (2017), which is incorporated by reference in its entirety. The authors showed efficient oxygen doping, but the amount of peroxide produced from auto-oxidation is also difficult to control. Therefore, the use of simple water soluble oxidizing agents, instead of gases or low solubility compounds, might give promising results. FIG. 24 shows O-doping using several strong oxidizing agents listed in the order of their standard reduction potential at pH 9.3. The reactions are examined with several different illumination wavelengths (on and off the absorption peaks of the oxidizing agents) and we only show the data with the highest doping results. The order of doping extent matches the order of reduction potentials of the oxidizing agents except in the case of S₂O₈²⁻ ions. It is possible that the doping reaction needs direct donation of oxygen atoms from the oxidizing agents. K₂Cr₂O₇ is a very strong oxidizing agent in acidic solution (E⁰=1.33) but decomposes into CrO⁴⁻ in basic solution. Therefore, no oxygen doping was observed using K₂Cr₂O₇. Similarly, H₂O₂ is a very strong oxidizing agent in acidic solution but shows lower reduction potential in basic solution. The reaction rate is slower, and the yield is lower compared to ClO⁻. Tuning the acidity of the solution for higher reduction potential is not practical here because it also greatly affects the surfactants coatings and leads to faster nanotube aggregation. Another factor that decreases the doping efficiency of H₂O₂ is low absorption. KMnO₄ shows acceptable doping density and reaction rate with 250 nm and 350 nm irradiation. It is worth mentioning that KMnO₄ quenches SWCNT fluorescence (before and after illumination). Adding extra SDC surfactant is necessary for fluorescence recovery. Using KMnO₄, the doping can proceed on a slower time scale (˜10 min) with longer irradiations wavelengths up to 500 nm (FIG. 24 and FIGS. 25A-25D). More detailed studies of the reaction mechanism can elucidate the mechanism. The formation of MnO₂ nanoparticles (brownish observed color) during the reaction process makes the solution dirtier and harder to clean. It was found that oxygen doping using NaClO gives the highest E*₁₁/E₁₁ ratio and the largest ϕ_{O-doped}/ϕₚᵣᵢₛₜᵢₙₑ, demonstrating the best doping quality. Efficient doping may require “direct” donation of singlet oxygen atom very close to the SWCNT surface. In this view, the simple structure of hypochlorite ions is an advantage. The high reduction potential of ClO⁻ at high pH is ideal.

### SWCNT Oxidation in Dark

Pristine SWCNTs are stable structures that require harsh condition to destroy. Researchers have been using strong oxidizing agents with high temperature to modify the SWCNT side wall. Here, the oxidation effects of several strong water-soluble oxidizing agents on the SWCNT structure were examined. Approximately 1 mM of oxidizing agent was added to (6,5)-enriched SWCNT suspensions in 0.07% SC in the dark for 24 hours. FIG. 23 shows the Raman spectra of SWCNT sample after 24 hours of incubation. The D/G ratio remained the same, indicating no modification of SWCNT side wall when isolated from light. Fluorescence spectra confirmed this result.

Oxygen Doping Using KMnO₄.

The permanganate ion is known to give an oxygen atom upon photo-excitation. See, Rao, A. S. Photodecomposition and absorption spectrum of potassium permanganate. Proc. Indian Acad. Sci. A 6, 293-300 (1937); and Houmoller, J., et al. On the photoabsorption by permanganate ions in vacuo and the role of a single water molecule. New experimental benchmarks for electronic structure theory. ChemPhysChem 14, 1133-1137 (2013), each of which is incorporated by reference in its entirety. One of the resulting products is the MnO₂ nanoparticles. The sample color change from purple to yellow after irradiation was observed. The MnO₄⁻ ions quench SWCNT fluorescence in SC suspensions. Therefore, similar to the reaction in SDS surfactants, it was not possible to monitor the reaction during the doping steps and had to add SDC to restore the fluorescence. It was found that the reaction rate was similar for near-UV irradiation but became slower for longer wavelengths. Here, good O-doping of SWCNTs using KMnO₄ was demonstrated. The advantage of using KMnO₄ is that the reaction can proceed with irradiation by visible wavelengths, even though the reaction rate is slower. The disadvantage is the generation of MnO₂ nanoparticles. This might require more complex post-processing to remove those unwanted side products.

### Other Water Soluble Oxidizing Agents.

Because the O-doping is an oxidation process, other water-soluble oxidizing agents were explored. Ghosh et al. has demonstrated that ozone gases could dope oxygen atoms onto the SWCNTs, but controlling accurate and reproducible ozone concentration in liquid is challenging. Chiu et al. utilized the auto-oxidation of linoleic acid to produce peroxide in solution. The authors showed efficient oxygen doping but the amount of peroxide produced from auto-oxidation is difficult to control. Therefore, the use of simple water-soluble oxidizing agents, instead of gas or low solubility molecules, might give promising results. FIG. 3D shows O-doping using several strong oxidizing agents listed in the order of their standard reduction potential at pH 9.3. The reactions are examined with several different illumination wavelengths (on and off the absorption peaks of the oxidizing agents) and only shows the data with the best doping results. The extent of doping matches the reduction potentials of the oxidizing agents except S₂O₈²⁻ ions. The doping reaction can need direct donation of oxygen atoms on the oxidizing agents. K₂Cr₂O₇ is a very strong oxidizing agent in acid solution (E0=1.33) but decomposes into CrO₄ ⁻ in basic solution. Therefore, no oxygen doping was observed using K₂Cr₂O₇. Similarly, H₂O₂ is a very strong oxidizing agent in acid solution but shows lower reduction potential in basic solution. The reaction rate is slower, and the yield is lower compared to ClO⁻ ions. Tuning the solution to acidic for higher reduction potential is not practical because it also greatly affects the coating completeness of surfactants, which leads to faster aggregation. Another factor that decreases the doping efficiency of H₂O₂ is the low absorption. KMnO₄ shows acceptable doping density and reaction rate at 250 nm and 350 nm illumination. It is worth to mention that KMnO₄ quenches SWCNT fluorescence (before and after illumination). Adding extra DOC surfactants is necessary for fluorescence recovery. The doping can proceed at lower rate (˜10 mins) using KMnO₄ with longer illumination wavelengths up to 500 nm. The slower reaction might comply with more complicated mechanism of donating an oxygen onto the SWCNTs. More detailed study on the reaction mechanism is necessary. The formation of MnO₂ nanoparticles (brownish color observed) during the reaction process makes the solution dirtier and harder to clean. The oxygen doping using NaClO gives highest E*₁₁/E₁₁ and largest ϕ_{O-doped}/ϕₚᵣᵢₛₜᵢₙₑ, demonstrating the best doping quality. Efficient doping can require “direct” donation of singlet oxygen atom adjacent to the SWCNT surface. Therefore, the simple structure of hypochlorite ions shows advantage. The high reduction potential of ClO⁻ at high pH is ideal. (6,5)-Enriched SWCNT samples were also prepared (with ˜1 mM of these five oxidizing agents left in dark for 24 hours. Fluorescence spectra shows no doping reaction occurred for all cases and Raman spectra shows D/G ratio are the same (FIG. 23), suggesting that photo-activation is required to dope SWCNTs; otherwise, the SWCNT structure remained intact with the amount of oxidizing agent used.

Oxygen Doping Using H₂O₂

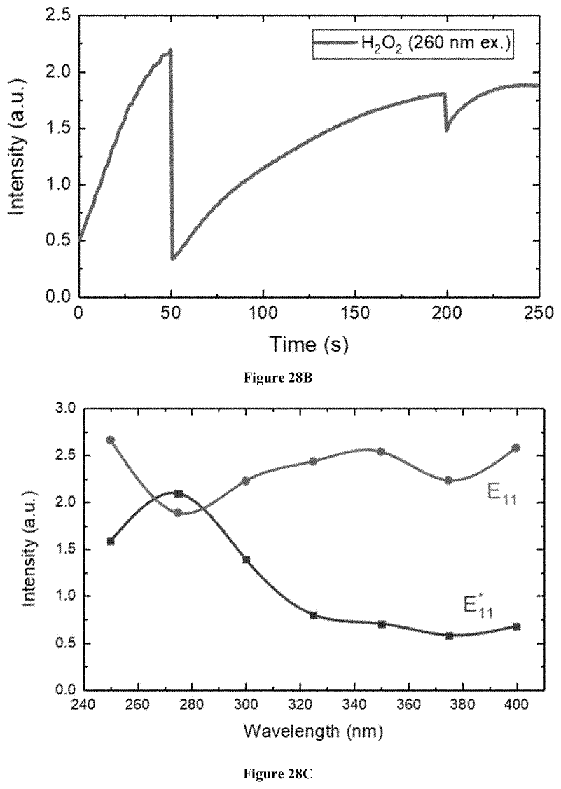

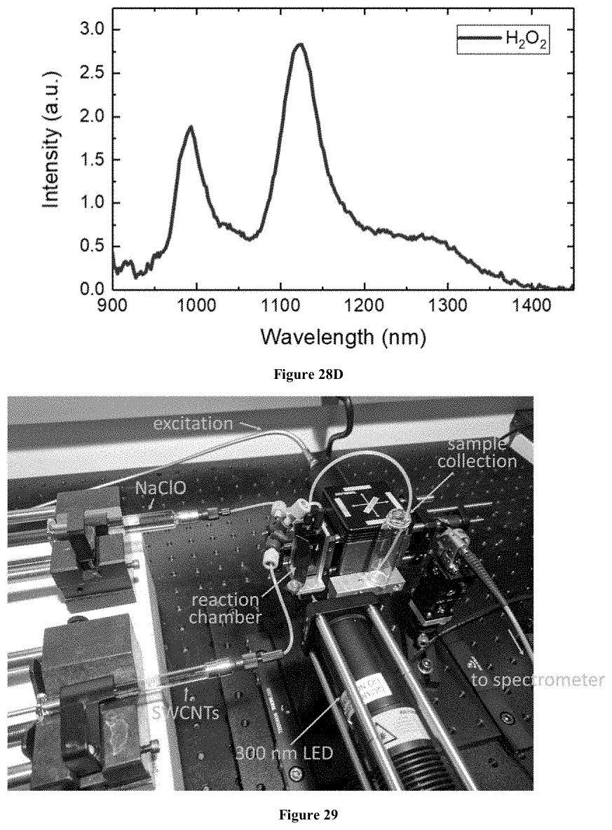

The photo-decomposition of H₂O₂ can produce oxygen atom. See, Hunt, J. P. & Taube, H. The photochemical decomposition of hydrogen peroxide. Quantum yields, tracer and fractionation effects. J. Am. Chem. Soc. 74, 5999-6002 (1952) and Iizumi, Y. et al. Oxygen-doped carbon nanotubes for near-infrared fluorescent labels and imaging probes. Sci. Rep. 8, 6272, doi:10.1038/s41598-018-24399-8 (2018), which is incorporated by reference in its entirety. However, the product of irradiated H₂O₂ seems to destroy the SWCNT structure. The resulting SWCNT fluorescence intensity is always lower than the SWCNTs doped by NaClO and KMnO₄. Also, the reaction rate is much slower compared to the NaClO and KMnO₄ because the extinction coefficient of the H₂O₂ is much lower, which is ˜18.4 M⁻¹ cm⁻¹ at 254 nm. See FIGS. 28A-28D.

### High-Throughput Flow Reactor

A flow reactor is shown in FIG. 29. The LED irradiation light source can give maximum power density of ˜73 mW/cm². A quartz condenser was used to focus the LED light onto a 3 mm diameter cylindrical beam. Reactant injection rates were controlled by a dual syringe pump (Harvard PUMP 33). The SWCNTs and NaClO were mixed right before injection to prevent the unwanted aggregation and side reaction. Extra SC was added into the collection vial to cease any aggregation and side reactions. The spectra of the O-doped SWCNTs can be monitored in situ. The fluorescence was collected from a focused spot nearby the quartz surface to reduce internal absorption when the SWCNT concentration is high.

### In Vivo Imaging

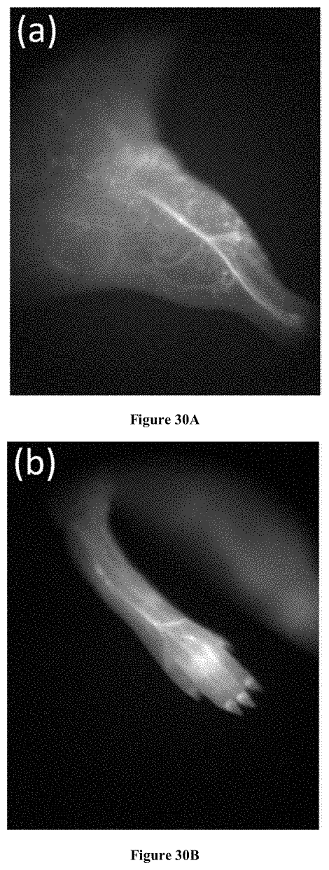

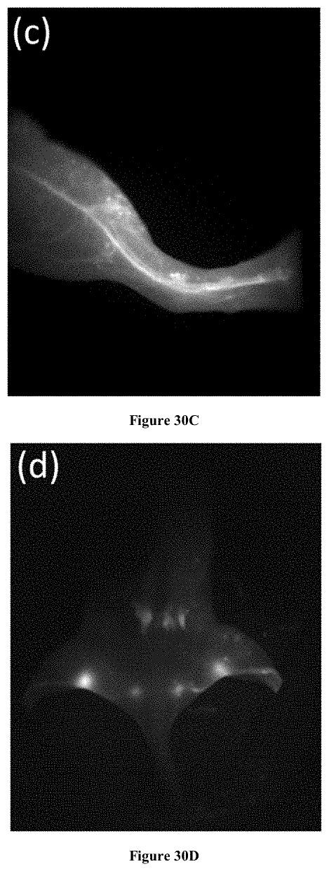

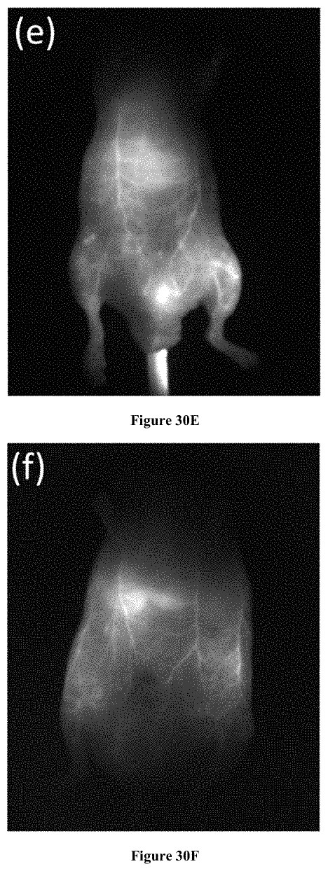

The in vivo imaging was performed using nu/nu nude, BALB/c, or BL6 mice. About 0.7 ng μL⁻¹ of DSPE-PEG5k was added into as-prepared O-doped SWCNTs and the sample was dialyzed against water for 3 days. The resulting DSPE-PEG5k-coated SWCNTs in 1×PBS were injected into tail vein (˜150 μL) and the image was taken starting right after the injection. The mouse was illuminated with 980 nm laser and the nanotube emission was filtered by a 1150 nm longpass filter, followed by signal acquisition by an InGaAs camera. The specimen's vasculature structure could be visualized clearly in the first hour of injection. To study the lymphatic drainage, ˜15 μL of the same SWCNT samples were injected into the footpads and images were taken several minutes later. FIGS. 30A-30F show several SWIR images.

It is worth to mention that the current standard of the oncologic care relies heavily on the ability to locate sentinel nodes to cancer, followed by characterizing their shapes, sizes, uptakes, and densities. Examples of the oncologic care are surgical planning, TNM model-based staging and life-span predictions, and metastatic and therapy response monitoring. Traditional modalities such as MM, PET/CT, and ultrasound exhibit poor resolution, low reproducibility, and limited accessibility to lymph node locations. At the same time, the cost to perform those imaging modalities is usually very high. Therefore, the highly sensitive SWIR fluorescence imaging can be a potential tool to aid such traditional imaging modalities. Additionally, with the advent of immunotherapy and increased awareness of the role of the immune system in disease, better understanding and visualization of the lymphatic vessels and their cell populations are of particular relevance. Those questions could also be addressed using our O-doped SWCNTs that are conjugated with extra targeting agents.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A composition comprising:
a plurality of single walled carbon nanotubes having a fluorescent quantum defect, the single walled carbon nanotube with the fluorescent quantum defect having emission maxima near about 1000 nm and 1275 nm and, optionally, having an E*₁₁ absorption with peak intensity of at least 1.5% compared to the E₁₁ absorption peak of pristine single walled carbon nanotubes.

2. The composition of claim 1, wherein the emission maxima are at 900-1000 nm and 1100-1275 nm.

3. The composition of claim 1, wherein the fluorescent quantum defect is O-doping.

4. The composition of claim 1, wherein the single walled carbon nanotubes having the fluorescent quantum defect have an emission quantum yield that is at least 2 times higher than pristine single walled carbon nanotubes.

5. The composition of claim 1, wherein the single walled carbon nanotubes having the fluorescent quantum defect have a D/G ratio of about 0.0371.

6. A method of making emissive single walled carbon nanotubes comprising:
contacting single walled carbon nanotubes with an oxygen-atom source to form a mixture; and
irradiating the mixture with UV light to introduce a fluorescent quantum defect in the single walled carbon nanotubes.

7. The method of claim 6, wherein the oxygen-atom source includes a hypochlorite, a peroxide or a permanganate.

8. The method of claim 6, wherein the UV light has a wavelength shorter than 350 nm.

9. The method of claim 6, wherein the UV light has a wavelength between 250 nm and 350 nm.

10. The method of claim 6, further comprising dispersing the single walled carbon nanotube with a surfactant prior to the contacting step.

11. The method of claim 10, wherein the surfactant is a dedecylbenzene sulfonate, a dodecyl sulfate or a deoxycholate.

12. The method of claim 6, further comprising flowing the mixture through a reaction zone where the irradiating takes place.

13. The method of claim 6, wherein the emissive single walled carbon nanotubes are manufactured in less than 2 minutes.

14. The method of claim 6, wherein the emissive single walled carbon nanotube with the fluorescent quantum defect has emission maxima near about 1000 nm and 1275 nm and, optionally, having an E*₁₁ absorption with peak intensity of at least 1.5% compared to the E₁₁ absorption peak of pristine single walled carbon nanotubes.

15. The method of claim 14, wherein the emission maxima are at 900-1000 nm and 1100-1275 nm.

16. The method of claim 14, wherein the fluorescent quantum defect is O-doping.

17. The method of claim 14, wherein the emissive single walled carbon nanotube with the fluorescent quantum defect have an emission quantum yield that is at least 2 times higher than pristine single walled carbon nanotubes.

18. The method of claim 14, wherein the emissive single walled carbon nanotubes with the fluorescent quantum defect have a D/G ratio of about 0.0371.

19. A method comprising:
exposing a single walled carbon nanotube having a fluorescent quantum defect to an excitation wavelength of light; and
detecting emission from the single walled carbon nanotube having a fluorescent quantum defect in a wavelength range of 850 nm to 1600 nm.

20. The method of claim 19, wherein the single walled carbon nanotube has emission maxima near about 1000 nm and 1275 nm:

21. The method of claim 19, further comprising introducing the single walled carbon nanotube into a subject and generating an image based on the detected emission.

22. The method of claim 21, wherein the single walled carbon nanotube is introduced at a concentration of less than 10 micrograms per kilogram.

23. The method of claim 21, wherein the single walled carbon nanotube is treated with a fatty acid polyalkylene glycol.

24. The method of claim 19, wherein detecting includes monitoring a shift in an emission maximum.

25. The method of claim 19, wherein detecting includes measuring a single photon emission.

26. A continuous flow reactor for making emissive single walled carbon nanotubes comprising:
a reaction chamber including:
an injection port configured to introduce a flow of single walled carbon nanotubes and a flow of an oxygen-atom source;
a reaction chamber configured to receive the flow of single walled carbon nanotubes and the flow of an oxygen-atom source as a mixture; and
a source of electromagnetic radiation arranged to irradiated the mixture with UV light to introduce a fluorescent quantum defect in the single walled carbon nanotubes.
